(19) United States
(12) Patent Application Publication
(10) Pub. No.: US 2010/0283736 A1
(43) Pub. Date: Nov. 11, 2010

(54) CHARACTER INPUT DEVICE, SYSTEM, AND CHARACTER INPUT CONTROL METHOD

(76) Inventors: Toshio Akabane, Osaka (JP); Keiko Hirukawa, Osaka (JP); Tomokazu Morio, Osaka (JP); Daisuke Tsujinishi, Osaka (JP); Yasushi Ishizuka, Osaka (JP)

Correspondence Address: BIRCH STEWART KOLASCH & BIRCH, PO BOX 747, FALLS CHURCH, VA, 22040-0747, US

(21) Appl. No.: 12/810,273

(22) PCT Filed: Dec. 26, 2008
(86) PCT No.: PCT/JP2008/073983

§ 371 Date: Jun. 23, 2010

Related U.S. Application Data
(60) Provisional application No. 61/009,196, filed on Dec. 27, 2007.

(30) Foreign Application Priority Data
Dec. 27, 2007 (JP) 2007-338326

(51) Int. Cl. G06F 3/02

(52) U.S. Cl. 345/168

(57) ABSTRACT

The character input device (5) (i) determines an input candidate that is a character string to be inputted at an input position on a basis of a character string before the input position, (ii) causes a display screen to display a candidate selection key to which the determined input candidate is assigned in such a manner as to allow a user to select the candidate selection key, and (iii) when the displayed candidate selection key is selected, inputs at the input position the character string of the input candidate assigned to the selected candidate selection key, the character input device including a first candidate determination section (38) for assigning a Caps key to the candidate selection key, a second candidate determination section (39) for assigning a Done key to the candidate selection key, and an editing candidate determination section (40) for assigning a Clear key to the candidate selection key. This allows determining an input candidate with high probability. In this manner, in the character input device (5), an input candidate with high probability is assigned to the candidate selection key, allowing a user to easily and swiftly input characters.

### TECHNICAL FIELD

The present invention relates to a character input device for supporting inputting of characters at an input position on the basis of a character string having been inputted.

### BACKGROUND ART

There has been widely used character input devices for inputting characters without using a keyboard etc. For example, character input devices for inputting characters are used in electronic apparatuses having difficulty in usage of a keyboard, such as cellular phones, television receivers, audiovisual apparatuses, and portable music players.

In general, such character input devices have narrow space where character input keys are to be provided, and therefore it is often that such character input devices have difficulty in providing all character input keys thereon. For that reason, the character input devices employ a method for inputting characters, such as a method in which plural characters are assigned to one character input key and a method for displaying a list of characters and selecting one of the displayed characters in order to input characters.

Such methods have a problem that it takes more time and trouble for a user to input characters than a case of using a keyboard having input keys corresponding to individual alphabets. Therefore, various ideas have been proposed to design the character input devices in order to allow a user to more easily and swiftly input characters.

For example, in Patent Document 1, character input keys are displayed on a touch panel in order to allow a user to input characters. A layout of the character input keys displayed on the touch panel is changed according to character strings having been inputted and thus increases operativity.

Further, in Patent Document 2, words whose tops are identical with those of character strings having been inputted are displayed as input candidates, and the words of the displayed input candidates can be inputted with use of keys for selecting the input candidates. With the arrangement of the present invention, when a user inputs the top of a word and the word is displayed as an input candidate, the user can input the word with one touch of a key.

[Patent Document 1]

U.S. Pat. No. 5,128,672, specification

[Patent Document 2]

U.S. Pat. No. 6,405,060, specification

### DISCLOSURE OF INVENTION

### Problems to be Solved by the Invention

However, the conventional character input devices have a problem that the displayed input candidates have low accuracy. That is, in the conventional character input devices, only when a character string having been inputted has a top identical with that of a word having been stored beforehand and when the word is identical with a word that a user wants to input, the user has less trouble in inputting characters. In other cases, the displayed input candidates are not useful at all.

One method to deal with the problem is storing as many words as possible and displaying as many input candidates as possible. With the method, it is possible to increase the probability of inputting a word with use of a candidate selection key.

However, much of the character input devices have limitation in their spaces where input keys etc. are provided. Therefore, it is unrealistic to provide many candidate selection keys or to display many input candidates. Further, displaying many input candidates takes more time for the user to find a desired input candidate rather than shortening the time.

The present invention was made in view of the foregoing problems. An object of the present invention is to realize a character input device etc. that assigns an input candidate with high accuracy to a candidate selection key and thus allows a user to easily and swiftly input characters.

### Means to Solve the Problem

In order to solve the foregoing problem, a character input device of the present invention is a character input device for changing, in accordance with a state of inputting of characters, a process assigned to a candidate selection key displayed in such a manner as to be selectable by a user, and for carrying out, when the candidate selection key is selected, the process assigned to the selected candidate selection key, the character input device including: character string candidate determination means for assigning, to the candidate selection key, a character string input process in which a character string determined according to a character string before an input position is inputted to the input position; and process candidate determination means for assigning, to the candidate selection key, a process that is related to inputting of characters and that is other than the character string input process, when the candidate selection key is selected, the process assigned by the character string candidate determination means or the process candidate determination means being carried out.

Further, in order to solve the foregoing problem, a character input control method of a character input device for changing, in accordance with a state of inputting of characters, a process assigned to a candidate selection key displayed in such a manner as to be selectable by a user, and for carrying out, when the candidate selection key is selected, the process assigned to the selected candidate selection key, the method including the steps of: (i) assigning, to the candidate selection key, a character string input process in which a character string determined according to a character string before an input position is inputted to the input position; (ii) assigning, to the candidate selection key, a process that is related to inputting of characters and that is other than the character string input process; and (iii) when the candidate selection key is selected, carrying out the process assigned to the candidate selection key in the step (i) or the step (ii).

With the arrangement of the present invention, the input candidate that is the character string to be inputted is assigned to the candidate selection key and the process that is related to inputting of characters is assigned to the candidate selection key. Note that the process that is related to inputting of characters is a process (function) generally used in the character input device, such as complete deletion of an inputted character string, deletion of a character, line break, determination, move of the input position, switching between inputting of a lowercase alphabet and inputting of a capital alphabet (in case of inputting alphabets), and kana-kanji conversion (in case of inputting Japanese).

In this manner, when inputting characters, not only a character string is inputted but also various processes as described above are performed. In a conventional character input device, such processes are performed with use of specific input keys etc. to which individual processes are assigned, as with a case of inputting character strings. That is, in a conventional character input device, processes that are related to inputting of characters are fixedly assigned to specific keys.

In contrast thereto, with the arrangement of the present invention, of the processes that are related to inputting of characters, a process that is other than inputting at the input position the character string of the input candidate is assigned to a candidate selection key. Consequently, with the arrangement of the present invention, the process that is related to inputting of characters can be easily and swiftly performed with use of a candidate selection key. This allows a user to easily and swiftly perform inputting of characters.

Here, a character string indicates a character or a plurality of continuous characters. Further, the character string includes signs and numerals. Further, the state of inputting of characters indicates a state such as whether the input position is at a starting position or not, whether a character string has been read from outside of the character input device, and what character string is inputted before the input position when the input position is not at a starting position.

Further, in order to solve the foregoing problem, a character input device of the present invention is a character input device for (i) determining an input candidate that is a character string to be inputted at an input position on a basis of a character string before the input position, (ii) causing a display section to display a candidate selection key to which the determined input candidate is assigned in such a manner as to allow a user to select the candidate selection key, and (iii) when the displayed candidate selection key is selected, inputting at the input position the character string of the input candidate assigned to the selected candidate selection key, the character input device including: input candidate determination means for determining the input candidate on a basis of a right-before-character string that is a continuous character string whose last character is right before the input position and which does not include a separator; a one-character candidate storage section for storing a character string having a predetermined number of characters and a one-character candidate that is a character inputted after the character string, in such a manner that the character string and the one-character candidate are related to each other; and one-character candidate determination means for referring to the one-character candidate storage section and determining as an input candidate the one-character candidate stored in relation to the character string having the predetermined number of characters right before the input position.

Further, in order to solve the foregoing problem, a character input control method of the present invention is a character input control method of a character input device for (i) determining an input candidate that is a character string to be inputted at an input position on a basis of a character string before the input position, (ii) causing a display section to display a candidate selection key to which the determined input candidate is assigned in such a manner as to allow a user to select the candidate selection key, and (iii) when the displayed candidate selection key is selected, inputting at the input position the character string of the input candidate assigned to the selected candidate selection key, the method including the steps of: determining the input candidate on the basis of a right-before character string that is a continuous character string whose last character is right before the input position and which does not include a separator; and referring to a one-character candidate storage section for storing a character string having a predetermined number of characters and a one-character candidate that is a character inputted after the character string, in such a manner that the character string and the one-character candidate are related to each other, and determining as an input candidate the one-character candidate stored in relation to the character string having the predetermined number of characters right before the input position.

In a case of determining an input candidate on the basis of the right-before character string, the right-before character string is required to be identical with at least a part of a word stored in advance. In other words, unless the word at least a part of which is identical with the right-before character string is stored in advance, the input character is not determined. Further, even when the right-before character string is identical with at least a part of the word stored in advance, if the identical word is different from a word which the user wishes to input, the candidate selection key cannot be used.

Therefore, with the arrangement of the present invention, an input candidate is determined on the basis of the right-before character string, and a one-character candidate stored in relation to a character string positioned right before the input position and having a predetermined number of characters is determined as an input candidate.

A one-character candidate is a character stored in relation to a character string having a predetermined number of characters, and therefore the one-character candidate can be provided with respect to any combination of characters. That is, a one-character candidate can be determined as an input candidate regardless of what character string exists right before the input position.

Therefore, with the arrangement of the present invention, it is possible to assign an input candidate to a candidate selection key even when a right-before character string is not identical with a word stored in advance, and it is possible to assign a one-character candidate aiding a user to input characters to a candidate selection key even when the word stored in advance is different from a word which the user wishes to input. This allows the user to easily and swiftly input a desired character string with use of the candidate selection key.

Further, in order to solve the foregoing problem, a character input device of the present invention is a character input device, including a character string storage section for storing a character string, said character input device (i) causing a display section to display a candidate selection key to which an input candidate that is a candidate of a character string to be inputted at the input position is assigned on a basis of a character string before the input position out of character strings stored in the character string storage section, the candidate selection key being displayed in such a manner as to allow a user to select the candidate selection key, and (ii) when the displayed candidate selection key is selected, inputting the character string of the input candidate assigned to the selected candidate selection key at the input position of the character string stored in the character string storage section, the character input device including: separator judgment means for judging whether a character right before the input position is a separator for separating words; first candidate determination means for, when a character right before the input position is a separator, regarding as an input candidate a candidate of a word inputted after a word right before the separator; and second candidate determination means for, when a character right before the input position is not a separator, regarding as an input candidate a candidate of a character string for completing as a word a right-before character string that is a continuous character string whose last character is right before the input position and which does not include a separator.

Further, in order to solve the foregoing problem, a character input control method of the present invention is a character input control method of a character input device for (i) determining an input candidate that is a character string to be inputted at an input position on a basis of a character string before the input position, (ii) causing a display section to display a candidate selection key to which the determined input candidate is assigned in such a manner as to allow a user to select the candidate selection key, and (iii) when the displayed candidate selection key is selected, inputting at the input position the character string of the input candidate assigned to the selected candidate selection key, the method including the steps of: (i) judging whether a character right before the input position is a separator for separating words; when a result of the step (i) shows that a character right before the input position is a separator, regarding as an input candidate a candidate of a word inputted after a word right before the separator; and when a result of the step (i) shows that a character right before the input position is not a separator, regarding as an input candidate a candidate of a character string for completing as a word a right-before character string that is a continuous character string whose last character is right before the input position and which does not include a separator.

With the arrangement of the present invention, it is judged whether a character right before the input position is a separator or not. An input candidate is determined by different means according to whether the character right before the input position is a separator or a character other than a separator.

Since a separator is a character for separating words, it is expected that a word is inputted after the separator. On the other hand, in a case where a character right before the input position is not a separator, when a character string right before the input position is not completed as a word, it is expected that a character string is inputted next, and when a character string right before the input position is completed as a word, it is expected that a separator is inputted next.

That is, with the arrangement of the present invention where an input candidate is determined in different manners according to whether a character right before the input position is a separator or a character other than a separator, a candidate that is likely to be inputted at the input position with high probability is assigned as an input candidate to the candidate selection key.

This allows increasing the accuracy of an input candidate assigned to a candidate selection key, compared with a conventional character input device in which it is not judged whether a character right before the input position is a separator or not. This allows a user to easily and swiftly input characters.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram illustrating a configuration of a main part of a character input device in accordance with an embodiment of the present invention.

FIG. 2 is a block diagram illustrating a schematic configuration of an image display system in accordance with an embodiment of the present invention.

FIG. 3 is a diagram illustrating an example of a configuration of a remote control device used in the image display system.

FIG. 4 is a drawing illustrating an example of an input window which the character input device causes a display device to display.

FIG. 5 is a drawing illustrating an example of a data structure of a prediction memory included in the character input device.

FIG. 6 is a drawing illustrating how to determine an input candidate by using data of the prediction memory. (a) of FIG. 7 illustrates an example of data stored in the prediction memory through learning. (b) of FIG. 7 illustrates an example of data stored in the prediction memory when another character string is learnt in the state of (a) of FIG. 7.

FIG. 8 is a flowchart illustrating an example of a learning process performed by the character input device.

FIG. 9 is a flowchart illustrating an example of a word registration process in the learning process.

FIG. 10 is a flowchart illustrating an example of a separator information registration process in the learning process.

FIG. 11 is a drawing explaining how to update separator information in the separator information registration process.

FIG. 12 is a flowchart illustrating an example of a word information registration process in the learning process.

FIG. 13 is a flowchart illustrating an example of an input candidate determination process performed by the character input device.

FIG. 14 is a flowchart illustrating an example of a next word candidate prediction process in the input candidate determination process.

FIG. 15 is a flowchart illustrating an example of a separator candidate prediction process in the input candidate determination process.

FIG. 16 is a flowchart illustrating an example of an abbreviation candidate prediction process in the input candidate determination process.

FIG. 17 is a flowchart illustrating an example of a next word candidate prediction process in the input candidate determination process.

FIG. 18 is a flowchart illustrating an example of a URL mode setting process in the input candidate determination process.

FIG. 19 is a flowchart illustrating a URL candidate prediction process in the input candidate determination process.

FIG. 20 is a drawing illustrating examples of input candidates determined in the URL candidate prediction process.

FIG. 21 is a flowchart illustrating an example of a candidate character string generation process in the input candidate determination process.

FIG. 22 is a flowchart illustrating an example of a candidate character string unification process in the input candidate determination process.

FIG. 23 is a drawing illustrating examples of candidate character strings determined in the candidate character string generation process and the candidate character string unification process.

FIG. 24 is a drawing explaining how to input an input candidate assigned to a candidate selection key in the character input device.

FIG. 25 is a drawing illustrating a display example in a case where a Caps key is assigned to a candidate selection key in the character input device.

FIG. 26 is a drawing illustrating a display example in a case where a Space key is dynamically assigned to a candidate selection key in the character input device.

FIG. 27 is a drawing explaining merits of a learning method of the character input device.

FIG. 28 is a drawing illustrating an example of a screen displayed when inputting “mu” in a case where a word “music” is registered in the prediction memory in the character input device.

FIG. 29 is a drawing illustrating a display example in a case where an address is inputted in the character input device.

FIG. 30 is a drawing illustrating an example of displaying input candidates in the character input device.

FIG. 31 is a drawing illustrating a display example in a case where three words “ichinomotocho”, “index”, and “is” are stored in the prediction memory.

FIG. 32 is a drawing illustrating a display example in a case where the length of an inputted character string is equal with respect to each input candidate.

FIG. 33 is a drawing explaining how to preferentially determine characters far from the position of a focus as selection candidates.

FIG. 34 is a drawing illustrating a display example in a case where a character string having been inputted in an input field is read in the character input device.

FIG. 35 is a drawing illustrating a display example in a case where a Done key is assigned to a candidate selection key in the character input device.

FIG. 36 is a drawing illustrating a display example in a case where inputting of Japanese is performed in the character input device.

FIG. 37 is a drawing illustrating a display example where only a character string displayed in a candidate selection key is inputted when inputting Japanese in the character input device.

FIG. 38 is a display example where [symbol] is inputted in a case where words [symbol] and [symbol] are stored in the prediction memory in the character input device.

FIG. 39 is a drawing illustrating a display example where a character string in an input field is read when inputting Japanese in the character input device.

FIG. 40 is a drawing illustrating a display example in a case where a character [symbol] is inputted after the character input device learnt that a determination operation was performed after a word [symbol] .

FIG. 41 is a drawing illustrating a display example in a case where a conversion key is assigned to a candidate selection key in the character input device.

### REFERENCE NUMERALS

1. Image display system

2. Display device

3. Information processing device

4. Remote control device

5. Character input device

6. Communication device

11. Determination button

12. Direction button

13. Exit button

14. RETURN button

15. Candidate determination button

20. Input window

21. Input frame

22. Input mode switching key

23. Character input key

24. Editing process key

25. Candidate selection key

26. Focus

30. Input window display control section

31. Operation acquiring section

32. Character string display control section

33. Character string reading section (character string reading means)

34. Input candidate display control section

35. Character string update section

36. Character string editing memory

37. Separating character judgment section (separating character judgment means)

38. First candidate determination section (character string candidate determination means, process candidate determination means, first candidate determination means)

39. Second candidate determination section (character string candidate determination means, process candidate determination means, one-character candidate determination means, second candidate determination means)

40. Editing candidate determination section (process candidate determination means, editing candidate determination means)

41. Learning section (learning means)

42. Prediction memory (chain process storage section, word storage section, chain separating character storage section, chain word storage section)

43. One-character prediction memory (one-character candidate storage section)

44. Input candidate assigning section (input candidate assigning means)

### BEST MODE FOR CARRYING OUT THE INVENTION

### [Arrangement of Image Display System 1]

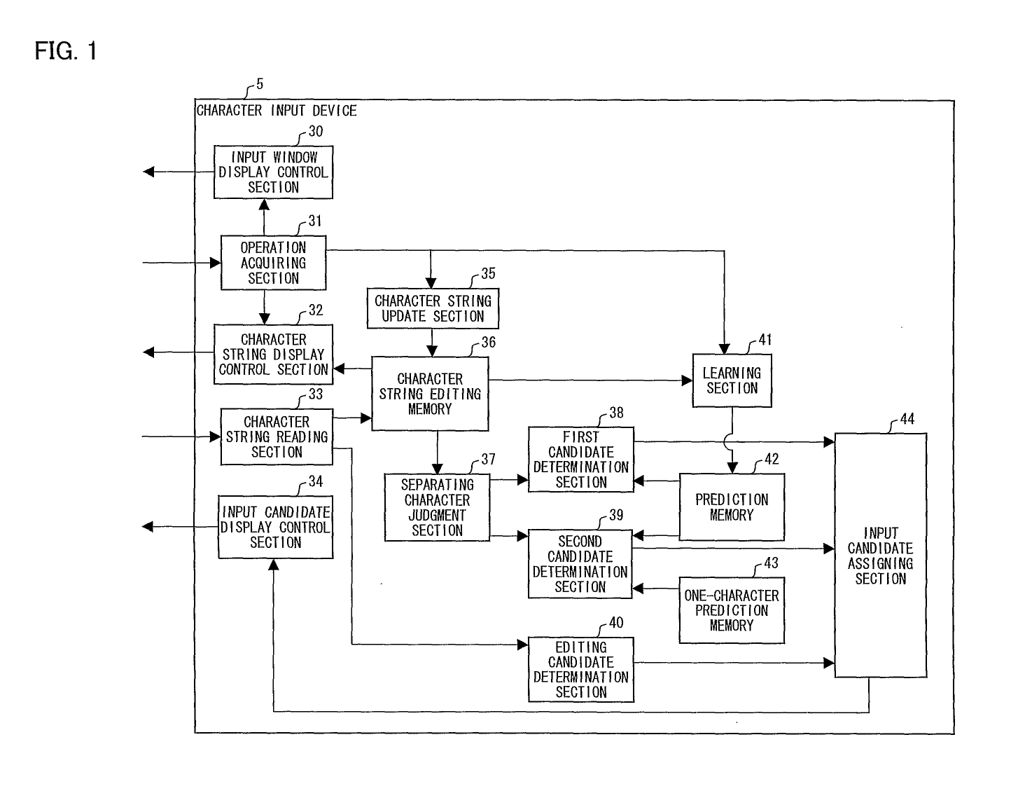

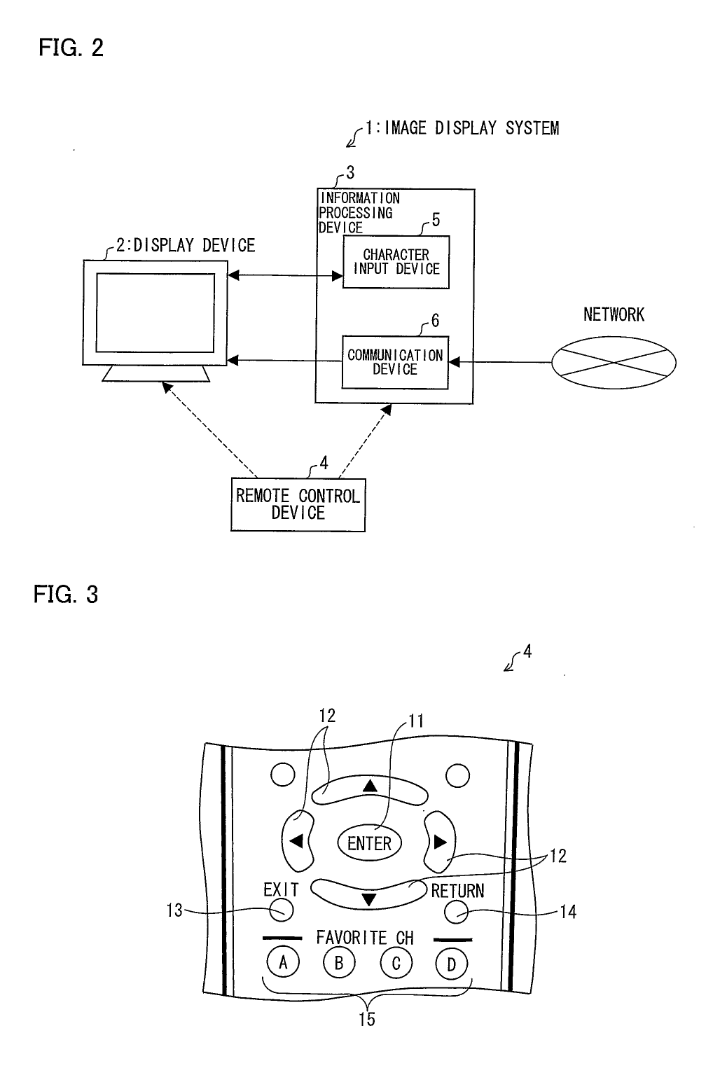

One embodiment of the present invention is described below with reference to FIGS. 1 to 41. Initially, an explanation is made as to an outline of an image display system 1 of the present invention with reference to FIG. 2. FIG. 2 is a block diagram schematically illustrating a structure of the image display system 1. As illustrated in FIG. 2, the image display system 1 includes a display device 2, an information processing device 3, and a remote operation device 4.

The display device 2 includes a display section and causes the display section to display an image. Further, as illustrated in FIG. 2, the display device 2 is connected with the information processing device 3 and capable of transmitting/receiving data to/from the information processing device 3. That is, image data output from the information processing device 3 is displayed by the display section of the display device. Further, the display device 2 operates in accordance with the operation of the remote operation device 4.

The display device 2 is not particularly limited as long as it is capable of receiving image data from the information processing device 3 and displaying the image data. Here, it is assumed that the display device 2 is a television receiver. That is, the display device 2 includes a tuner and is capable of outputting images and audios that are received via the tuner.

As illustrated in FIG. 2, the information processing device 3 includes a character input device 5 and a communication device 6. The communication device 6 has a browser function and a communication function. As illustrated in FIG. 2, the communication device 6 is connected with a network. That is, in accordance with instructions from the information processing device 3, the communication device 6 gets connected with the network and obtains various data, and outputs the obtained data to the display device 2 so as to cause the display device 2 to display the obtained data. The information processing device 3 can be operated by the remote operation device 4.

The network may be one of various publicly known communication networks. Here, an explanation is made as to a case where the network is the Internet. Here, it is assumed that the information processing device 3 is a personal computer (PC). Needless to say, the information processing device 3 is not limited to a PC and may be a device where a display device and an information processing device are integrated with each other, such as a television receiver with a browser function.

As described above, the information processing device 3 can get connected with the Internet with use of the function of the communication device 6 and cause the display device 2 to display a web page. Some web pages such as a search site, a BBS, and a weblog require inputting characters. Further, inputting an address (URL) of the Internet requires inputting characters. In this specification, a position where characters are input is referred to as an input field. PCs are generally designed such that an input field is specified with use of a pointing device such as a mouse and characters are inputted in the specified input field with use of an input device such as a keyboard.

In contrast, the image display system 1 is designed such that an input field is selected with use of the remote operation device 4, and when the input field is selected, the character input device 5 causes the display device 2 to display an input window in order to allow inputting of characters with use of the input window. That is, the image display system 1 is designed such that inputting of characters is performed without using hardware such as a keyboard.

The remote operation device 4 is a device for performing operational input on the display device 2 and the information processing device 3. The remote operation device 4 has on its surface input buttons related to individual operational inputs. Pressing an input button transmits to the display device 2 or the information processing device 3 an operational input signal related to the input button.

Specifically, the remote operation device 4 allows turning on/off the display device 2, changing channels of the display device 2, switching a source of data to be displayed on the display device 2 (switching from a TV to a PC or vice versa), and the similar operation. Further, the remote operation device 4 allows turning on/off the information processing device 3, performing operational inputs on the character input device 5, and the similar operation. Further, the remote operation device 4 has a function of a pointing device for selecting an input field displayed on a display screen of the display device 2. The remote operation device 4 transmits the operational inputs to the display device 2 or the information processing device 3 via communication means such as an infrared ray, Bluetooth®, and a wireless LAN.

(Specific Configuration Examples)

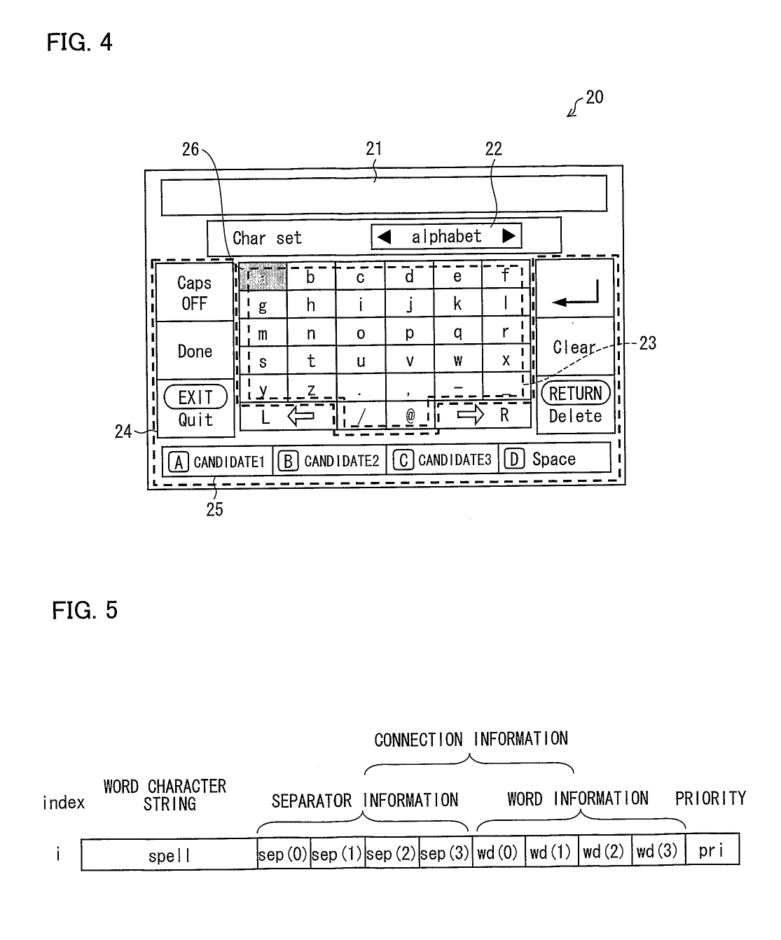

With reference to FIGS. 3 and 4, an explanation is made below as to a specific configuration example of the remote operation device 4 and a specific example of an input window that the character input device 5 causes the display device 2 to display.

The remote operation device 4 may be configured as illustrated in FIG. 3 for example. FIG. 3 is a drawing illustrating an example of a configuration of the remote operation device 4. Since the main feature of the image display system 1 is a character input process with use of the character input device 5, FIG. 3 illustrates only a part of the remote operation device 4 where input buttons related to the character input process are provided out of all input buttons. As illustrated in FIG. 3, the remote operation device 4 has on its surface a determination button 11, direction buttons 12, an EXIT button 13, a RETURN button 14, and candidate determination buttons 15.

Functions of inputting characters are assigned to these buttons. A user inputs characters by operating the buttons while seeing the input window.

FIG. 4 is an example of the input window that the character input device 5 causes the display device 2 to display. As illustrated in FIG. 4, in an input window 20, there are displayed an input frame 21, an input mode switching key 22, character input keys 23, editing process keys 24, candidate selection keys 25, and a focus 26.

The input frame 21 is a field where a character string inputted to the character input device 5 is displayed. Here, the character string indicates a character or a line of characters unless otherwise stated. Further, in addition to characters such as alphabets, hiragana characters, katakana characters, and kanji characters, examples of the character string also include signs such as “.”(period), “,”(comma), “ ”(space), “?”(question mark), “!”(exclamation mark), “-”(hyphen), “/”(slash), “©”(at mark), “_”(underline), “∘”(period in Japanese), and “' ”(comma in Japanese), and numbers. These signs are frequently used to separate characters and therefore are specially referred to as “separator” here. Characters regarded as separators are not limited to the above examples and may be specified when needed.

Further, characters regarded as separators may be changed according to situations. For example, in a case of inputting a text or a URL, it is preferable that “&” and “.” are regarded as separators. On the other hand, in a case of inputting numerals including decimals, it is reasonable that “.” is not regarded as a separator.

In a case of inputting a telephone number for example, when “-”(hyphen) is not regarded as a separator, the telephone number is a single character string. In contrast, when “-”(hyphen) is regarded as a separator, the telephone number is made of a plurality of character strings separated by a separator. As mentioned later, in a case where an area where candidates are displayed is small or a case where a plurality of telephone numbers having the same area codeare inputted, regarding “-”(hyphen) as a separator allows more effective inputting of characters.

As described above, inputting of characters can be performed more effectively by changing a character string regarded as a separator in accordance with the size of an area where candidates are displayed or with what a character string is to be inputted.

The input mode switching key 22 displays a current input mode. Operating the input mode switching key 22 allows switching input modes. Switching input modes changes characters to be displayed by the character input keys 23. For example, in the case of FIG. 4, since the input mode is the alphabet mode, the character input keys 23 display alphabets.

Here, it is assumed that the input modes include four modes: an alphabet input mode, a hiragana input mode, a katakana input mode, and a sign input mode. However, the kinds and the number of the input modes are changed when needed.

The character input keys 23 are keys with which characters are input. By putting the focus 26 on one of the character input keys 23 and pressing the determination button 11, the character displayed by the character input key 23 is inputted and displayed in the input frame 21.

The editing process keys 24 allow processes that is related to inputting of characters and that are other than inputting of characters. By putting the focus 26 on one of the editing process keys 24 and pressing the determination button 11, the process displayed by the editing process key 24 is carried out.

(Editing Process Key 24)

Here, as illustrated in FIG. 4, it is assumed that the editing process keys 24 include a Caps key, a Done key, a Quit key, an L key and an R key, a Delete key, a Clear key, and an end-of-line key.

The Caps key is a key with which inputting of capital alphabets and inputting of lowercase alphabets are switched. In the case of FIG. 4, the Caps key displays “Caps OFF.” This indicates that putting the focus 26 on one alphabetical key of the character input keys 23 and pressing the determination button 11 inputs a lowercase alphabet (displays a lowercase alphabet in the input frame 21).

Here, putting the focus 26 on the Caps key and pressing the determination button 11 causes the Caps key to display “Caps ON.” Putting the focus 26 on an alphabetical key of the character input keys 23 while the Caps key displays “Caps ON” and pressing the determination button 11 inputs a capital alphabet. Inputting one character while the Caps key displays “Caps ON” causes the Caps key to display “Caps OFF” again.

Further, putting the focus 26 on the Caps key while the Caps key displays “Caps ON” and pressing the determination button 11 causes the Caps key to display “Caps LOCK.” While the Caps key displays “Caps LOCK”, capital alphabets are always inputted.

The Done key is a key with which a character string in editing displayed in the input frame 21 is determined and displayed in the input field of the display device 2. As described above, putting the focus 26 on one of the character input keys 23 and pressing the determination button 11 causes the character displayed by the character input key 23 to be displayed in the input frame 21.

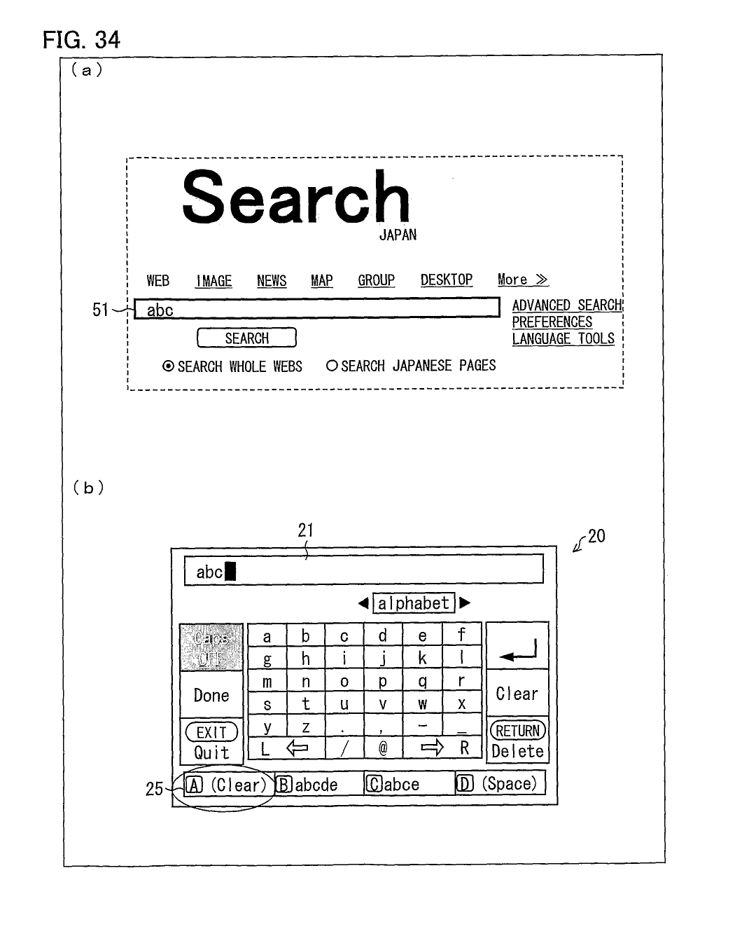

The input field indicates a text box etc. that allows inputting of characters on a web page. Specific examples of the input field include a text box where a keyword is inputted or a text box where a URL is inputted on a search site for keyword searching (see (a) of FIG. 34).

The Quit key is a key with which the character string displayed in the input frame 21 is cancelled and inputting of characters is finished. In the case of FIG. 4, the Quit key displays “EXIT.” This indicates that the Quit key corresponds to the EXIT button 13 of the remote operation device 4 in FIG. 3. That is, pressing the EXIT button 13 of the remote operation device 4 performs the same operation as that performed by putting the focus 26 on the Quit key and pressing the determination button 11.

The L key and the R key are keys with which an input position in the input frame 21 is moved. An explanation is made here as to the input position. Although not illustrated in FIG. 4, a cursor indicative of the input position is displayed in the input frame 21. That is, a character string inputted with use of the character input keys 23 etc. is inserted at the position of the cursor in the input frame 21.

The Delete key is a key with which one character right before the input position is deleted. In the case of FIG. 4, the

Delete key displays “Return.” This indicates that the Delete key corresponds to the RETURN button 14 of the remote control device 4 in FIG. 3. That is, pressing the RETURN button 14 of the remote operation device 4 performs the same operation as that performed by putting the focus 26 on the Delete key and pressing the determination button 11.

The Clear key is a key with which a character string displayed in the input frame 21 is wholly cleared. The end-of-line key is a key with which a character string displayed in the input frame 21 starts on a new line. Here, it is assumed that a character string displayed in the input frame 21 is one line. Therefore, when the focus 26 is put on the end-of-line key and the determination button 11 is pressed, a new line does not start in the input frame 21 but an end-of-line mark indicative of the position where the new line starts is displayed in the input frame 21. When the character string including the end-of-line mark is input in the input field, the character string starts on a new line at the position of the end-of-line mark.

[Candidate Selection Key 25]

The candidate selection keys 25 are keys where candidates of character strings to be inputted in the input frame 21 are displayed. Putting the focus 26 on one of the candidate selection keys 25 and pressing the determination button 11 causes the character string displayed by the candidate selection key 25 to be input at the input position (cursor position) in the input frame 21.

Here, the remote operation device 4 has candidate determination buttons 15 corresponding to the candidate selection keys 25, respectively. For example, FIG. 4 illustrates four candidate selection keys 25 to which characters A-D are assigned, and FIG. 3 illustrates four candidate determination buttons 15 to which characters A-D are assigned.

That is, the candidate determination buttons 15 of the remote operation device 4 correspond to the candidate selection keys 25, respectively, and pressing one of the candidate determination buttons 15 inputs the character string displayed by the candidate selection key 25 corresponding to the pressed candidate determination button 15. Thus, making the buttons of the remote operation device 4 correspond to the candidate selection keys 25, respectively, allows easily selecting the candidate selection keys 25.

In the case of FIG. 4, the candidate selection key 25 to which “D” is assigned reads “Space.” That is, the candidate selection key 25 to which “D” is assigned serves as a key with which a space is input, i.e., a space key, and pressing the candidate determination button 15 to which “D” is assigned on the remote operation device 4 inputs a space at the input position.

A space is more frequently used in inputting characters than other character/editorial operations. Therefore, assigning a space key to a specific one of the candidate selection keys 25 allows increasing operativity for a user. The space key may be provided in the input window 20 as with the character input key 23 and the editing process key 24.

As detailed later, the character input device 5 causes the display device 2 to display the candidate selection keys 25 to which input candidates indicative of character strings to be inputted at the input position are assigned, in accordance with a character string that is in the input frame 21 and that is positioned before the input position. That is, character strings expected to be inputted at the input position in view of a character string having been inputted are assigned as input candidates to the candidate selection keys 25.

When one of the candidate selection keys 25 displayed by the display device 2 is selected with use of the candidate determination buttons 15 of the remote operation device 4 as described above, the character string of the input candidate assigned to the selected candidate selection key 25 can be inputted at the input position.

Therefore, when the character string to be inputted at the input position is assigned as an input candidate to the candidate selection key 25, the number of pressing buttons is smaller than when the character string is inputted by serially putting the focus 26 on the character input keys 23 and pressing the determination button 11. Thus, the user of the character input device 5 can easily and swiftly input the character string.

Needless to say, when the character string to be inputted at the input position is not assigned as an input candidate to the candidate selection key 25, it is necessary to serially put the focus 26 on the character input keys 23 and pressing the determination button 11 in order to input the character string. That is, when predictive accuracy of the input candidates is low, there is no merit in assigning the input candidates to the candidate selection keys 25.

For that reason, the character input device 5 is designed such that input candidates assigned to the candidate selection keys 25 are dynamically changed according to whether a character string inputted before the input position is a separator for separating words or not, which will be detailed later. This makes predictive accuracy of the input candidates higher, allowing easy and swift inputting of character strings.

[Configuration of Character Input Device 5]

The following explains a detailed configuration of the character input device 5 with reference to FIG. 1. FIG. 1 is a block diagram illustrating a configuration of a main part of the character input device 5. As illustrated in FIG. 1, the character input device 5 includes an input window display control section 30, an operation acquiring section 31, a character string display control section 32, a character string reading section (character string reading means) 33, an input candidate display control section 34, a character string update section 35, a character string editing memory 36, a separating character judgment section (separating character judgment means) 37, a first candidate determination section (character string candidate determination means, process candidate determination means, first candidate determination means) 38, a second candidate determination section (character string candidate determination means, process candidate determination means, one-character candidate determination means, second candidate determination means) 39, an editing candidate determination section (process candidate determination means, editing candidate determination means) 40, a learning section (learning means) 41, a prediction memory (chain process storage section, word storage section, chain separating character storing section, chain word storage section) 42, a one-character prediction memory (one-character candidate storage section) 43, and an input candidate assigning section (input candidate assigning means) 44.

When an input field where characters are inputted on the display section of the display device 2 is selected, the input window display control section 30 causes the display section to display an input window including various keys with which character strings are inputted, edited, and subjected to similar processes. The input window may be a window illustrated in FIG. 4 for example. Needless to say, the kinds and the arrangements of the keys included in the input window are not limited to the example in FIG. 4 and may be changed when needed.

The operation acquiring section 31 acquires an input operation from the remote operation device 4 and carries out a predetermined process according to the acquired input operation. Specifically, the remote operation device 4 receives a user's input operation with use of various input buttons provided on the surface thereof and transmits an operation signal corresponding to the input operation to the information processing device 3, and the operation acquiring section 31 acquires the operation signal via the information processing device 3. In accordance with the operation signal received from the information processing device 3, the operation acquiring section 31 sends predetermined instructions to individual sections of the character input device 5 so as to cause the sections to carry out a process corresponding to the input operation on the remote operation device 4.

The character string display control section 32 causes the display device 2 to display character strings inputted in the character input device 5. Specifically, the character string display control section 32 reads out character strings stored in the character string editing memory 36 and causes the character strings to be displayed in the input window (input frame 21 in the example of FIG. 4). Further, when the character strings stored in the character string editing memory 36 are updated, the character string display control section 32 updates character strings to be displayed accordingly. Further, when the operation acquiring section 31 acquires an operation to determine a character string (operation on the Done key in FIG. 4), the character string display control section 32 reads out character strings stored in the character editing memory 36 and causes the character strings to be displayed in the input field of the display device 2.

The character string reading section 33 reads a character string at the outside of the character input device 5 and causes the character string to be stored in the character string editing memory 36. The outside of the character input device 5 indicates an input field. That is, there is a case where in a field capable of receiving inputting of characters on a web page etc., a character string has been already inputted. When the input field is selected and the input window is displayed, the character string reading section 33 reads the character string having been already inputted in the input field and causes the character string to be stored in the character string editing memory 36.

Here, character strings stored in the character string editing memory 36 are displayed on the input window by the character string display control section 32. Therefore, when an area in which a character string has been already inputted on the display device 2 is selected as an input field, the character string is displayed in the input window while the input window is displayed.

The input candidate display control section 34 causes the input candidates sent from the input candidate assigning section 44 to be displayed on candidate selection keys on the input window.

The character string update section 35 updates character strings stored in the character string editing memory 36 in accordance with instructions from the operation acquiring section 31. Specifically, when acquiring an operation to input a character string, the operation acquiring section 31 instructs the character string update section 35 to insert the character string. Receiving the instruction, the character string update section 35 inserts the character string at the input position set in the character string editing memory 36 and thus updates the character string stored in the character string editing memory 36.

The character string editing memory 36 is a memory in which a character string inputted in the character input device 5 is temporarily stored in order to edit the character string. As described above, the input position is set to the character string in the character string editing memory 36, and editing of the character string in the character string editing memory 36 is performed at the input position.

The separating character judgment section 37 reads out the character string stored in the character string editing memory 36 and judges whether a character right before the input position set to the read-out character string is a separator or not. When the character right before the input position is a separator, the separating character judgment section 37 transmits the read-out character string to the first candidate determination section 38. When the character right before the input position is not a separator, the separating character judgment section 37 transmits the read-out character string to the second candidate determination section 39. Thus, an input candidate is outputted according to whether a separator exists or not.

When the character right before the input position is a separator, the first candidate determination section 38 regards as an input candidate a candidate of a word to be inputted after a word right before the separator. Further, when a continuous character string made of characters other than the separator right before the input position is identical with a word stored in the prediction memory 42, the first candidate determination section 38 regards as an input candidate a word stored in relation to the word. Further, when inputting a URL, the first candidate determination section 38 regards as an input candidate a predetermined character string according to whether “/” exists or not before the input position and after “://”.

In a case of inputting alphabets, when the input position is at the beginning of the character string or a space or a period exists right before the input position, the first candidate determination section 38 regards as an input candidate a switching process between inputting of lowercase alphabets and capital alphabets (Caps key). As described above, there is a case where the first candidate determination section 38 regards as an input candidate a predetermined process other than a character string. When the predetermined process is regarded as an input candidate and when the input candidate is selected, the predetermined process is carried out. That is, the first candidate determination section 38 has a function of assigning to the candidate selection key a process that is related to inputting of characters and that is other than inputting at the input position the character string of the input candidate.

When the character right before the input position is a character other than a separator, the second candidate determination section 39 regards as an input candidate a character string for completing as a word a right-before-character string that is a character string whose last character is a character right before the input position and which does not include a separator. Specifically, when the right-before-character string is identical with the top part of a word stored in the prediction memory 42, the second candidate determination section 39 regards as an input candidate a character string following the identical part of the word.

Further, when the right-before-character string is identical with a word stored in the prediction memory 42, the second candidate determination section 39 regards a separator as an input candidate. Further, when the right-before-character string is identical with a word stored in the prediction memory 42, the second candidate determination section 39 regards as an input candidate a separator stored in relation to the word.

Further, the second candidate determination section 39 refers to the one-character prediction memory 43 and regards as an input character a one-character candidate to be inputted after two characters right before the input position. How to determine a one-character candidate will be explained in an explanation of the one-character prediction memory 43.

In a case of inputting a URL (Uniform Resource Locator), when the number of characters from a separator right before the input position to a character right before the input position is more than a predetermined number, the second candidate determination section 39 regards a period as an input candidate.

In a case of inputting Japanese, when the right-before-character string is not subjected to hiragana/katakana-kanji conversion, the second candidate determination section 39 regards as an input candidate a process for subjecting the right-before-character string to hiragana/katakana-kanji conversion. As described above, there is a case where the second candidate determination section 39 regards as an input candidate a predetermined process other than a character string. When the predetermined process is regarded as an input candidate and when the input candidate is selected, the predetermined process is carried out. That is, the second candidate determination section 39 has a function of assigning to the candidate selection key a process that is related to inputting of characters and that is other than inputting at the input position the character string of the input candidate.

When the character string reading section 33 reads a character string from the outside of the character input device 5, the editing candidate determination section 40 regards as an input candidate at least one of a whole clear process (Clear key) on the read character string and a Space key. That is, the editing candidate determination section 40 has a function of assigning to the candidate selection key a process that is related to inputting of characters and that is other than inputting at the input position the character string of the input candidate (whole clear process on the read character string).

When a determination process (input on Done key) is performed, the learning section 41 cuts out a separator and a word from a character string stored in the character string editing memory 36, causes the word and the separator following the word to be stored in the prediction memory 42 in such a manner that the word and the separator following the word are related to each other, and causes two continuous words with the separator therebetween to be stored in the prediction memory 42 in such a manner that the two continuous words are related to each other. That is, when a character string is inputted in an input field with use of the character input device 5, the prediction memory 42 is updated by the learning section 41.

The prediction memory 42 is a database used when the first candidate determination section 38 and the second candidate determination section 39 determine input candidates. The prediction memory 42 is designed to be updated by the learning section 41. Consequently, the prediction memory 42 is updated to include a character string inputted and determined by the user, and therefore a word etc. that the user frequently uses is assigned as an input candidate to the candidate selection key. The prediction memory 42 and how to learn a character string will be detailed later.

The one-character prediction memory 43 is a database in which a character string made of any two characters and one character that is likely to follow the character string with high probability. Specifically, a plurality of one-character candidates are related to a character string made of any two characters in the order of probability that the one-character candidate follows the character string. With use of the database, the second candidate determination section can determine as an input candidate one character expected to follow two characters right before the input position. The one-character prediction memory 43 may be arranged so that a character string made of any three characters and one character that is likely to follow the character string with high probability are stored therein in such a manner that the character string and the character are related to each other.

Further, a separating character such as a space may be stored as a one-character candidate in the one-character prediction memory 43. For example, a character string “on” is frequently used at the end of a word. Therefore, by storing a space in relation to the character “on”, it is possible to make a space an input candidate when the character string “on” is inputted.

The input candidate assigning section 44 transmits, to the input candidate display control section 34, an input candidate that is determined by at least one of the first candidate determination section 38, the second candidate determination section 39, and the editing candidate determination section 40, and causes the input candidate to be displayed by a candidate selection key. Further, when character strings to be displayed by a plurality of candidate selection keys include a character string at the end of a character string right before the input position (inputted character string), the input candidate assigning section 44 unifies the character string at the end of the character string right before the input position (inputted character string).

[Configuration of Prediction Memory 42]

Here, the configuration of the prediction memory 42 is explained in more detail with reference to FIGS. 5-7. A data structure of the prediction memory 42 of the character input device 5 has a characteristic structure that is not seen in conventional arts. This data structure allows outputting an input candidate with high predictive accuracy on the basis of a small amount of data.

FIG. 5 is an example of the data structure of the prediction memory 42. As illustrated in FIG. 5, the prediction memory 42 has a data structure in which an index (i), a word character string (spell), separator information (sep(0)-sep(3)), word information (wd(0)-wd(3)), and priority (pri) are related to each other.

A word registered in the prediction memory 42 is stored as the word character string (spell). The word stored as the word character string (spell) is added by the learning section 41 performing a learning process. Words that are expected to be used with high frequency may be stored beforehand.

Separators (separator candidates) that follow the word character string (spell) are stored as the sep(0)-sep(3) of the separator information. Further, words (next word candidates) that follow the word character string (spell) are stored as the word information wd(0)-wd(3). The separator information and the word information are information indicative of a character string that follows the word character string (spell), i.e., connection information of the word character string (spell). The connection information is determined as input candidates when the word character string (spell) is identical with the character string right before the input position.

The priority (pri) is data indicative of a priority of the connection information used as an input candidate. The priority (pri) is used to make the number of input candidates equal to or smaller than the number of candidate selection keys when the number of input candidates is larger than the number of candidate selection keys. That is, when the number of input candidates is larger than the number of candidate selection keys, an input candidate with higher priority is determined out of a plurality of input candidates.

Here, it is assumed that priority is indicated by an integer of 0 or more, and an input candidate with priority closer to 0 has higher priority. Further, it is assumed that a word character string (spell) that is learnt most recently and connection information thereof are given highest priority. Consequently, input candidates are determined in accordance with what character strings the user has recently inputted.

Specifically, at the time when a word character string (spell) and connection information thereof are learnt, priorities of the word character string (spell) and the connection information thereof are set to zero. Thereafter, when other word character string (spell) and connection information thereof are learnt, priories of the word character string (spell) and the connection information thereof are set to zero and the priorities of the word character string (spell) having been already learnt and the connection information thereof are set to 1. Consequently, input candidates are determined in accordance with what character strings the user has recently inputted.

Setting priority is preferable since it allows narrowing down input candidates in accordance with the tendency of the user in inputting. However, setting priority is not essential in the character input device 5. Here, an explanation is made as to a case where the word character string (spell) that is learnt most recently and connection information thereof are given highest priorities. However, setting priority is not limited to this. For example, the present invention may be arranged so that the number or the frequency for the user to select a word character string (spell) and connection information thereof is counted, and the word character string (spell) and the connection information thereof with the number or the frequency being higher are given higher priorities.

The index (i) is an identification number assigned to a series of data consisting of a word character string (spell) and connection information related to the word character string (spell). That is, data consisting of the word character string (spell) and the connection information thereof, stored in the prediction memory 42, is managed by using index (i). Here, a series of data consisting of the index (i), the word character string (spell) and connection information related to the word character string (spell) is referred to as data of the index (i) or M(i).

FIG. 5 illustrates an example of the data structure of the prediction memory 42. The data structure of the prediction memory 42 employed in the character input device 5 is not limited to FIG. 5. Here, as illustrated in FIG. 4, there are four candidate selection keys A-D and therefore the number of candidates of character strings inputted next to a word character string (spell) is 4 at the maximum. Therefore, in the example of FIG. 5, the word character string (spell) is stored in relation to four separators sep(0)-sep(3) and four word information wd(0)-wd(3). The number of separators related to the word character string (spell) and the number of the word information may be changed as needed.

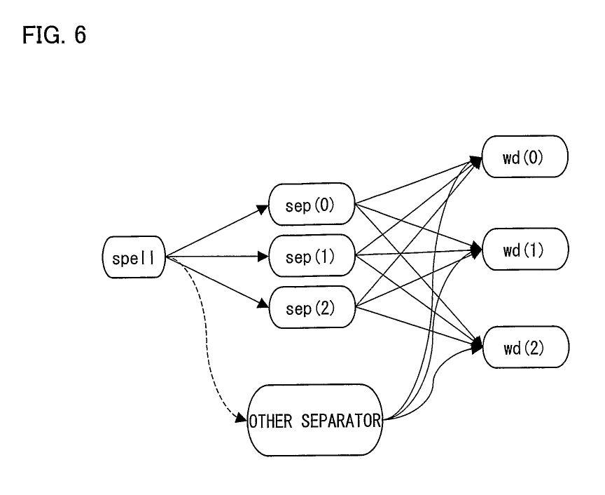

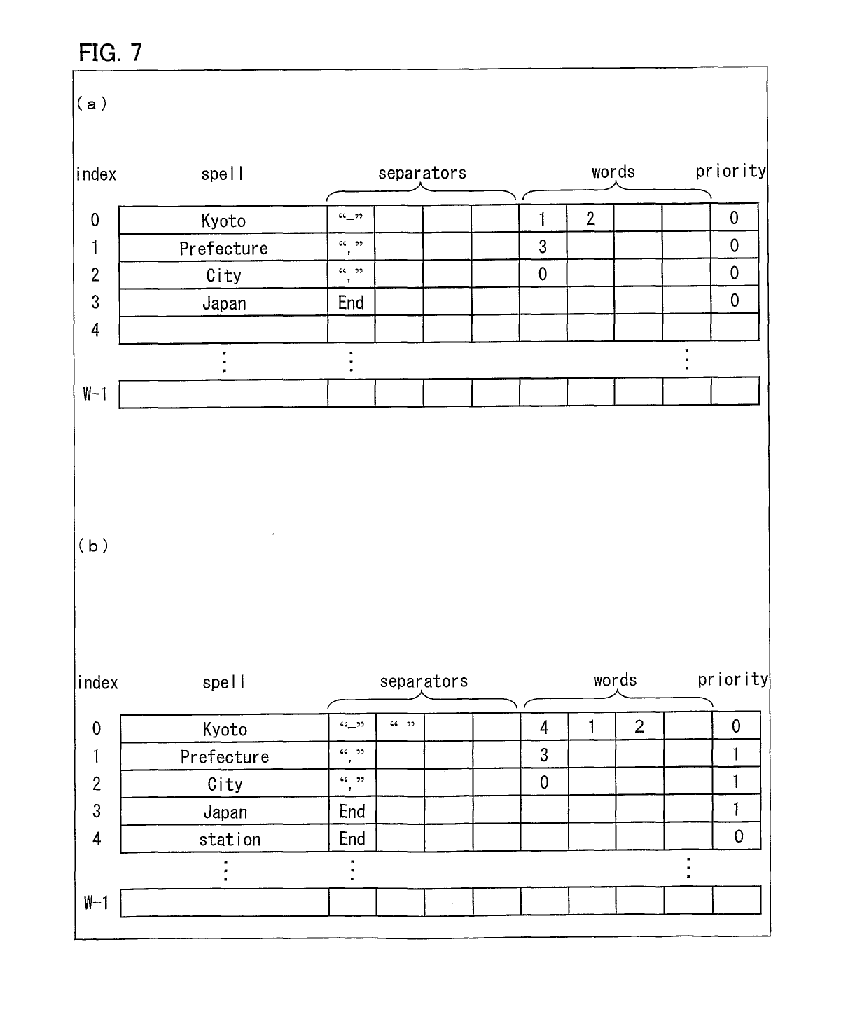

In the character input device 5, with use of the prediction memory 42 having the data structure, a separator inputted next to a word and a word inputted next to the separator are determined as input candidates. This is explained below with reference to FIG. 6. FIG. 6 is a drawing illustrating how to determine input candidates with use of data in the prediction memory 22. In FIG. 6, sep(0)-sep(2) out of sep(0) to sep(3) and wd(0)-wd(2) out of wd(0)-wd(3) are shown. Sep(3) and wd(3) are treated as with the sep(0)-sep(2) and wd(0) to wd(2).

As illustrated in FIG. 6, separators sep(0)-sep(2) follow the word character string (spell). The word information wd(0)-wd(2) follows the separators sep(0)-sep(2).

Here, as illustrated in FIG. 6, a separator other than the separators sep(0)-sep(2) may follow the word character string (spell). Even when the separator other than the separators sep(0)-sep(2) follows the word character string (spell), the word information wd(0)-wd(2) follows the separator.

That is, in the prediction memory 42, the word character string (spell) and the separators sep(0)-sep(3) that follow the word character string (spell) are stored in such a manner that the word character string (spell) and the separators sep(0)-(3) are related to each other. Therefore, when a character string right before the input position is identical with the word character string (spell), the separators sep(0)-sep(3) related to the word character string (spell) can be regarded as input candidates.

Further, in the prediction memory 42, the word character string (spell) and the word information wd(0)-wd(3) that follow the word character string (spell) are stored in such a manner that the word character string (spell) and the word information wd(0)-(3) are related to each other. Therefore, when a character string right before the input position is any separator (sep(0)-sep(3) or other separator) and a character string right before the separator is identical with the word character string (spell), the word information wd(0)-wd(3) related to the word character string (spell) can be regarded as input candidates.

[How to Learn]

In the character input device 5, when a determination process (Done key operation) is performed, the learning section 41 cuts off a separator and a word from a character string stored in the character string editing memory 36, causes the word and the separator following the word to be stored in the prediction memory 42 in such a manner that the word and the separator are related to each other, and causes two continuous words with the separator therebetween are stored in the prediction memory 42 in such a manner that the two continuous words are related to each other.

The following explains how data is stored in the prediction memory 42 with reference to FIG. 7. (a) of FIG. 7 illustrates an example of data stored in the prediction memory 42 as a result of learning. (b) of FIG. 7 illustrates an example of data stored in the prediction memory 42 when another character string is learnt in the state of (a) of FIG. 7.

Specifically, (a) of FIG. 7 illustrates an example of data stored in the prediction memory 42 when the determination process is performed while a character string “Kyoto-City, Kyoto-Prefecture, Japan” is stored in the character string editing memory 36.

As illustrated in (a) of FIG. 7, words included in the character string “Kyoto-City, Kyoto-Prefecture, Japan”, i.e., character strings “Kyoto”, “City”, “Prefecture”, and “Japan” are stored as word character strings (spells) related to indexes 0-3, respectively.

Further, in the character string “Kyoto-City, Kyoto-Prefecture, Japan”, a character following the word “Kyoto” is a separator “-”. Therefore, in the example of (a) of FIG. 7, “Kyoto” is stored in such a manner that “Kyoto” and “-” are related to each other. Similarly, “Prefecture” and “City” are stored in such a manner that “Prefecture” and “City” are related to separator information “,”.

In the example of (a) of FIG. 7, data “End” is stored as separator information for the character string “Japan”. This indicates that the determination process (Done key operation) was performed after the character string “Japan” was inputted. As described above, a predetermined process as well as a separator and a word may be stored in the prediction memory 42.

For example, in a case where the data in (a) of FIG. 7 is stored in the prediction memory 42, when the character string right before the input position is identical with “Japan”, the determination process (Done key) is determined as an input candidate. Consequently, when a user inputs a character string whose end is “Japan”, the user can smoothly determine the input character string. This is effective when repeatedly inputting the same character string, such as when inputting addresses, names, etc.

Further, in the character string “Kyoto-City, Kyoto-Prefecture, Japan”, words following “Kyoto” are “City” and “Prefecture”. Therefore, as illustrated in (a) of FIG. 7, indexes of “City” and “Prefecture” are stored as word information for “Kyoto”. Although word information may be a character string, word information being an index as in (a) of FIG. 7 allows reducing the amount of data in the prediction memory 42. Similarly, the index of “Japan” is stored as word information for “Prefecture” and the index of “Kyoto” is stored as word information for “City”.

In the example of (a) of FIG. 7, it is assumed that after the character string “Kyoto-City, Kyoto-Prefecture, Japan” was learnt, no other character strings are learnt. Consequently, priorities “0” are set to indexes 0-4 that are generated in the learning.

Here, when a character string “Kyoto Station” is learnt while the data illustrated in (a) of FIG. 7 is stored in the prediction memory 42, the data stored in the prediction memory 42 is updated to data illustrated in (b) of FIG. 7.

Since a new character string is learnt, priorities of data of indexes 0-3 that have been learnt in (a) of FIG. 7 change to 1. However, the word character string (spell) of data of the index 0 is also included in the newly learnt character string “Kyoto Station”, and therefore the data of the index 0 has the priority “0”.

Further, since the newly learnt character string “Kyoto Station” includes a word “Station” that was not stored in the data in (a) of FIG. 7, the word “Station” is added as data of the index 4. The fact that the character string “Kyoto Station” was learnt indicates that the determination process (Done key operation) was performed after the word “Station” was inputted and therefore “End” is stored as separator information of the data of the index 4. Further, since the data of the index 4 results from newest learning, the data of the index 4 is given priority “0”.

In the newly learnt character string “Kyoto Station”, a separator following “Kyoto” is “ ”(space) and a word following “Kyoto” is “Station”. Consequently, “ ”(space) is added as separator information of the data of the index 0 and the index 4 is added as word information of the data of the index 0.

(Learning Process)

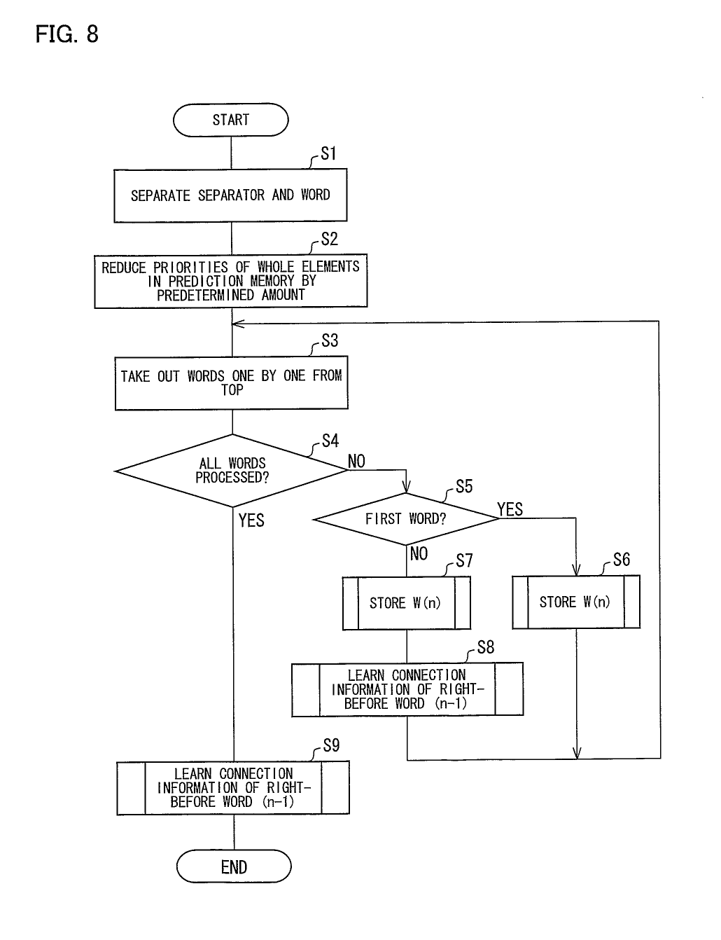

As described above, the character input device 5 includes the prediction memory 42 having the data structure as illustrated in FIGS. 5 and 7(a). When a new character string is learnt, the learning section 41 updates the data in the prediction memory 42 to data as illustrated in (b) of FIG. 7. The following explains a process for learning a character string and updating the prediction memory 42 with reference to FIGS. 8-12.

[Whole Flow of Learning Process]

FIG. 8 is a flowchart illustrating an example of the learning process. As described above, in the character input device 5, when the determination process (Done key operation) is performed while a character string is stored in the character string editing memory 36, the character string stored in the character string editing memory 36 is learnt. To be more specific, when the determination process (Done key operation) is performed, the operation acquiring section 31 informs the learning section 41 that the determination process (Done key operation) is performed. The learning section 41 thus informed reads out a character string from the character string editing memory 36. Thus, the learning process starts.

First, the learning section 41 separates the character string read out from the character string editing memory 36 into a separator and a word (S1). The learning section 41 regards a continuous character string separated by the separator as a word. What character string is regarded as a separator is determined beforehand.

Consequently, words W(0)-W(N) and separators S(0)-S(N) are acquired from the read-out character string. N is an integer of 0 or more. When the read-out character string does not include a separator, the character string is dealt with as a word. In this case, the separator is not stored, but the word and “End” are stored in such a manner that the word and “End” are related to each other.

Next, the learning section 41 reduces priorities of all factors in the prediction memory 42 by a predetermined amount (S2). Specifically, the learning section 41 increment priorities of all data of indexes stored in the prediction memory 42 by 1.

Subsequently, the learning section 41 serially takes out the words obtained by separating the character string, one by one, in such a manner that the word at the top of the character string is taken out first (S3). Here, the taken out word is regarded as W(n). 1N and n is an integer. The learning section 41 having taken out the word W(n) judges whether the word W(n) is the last (end) word of the character string or not (S4).

When the word W(n) is not the end word of the character string (NO in S4), the learning section 41 judges whether the word W(n) is at the first (top) word of the read-out character string or not (S5). When the word W(n) is the first word (YES in S5), the learning section 41 performs a registration process on the word W(n) (S6). After the registration process, the learning section 41 goes back to S3 and takes out a word.

On the other hand, when the word W(n) is not the first word (NO in S5), the learning section 41 performs the registration process on the word W(n) (S7), and then learns connection information between the word W(n) and a word W(n-1) right before the word W(n) (S8). Then, the learning section 41 learns the connection information and then goes back to S3 and takes out a word. Note that the process of S6 and the process of S7 are the same.

As described above, by repeating S3-S8, words serially taken out from the top of the read-out character string and connection information thereof are stored. Here, when the word W(n) taken out in S3 is the end word of the read-out character string (YES in S4), the learning section 41 learns connection information between the word W(n) and a word W(n-1) right before the word W(n) (S9), and finishes the learning process. Thus, all words included in the read-out character string are registered in the prediction memory 42 and connection information between the registered words is registered in the prediction memory 42. Note that the process of S8 and the process of S9 are the same.

[Word Registration Process]

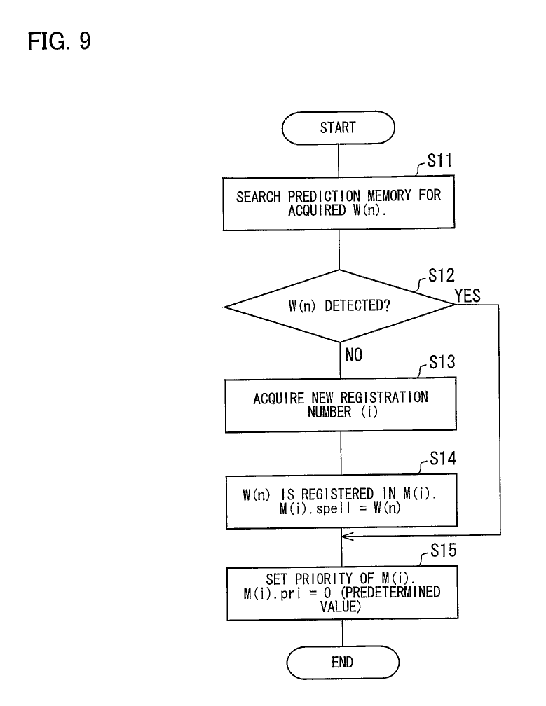

With reference to FIG. 9, the following details the word registration process (S6 and S7) in the flowchart in FIG. 8. FIG. 9 is a flowchart illustrating an example of the word registration process. First, the learning section 41 searches the prediction memory 42 for the word W(n) in order to confirm whether the word W(n) has been already registered in the prediction memory 42 (S11). Then, the learning section confirms whether the word W(n) is detected in the prediction memory 42 or not (S12).

When the word W(n) is not detected in the prediction memory 42 (NO in S12), the learning section 41 acquires a registration number (i) with which the word W(n) is to be registered (S13). The registration number (i) is an index. That is, the word W(n) is registered as data of an index (i) in M(i).

Next, the learning section 41 registers the word W(n) in M(i) (S14). Specifically, the learning section 41 registers the character string of the word W(n) as a word character string (spell) of M(i). Therefore, when the word character string (spell) of M(i) is referred to as M(i).spell, the process of S14 may be expressed as M(i).spell=W(n).

Then, the learning section 41 sets a priority of M(i) to which the word W(n) has been registered (S15). Here, it is assumed that the priority of data of the most newly registered index is set to zero. Therefore, the process of S15 can be expressed as M(i).pri=0 where M(i).pri is the priority (pri) of M(i).

On the other hand, when it is confirmed in S12 that W(n) is detected in the prediction memory 42 (YES in S12), the learning section 41 changes the priority of data of index whose word character string (spell) is W(n). For example, when W(n) is registered as a word character string (spell) in M(i) in the prediction memory 42, the learning section 41 changes the priority of M(i) to zero (S15).

As described above, in the word registration process, when the acquired word W(n) is not registered as a word character string (spell) in the prediction memory 42, the word W(n) is registered in M(i) in the prediction memory 42 and the priority of M(i) is set to zero. On the other hand, when the acquired word W(n) is registered as a word character string (spell) in the prediction memory 42, the priority of M(i) in which the word W(n) is registered is set to zero.

[Connection Information Registration Process (Separator Information Registration Process)]

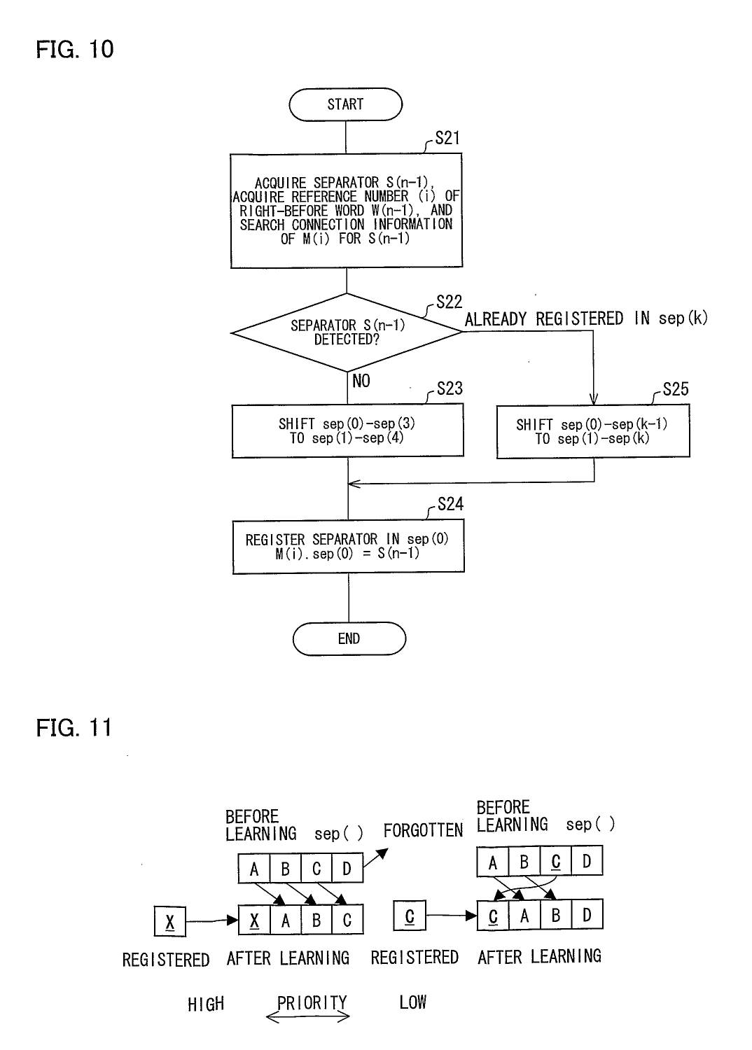

With reference to FIG. 10, the following details the connection information registration process (S8 and S9) in the flowchart of FIG. 8. The connection information registration process includes a separator information registration process for registering separator information and a word information registration process for registering word information. FIG. 10 illustrates an example of the separator information registration process.

First, the learning section 41 acquires a separator S(n-1) positioned between the acquired word W(n) and a word W(n-1) right before the word W(n). Next, the learning section 41 acquires a registration number (i) of the word W(n-1) and searches connection information of M(i) for S(n-1) (S21). Then, the learning section 41 confirms whether S(n-1) is detected or not in the connection information of M(i) (S22).

When it is not confirmed that S(n-1) is detected in the connection information of M(i) (NO in S22), the learning section 41 shifts sep(0)-sep(3) stored in separator information of the connection information of M(i) to sep(1)-sep(4) (S23). Note that, as illustrated in FIG. 5, the separator information here includes only four separators sep(0)-sep(3). That is, shifting to sep(4) indicates forgetting the information (deleting the information from the prediction memory 42). As described above, the number of separator information stored in the prediction memory 42 is always 4 or less, and therefore a storage capacity required for the prediction memory 42 does not increase even when the learning process is repeated.

On the other hand, when it is confirmed that S(n-1) is detected in the connection information of M(i) (YES in S22), the learning section 41 changes priorities in the separator information. That is, when S(n-1) is detected in sep(k) in the connection information of M(i), the learning section 41 shifts sep(0)-sep(k-1) to sep(1)-sep(k) (S25). 0≦k≦3 and k is an integer.

As described above, since the separator information is shifted in S23 or S24, sep(0) gets blank out of the separator information sep(0)-sep(3). The learning section 41 registers the separator S(n-1) in the blank sep(0) (S24). This process may be expressed as M(i).sep(0)=S(n-1).

Here, an explanation is made as to the processes of S23 and S25 with reference to FIG. 11. FIG. 11 is a drawing explaining how to update separator information. In FIG. 11, it is assumed that separators A-D are stored in separator information sep(0)-sep(3), respectively.

As illustrated in the left side of FIG. 11, when separator X different from the separators A-D is registered (S23 in FIG. 10), the separators A-D are shifted toward right side of FIG. 11. To be more specific, the separator A is shifted from sep(0) to sep(1), the separator B is shifted from sep(1) to sep(2), the separator C is shifted from sep(2) to sep(3). The separator D gets out of the separator information (gets forgotten). The newly registered separator X is registered in sep(0).

On the other hand, as illustrated in the right side of FIG. 11, when the separator C that has been already stored as the separator information is registered (S25 in FIG. 10), the separators A and B stored at the left side of the separator C are shifted toward the right side of FIG. 11. To be more specific, the separator A is shifted from sep(0) to sep(1), the separator B is shifted from sep(1) to sep(2). The position where the separator D is stored does not shift. The newly registered separator C is stored in sep(0).

As described above, the learning section 41 fixes the position where newly registered separator is to be stored and shifts the positions where already registered separators are stored with respect to each time a separator is newly registered. Thus, the separator information always includes the newest four separators.

Further, when the already registered separator is registered again, the registered separator is stored in the position where a newly registered separator is to be stored (sep(0)). Consequently, sep(0)to sep(3) are arrayed in the separator information in the order of registration, which can be used as priorities. For example, in a case where the number of input candidates is larger than the number of candidate selection keys, when it is necessary to make the number of input candidates equal to or less than the number of candidate selection keys, input candidates can be determined in the order of newest updating since it is unnecessary to rearrange the input candidates in the expecting process in accordance with priorities. [Connection Information Registration Process (Word Information Registration Process)]

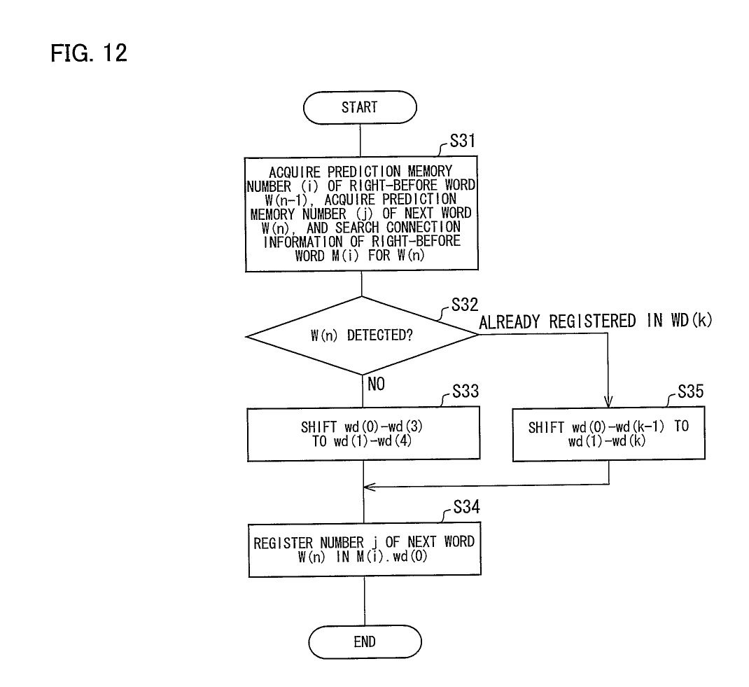

With reference to FIG. 12, the following details the connection information registration process (S8 and S9) in the flowchart of FIG. 8. As described above, the connection information registration process includes the separator information registration process for registering separator information and the word information registration process for registering word information. FIG. 12 illustrates an example of the word information registration process.

First, the learning section 41 acquires the number of a word W(n-1) right before the acquired word W(n) in the prediction memory 42, i.e., the index (i). Further, the learning section 41 acquires the index (j) of the acquired word W(n). Then, the learning section 41 searches the connection information (word information) of the word W(n-1) for the word W(n) (S31). Since it is assumed that the connection information in the prediction memory 42 includes indexes as illustrated in FIGS. 7(a) and 7(b), the learning section 41 searches the connection information (word information) of M(i) for the index (j) of the word W(n). Then, the learning section 41 confirms whether the index (j) is detected or not in the connection information of M(i) (S32).

When it is not confirmed that the index (j) is detected in the connection information of M(i) (NO in S32), the learning section 41 shifts wd(0)-wd(3) stored in the word information of the connection information of M(i) to wd(1)-wd(4), respectively (S33). As illustrated in FIG. 5, the word information includes only four word information wd(0)-wd(3). Therefore, shifting to wd(4) indicates forgetting the information (deleting the information from the prediction memory 42).

On the other hand, when it is confirmed that the index (j) is detected in the connection information of M(i) (YES in S32), the learning section 41 changes the priorities in the word information. That is, when the index (j) is detected in wd(k) of the connection information of M(i), the learning section 41 shifts wd(0)-wd(k-1) to wd(1)-wd(k), respectively (S35). 0≦k≦3 and k is an integer.

As described above, the word information is shifted in S33 or S34, and consequently wd(0) gets blank out of the word information wd(0)-wd(3). The learning section 41 registers the index (j) in the blank wd(0) (S34). This process can be expressed as M(i).wd(0)=j.

As described above, the learning section 41 fixes the position where newly registered word is stored and shifts the positions where already registered words are stored with respect to each time a word is newly registered. Thus, the word information always includes the newest four words.

Further, when the already registered word is registered again, the registered word is stored in the position where a newly registered word is to be stored (wd(0)). Consequently, wd(0)to wd(3) are arrayed in the word information in the order of registration, which can be used as priorities. For example, in a case where the number of input candidates is larger than the number of candidate selection keys, when it is necessary to make the number of input candidates equal to or less than the number of candidate selection keys, input candidates can be determined in the order of newest updating since it is unnecessary to rearrange the input candidates in the expecting process in accordance with priorities.

[Input Candidate Determination Process]

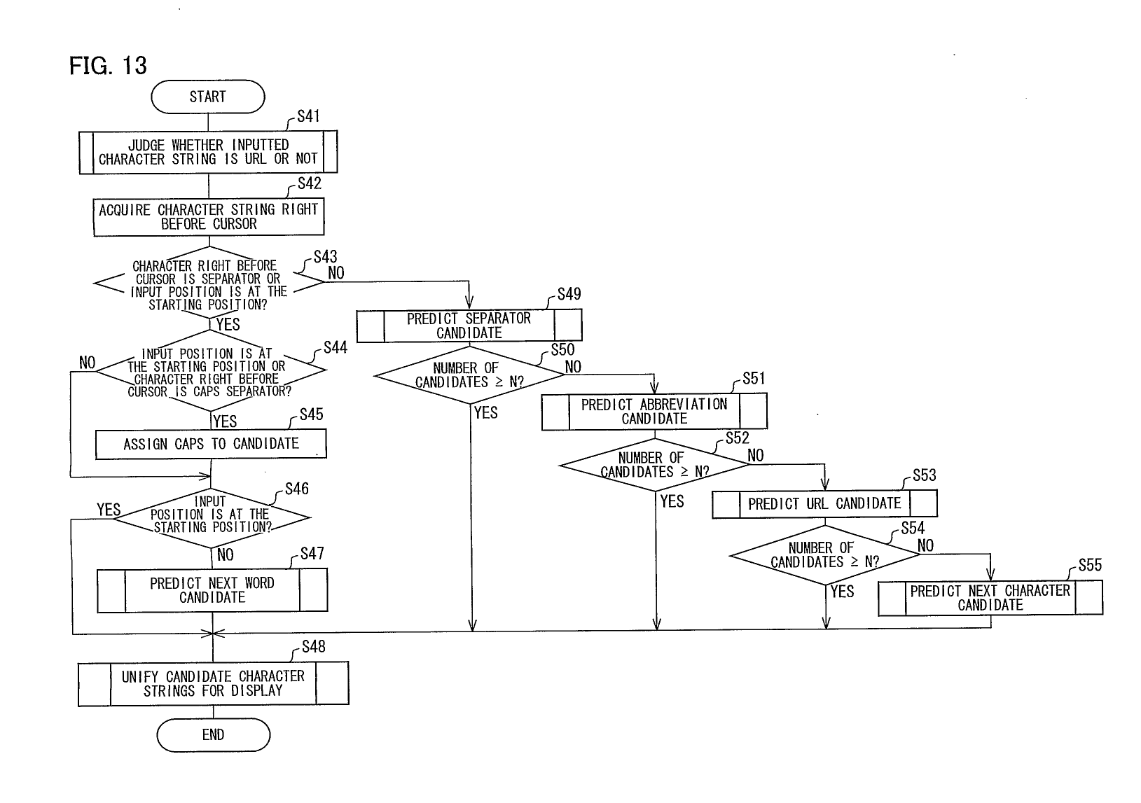

In the character input device 5, the first candidate determination section 38 or the second candidate determination section 39 determines an input candidate with use of the prediction memory 42 updated through the leaning process as explained above. The following explains an input candidate determination process with reference to FIGS. 13 to 23.

[Whole Flow of Input Candidate Determination Process]

An explanation is made as to the whole flow of the input candidate determination process with reference to FIG. 13. FIG. 13 is a flowchart illustrating an example of the input candidate determination process.

Here, the input candidate determination process is carried out with timing when a character string stored in the character string editing memory 36 is updated. Specifically, the input candidate determination process is carried out with timing when the character string editing memory 36 is updated by the character string update section 35 or with timing when the character string editing memory 36 is updated by the character string reading section 33. FIG. 13 does not illustrate the process carried out with timing when the character string editing memory 36 is updated by the character string reading section 33. Therefore, the process carried with that timing is explained first.

As described above, the character string reading section 33 causes a character string input in an input field to be stored in the character string editing memory 36. At that time, the character string reading section 33 informs the editing candidate determination section 40 that the character string was stored in the character string editing memory 36. When the editing candidate determination section 40 is informed that the character string was stored in the character string editing memory 36, the editing candidate determination section 40 transmits, to the input candidate assigning section 44, a process for completely deleting the character string stored in the character string editing memory 36 (Clear key) and a space key as input candidates.

This makes it easy for a user to completely delete the character string input in the input field and to input “ ”(space) after the character string input in the input field. This is convenient when performing keyword search in a search site etc.

For example, when a search keyword A is input in a predetermined position and the predetermined position is regarded as an input field, the character string of the search keyword A is read by the character string reading section 33 and is stored in the character string editing memory 36.

Here, when performing keyword search with another search keyword B instead of the search keyword A, it is necessary to completely delete the search keyword A. At that time, the above configuration allows the user to perform the process for completely deleting the character string (Clear key operation) with use of a candidate selection key.

When performing keyword search with the search keyword B added to the search keyword A, it is necessary to input “ ”(space) right after the search keyword A. At that time, the above configuration allows the user to input “ ”(space) with use of a candidate selection key, which is convenient. Note that in a case where the space key is always assigned to the candidate selection key as in the example of FIG. 4, the editing candidate determination section 40 does not treat the space key as an input candidate.

Here, the explanation of FIG. 13 is resumed below. When the character string editing memory 36 is updated by the character string reading section 33, a process of S41 in the flowchart of FIG. 13 is performed after the above process. On the other hand, when the character string editing memory 36 is updated by the character string update section 35, the input candidate determination process starts from the process of S41.

That is, when the character string editing memory 36 is updated by the character string update section 35 or the character string reading section 33, the separating character judgment section 37 reads out a character string stored in the character string editing memory 36, and judges whether the read-out character string is a URL or not (S41). When the read-out character string is a URL, the input candidate determination process switches to a URL mode. In the URL mode, the first candidate determination section 38 and the second candidate determination section 39 determine an input candidate suitable for inputting of a URL.

Next, the separating character judgment section 37 acquires a character right before a cursor (input position) in the read-out character string (S42). The separating character judgment section 37 judges whether the input position is a top of the character string or whether the acquired character is a separator (S43). When the input position is the top of the character string or when the acquired character is a separator, the separating character judgment section 37 transmits the read-out character string to the first candidate separation section 38. On the other hand, when the acquired character is not a separator, the separating character judgment section 37 transmits the read-out character string to the second candidate separation section 39.

When the input position is the top of the character string or the acquired character is a separator (YES in S43), the first candidate determination section 38 judges whether the character acquired by the separating character judgment section 37 is a Caps separator or not (S44). The Caps separator is a separator used when a capital alphabet may follow the separator. What separator is used as the Caps separator is predetermined. For example, “.”(period), “,”(comma), “ ”(space) etc. may be the Caps separator.

When the input position is the top of the character string or the acquired character is the Caps separator (YES in S44), the first candidate determination section 38 determines as an input candidate a process for switching between inputting of lowercase alphabets and inputting of capital alphabets (Caps key), and transmits the determined input candidate to the input candidate assigning section 44 (S45).

After determining in S45 as an input candidate the process for switching between inputting of lowercase alphabets and capital alphabets, or when the input position is not the top of the character string and the acquired character is not the Caps separator in S44 (NO in S44), the first candidate determination section 38 judges whether the input position is the top of the character string or not (S46).

When the input position is the top of the character string (YES in S46), the first candidate determination section 38 informs the input candidate assigning section 44 that the input candidate determination process has been completed. When the input candidate assigning section 44 is informed that the input candidate determination process has been completed, the input candidate assigning section 44 unify inputted characters of candidate character strings for display in order to cause the candidate selection key to display an input candidate (S48).

On the other hand, when the input position is not the top of the character string (NO in S46), the first candidate determination section 38 predicts a next word candidate (S47). A process for predicting the next word candidate is a process for determining as an input candidate a word that follows a word right before the input position. The first candidate determination section 38 transmits the determined input candidate to the input candidate assigning section 44 and informs the input candidate assigning section 44 that the input candidate determination process has been completed. Thus, the process goes to S48.

As described above, when it is judged in S43 that the cursor (input position) is at the top of the character string or that a character right before the cursor (input position) is a separator (YES in S43), the first candidate determination section 38 determines the input candidate. On the other hand, when it is judged in S43 that the character right before the cursor (input position) is not a separator (NO in S43), the second candidate determination section 39 determines the input candidate.

That is, when the character right before the input position is not a separator (NO in S43), the separating character judgment section 37 transmits the read-out character string to the second candidate determination section 39. When receiving the character string, the second candidate determination section 39 predicts a separator candidate (S49). Predicting the separator candidate is a process for determining as an input candidate a separator that follows a character string right before the input position. The second candidate determination section 39 transmits the determined input candidate to the input candidate assigning section 44.

Subsequently, the second candidate determination section 39 judges whether the number of input candidates determined in S49 is not less than N or not (S50). N is the maximum number of input candidates that can be assigned to candidate selection keys and is an integer of zero or more. In the example of FIG. 4, when a space key is fixed to one of the candidate selection keys 25, N=3. When the number of input candidates is not less than N (YES in S50), the second candidate determination section 39 informs the input candidate assigning section 44 that the input candidate determination process has been completed. Thus, the process goes to S48.

On the other hand, when the number of input candidates is less than N (NO in S50), the second candidate determination section 39 predicts an abbreviation candidate (S51). Predicting an abbreviation candidate is a process for determining as an input candidate a character string for completing a character string right before the input position as a word. The second candidate determination section 39 transmits the determined input candidate to the input candidate assigning section 44.

After the prediction of the abbreviation candidate, the second candidate determination section 39 confirms whether the total number of input candidates determined in S49 and S51 is not less than N or not (S52). When the number of input candidates is not less than N (YES in S52), the second candidate determination section 39 informs the input candidate assigning section 44 that the input candidate determination process has been completed. Thus, the process goes to S48.

On the other hand, when the number of input candidates is less than N (NO in S52), the second candidate determination section 39 predicts a URL candidate (S53). A process for predicting a URL candidate is a process for determining as an input candidate a predetermined character string etc. used when inputting a URL. The second candidate determination section 39 transmits the determined input candidate to the input candidate assigning section 44. Note that the prediction of a URL candidate is performed only when the input candidate determination process is set to the URL mode in S41. When the input candidate determination process is not set to the URL mode in S41, a process of S55 is performed after the process of S52.

After the prediction of a URL candidate, the second candidate determination section 39 confirms whether the total number of input candidates determined in S49, S51, and S53 is not less than N or not (S54). When the number of input candidates is not less than N (YES in S54), the second candidate determination section 39 informs the input candidate assigning section 44 that the input candidate determination process has been completed. Thus, the process goes to S48.

On the other hand, when the number of input candidates is less than N (NO in S54), the second candidate determination section 39 predicts a next character candidate (S55). A process for predicting a next character candidate is a process for determining as an input candidate a character candidate that follows two characters right before the input position. In S55, an input candidate of one character is determined in such a number as to allow the total number of input candidates determined in S49, S51, S53, and S55 to be not less than N. The second candidate determination section 39 transmits the determined input candidates to the input candidate assigning section 44 and informs the input candidate assigning section 44 that the input candidate determination process has been completed. Thus, the process goes to S48.

Note that the aforementioned input candidate determination process is an example, and the input candidate determination process is not limited to this example and may be arranged when needed. For example, the input candidate determination process in the flowchart of FIG. 13 is designed so as to be completed when the number of input candidates is not less than N. Therefore, when all input candidates are determined in an earlier process out of the processes of S49, S51, S53, and S55, processes subsequent to the earlier process are not performed.

Therefore, the input candidate determination process may be arranged such that the order of performing the processes of S49, S51, S53, and S55 are changed so as to initially perform a process for generating an input candidate that is preferably to be assigned to a candidate selection key out of input candidates generated in the processes of S49, S51, S53, and S55. For example, by exchanging the abbreviation candidate prediction process of S51 and the separator candidate prediction process of S49 with each other, when an input candidate is determined in the abbreviation candidate prediction process, the input candidate is surely assigned to a candidate selection key.

[Next Word Candidate Prediction Process]

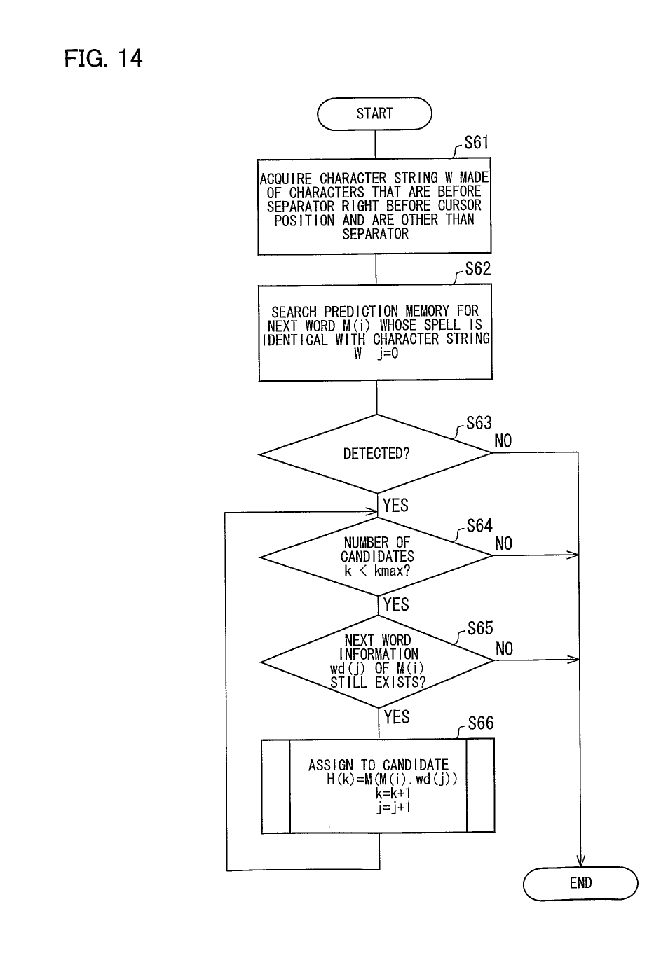

The following details the next word candidate prediction process with reference to FIG. 14. FIG. 14 is a flowchart illustrating an example of the next word candidate prediction process. The next word candidate prediction process corresponds to the process of S47 in the flowchart of FIG. 13. That is, the next word candidate prediction process is performed by the first candidate determination section 38.

Initially, the first candidate determination section 38 acquires a character string W from character strings stored in the character string editing memory 36 that are received from the separating character judgment section 37 (S61). The character string W is positioned before a separator right before the cursor position (input position) and is other than a separator. That is, the first candidate determination section 38 acquires a word right before the input position.

Next, the first candidate determination section 38 refers to the prediction memory 42 and searches for data of an index where a word character string (spell) corresponds to the character string W. The search is carried out from data of the index (0) in the ascending order. When data of an index where a word character string (spell) corresponds to the character string W is detected, the first candidate determination section 38 searches the detected data of an index for word information (S62).

Here, it is assumed that a word character string (spell) of M(i) corresponds to the character string W. Further, it is assumed that word information of M(i) is wd(j). In S62, M(i) where the word character string (spell) corresponds to the character string W is searched for.

When M(i) where the word character string (spell) corresponds to the character string W is not detected (NO in S63), the first candidate determination section 38 finishes the next word candidate determination process. That is, in this case, a next word is not outputted as an input candidate.

On the other hand, when M(i) where the word character string (spell) corresponds to the character string W is detected (YES in S63), the first candidate determination section 38 judges whether the total number k of input candidates transmitted to the input candidate assigning section 44 is smaller than the maximum number kmax of input candidates that can be assigned to candidate selection keys or not (S64). k is a natural number and kmax equals to N in FIG. 13.

When the total number of input candidates transmitted to the input candidate assigning section 44 is not less than kmax (NO in S64), the first candidate determination section 38 finishes the next word candidate determination process. On the other hand, when the total number of input candidates transmitted to the input candidate assigning section 44 is less than kmax (YES in S64), the first candidate determination section 38 refers to word information of M(i) and confirms whether the next word information wd(j) still exists or not (S65). The initial value of j is 0.

When the next word information wd(j) does not exist any more (NO in S65), the first candidate determination section 38 finishes the next word candidate prediction process. On the other hand, when the next word information wd(j) still exists (YES in S65), the first candidate determination section 38 determines wd(l) as an input candidate and transmits the determined input candidate to the input candidate assigning section 44 (S66). Then, the process goes to S64 again and the first candidate determination section 38 judges whether the number of candidates is smaller than kmax or not.

As described above, in the next word candidate prediction process, when a word corresponding to the character string W is detected in the prediction memory 42, the process carries on until the total number of input candidates is not less than kmax or all word information in data of an index where the character string W is registered is regarded as input candidates. In the present embodiment, the word information wd(j) is stored in the order of priority and input candidates are determined in the order of priority as illustrated in the flowchart of FIG. 14. Therefore, when the total number of input candidates is not less than kmax, the input candidate with highest priority is determined automatically.

(Separator Candidate Prediction Process)

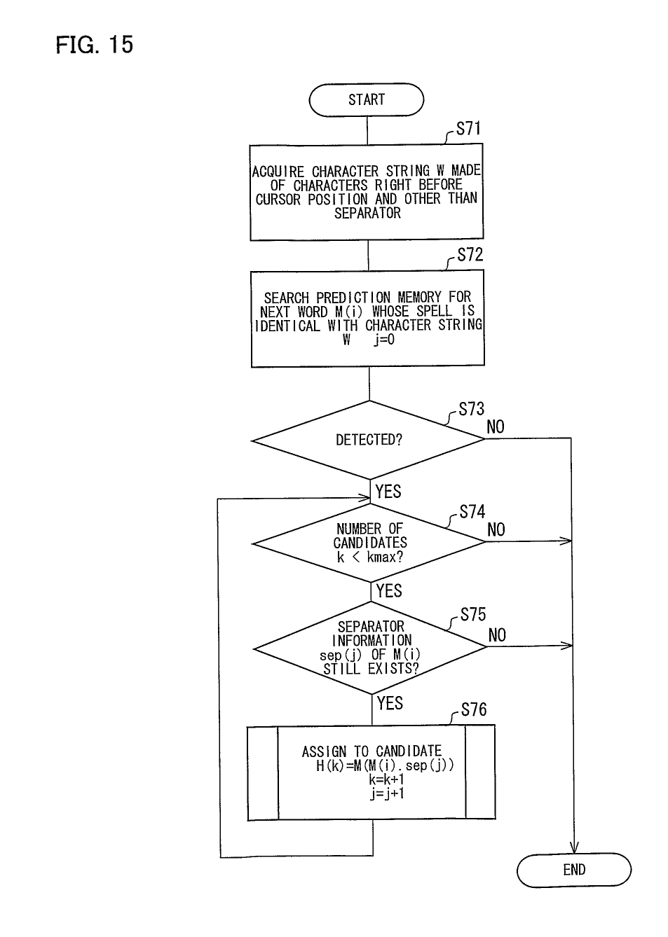

The following details the separator candidate prediction process with reference to FIG. 15. FIG. 15 is a flowchart illustrating an example of the separator candidate prediction process. The separator candidate prediction process corresponds to the process of S49 in the flowchart of FIG. 13. That is, the separator candidate prediction process is carried out by the second candidate determination section 39.

First, the second candidate determination section 39 acquires, from character strings having been received from the separating character judgment section 37 and stored in the character string editing memory 36, a character string W made of characters other than a separator right before the cursor position (input position) (S71). That is, the second candidate determination section 39 detects the separator right before the input position and acquires the character string W whose first character is next to the separator and whose last character is right before the input position. When the second candidate determination section 39 does not detect the separator right before the input position, the second candidate determination section 39 acquires whole character strings right before the input position as the character string W.

Next, the second candidate determination section 39 refers to the prediction memory 42 and searches for data of an index where a word character string (spell) corresponds to the character string W in an ascending order from data of the index (0). Here, when the data of an index where a word character string (spell) corresponds to the character string W is detected, the second candidate determination section 39 searches the detected data of an index for separator information (S72).

Here, it is assumed that the word character string (spell) of M(i) corresponds to the character string W. Further, it is assumed that separator information of M(i) is sep(j). In S72, M(i) where the word character string (spell) corresponds to the character string W is searched for. When M(i) where the word character string (spell) corresponds to the character string W is not detected (NO in S73), the second candidate determination section 39 finishes the separator candidate prediction process. That is, in this case, a separator is not output as an input candidate.

On the other hand, when M(i) where the word character string (spell) corresponds to the character string W is detected (YES in S73), the second candidate determination section 39 judges whether the total number of input candidates transmitted to the input candidate assigning section 44 is less than kmax or not (S74).

When the total number of input candidates transmitted to the input candidate assigning section 44 is not less than kmax (NO in S74), the second candidate determination section 39 finishes the separator candidate prediction process. On the other hand, when the total number of input candidates transmitted to the input candidate assigning section 44 is less than kmax (YES in S74), the second candidate determination section 39 refers to separator information of M(i) and confirms whether separator information sep(j) still exists or not (S75). An initial value of j is 0.

When the separator information sep(j) does not exist any more (NO in S75), the second candidate determination section 39 finishes the separator candidate prediction process. On the other hand, when the separator information sep(j) still exists (YES in S75), the second candidate determination section 39 determines sep(l) as an input candidate and transmits the determined input candidate to the input candidate assigning section 44 (S76). Then, the process goes to S74 again and the second candidate determination section 39 judges whether the number of candidates is less than kmax or not.

As described above, in the separator candidate prediction process, when a word corresponding to the character string W is detected in the prediction memory 42, the process continues until the total number of input candidates is not less than kmax or all separator information in data of an index where the character string W is registered is regarded as input candidates.

Further, in the present embodiment, separator information sep(j) is stored in the order of its priority, and input candidates are determined in accordance with the priority, as illustrated in the flowchart of FIG. 14. Consequently, when the total number of input candidates is not less than kmax, an input candidate with highest priority is determined automatically.

[Abbreviation Candidate Prediction Process]

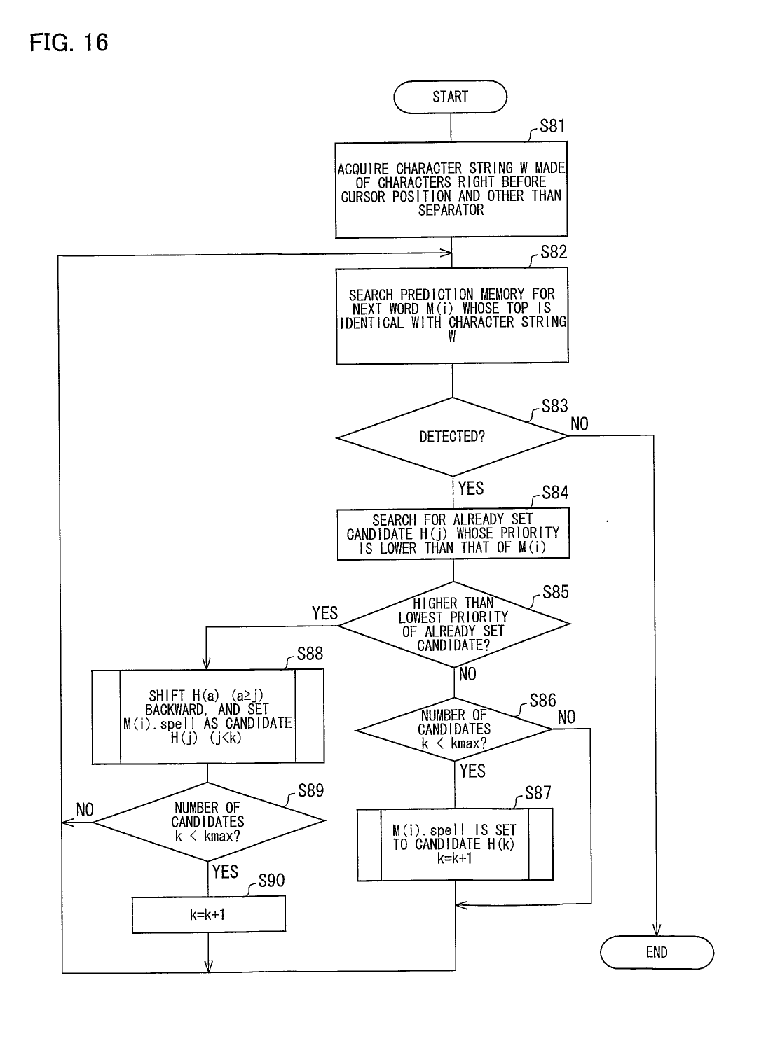

The following details the abbreviation candidate prediction process with reference to FIG. 16. FIG. 16 is a flowchart illustrating an example of the abbreviation candidate prediction process. The abbreviation candidate prediction process corresponds to the process of S51 in the flowchart of FIG. 13. That is, the abbreviation candidate prediction process is carried out by the second candidate determination section 39.

First, the second candidate determination section 39 acquires, from character strings having been received from the separating character judgment section 37 and stored in the character string editing memory 36, a character string W made of characters other than a separator right before the cursor position (input position) (S81). That is, the second candidate determination section 39 detects the separator right before the input position and acquires the character string W whose first character is next to the separator and whose last character is right before the input position. When the second candidate determination section 39 does not detect the separator right before the input section, the second candidate determination section 39 acquires whole character strings right before the input section as the character string W.

Next, the second candidate determination section 39 refers to the prediction memory 42 and searches for data of an index where the top of a word character string (spell) corresponds to the character string W in an ascending order from data of the index (0) (S82), and confirms whether data of an index where the top of the word character string (spell) corresponds to the character string W is detected or not (S83).

When data of an index where the top of the word character string (spell) corresponds to the character string W is not detected (NO in S83), the second candidate determination section 39 finishes the abbreviation candidate prediction process. That is, in this case, an abbreviation candidate is not output as an input candidate.

On the other hand, when data of an index where the top of the word character string (spell) corresponds to the character string W is detected (YES in S83), the second candidate determination section 39 detects priority of the detected data of index and searches abbreviation candidates already detected as input candidates (already set candidates) for an abbreviation candidate having priority lower than the priority of the detected data of index (S84). Then, the second candidate determination section 39 confirms whether the priority of the detected data of index is higher than the lowest priority of the already set candidates or not (S85).

Here, it is assumed that the top of the word character string (spell) of M(i) corresponds to the character string W. Further, the already set candidate is referred to as H(j) and the already set candidate with the lowest priority is referred to as H(a) (a≧j). Therefore, the process of S84 may be expressed as a process for searching for H(j) whose priority is lower than that of M(i) and the process of S85 may be expressed as a process for judging whether the priority of M(i) is higher than that of H(a) or not.

When the priority of M(i) is lower than that of H(a) (NO in S85), the second candidate determination section 39 judges whether the sum of the total number of input candidates transmitted to the input candidate assigning section 44 and of the total number of input candidates determined in the abbreviation candidate determination process is less than kmax that is the maximum number of input candidates that can be assigned to candidate selection keys (S86).

When the sum is not less than kmax (NO in S86), the second candidate determination section 39 goes back to the process of S82 and searches for data of index where the top of a word character string (spell) corresponds to the character string W in an ascending order from data of index (M(i+1)) next to M(i) whose priority has been compared.

On the other hand, when the sum is less than kmax (YES in S86), the second candidate determination section 39 determines the word character string of M(i) (M(i).spell) as an input candidate H(k) (S87). Then, the second candidate determination section 39 goes back to the process of S82 and searches for data of an index where the top of the word character string (spell) corresponds to the character string W in an ascending order from data of index (M(i+1)) next to M(i).

In S85, when the priority of M(i) is higher than that of H(a) (YES in S85), the second candidate determination section 39 shifts H(a) having priority lower than that of M(i) backward, and determines M(i).spell as an input candidate H(k) (S88). Here, shifting H(a) backward indicates dropping the priority of H(a) in the already set input candidates.

Next, the second candidate determination section 39 judges whether the sum of the total number of input candidates transmitted to the input candidate assigning section 44 and of the total number of input candidates determined in the abbreviation candidate determination process is less than kmax that is the maximum number of input candidates that can be assigned to candidate selection keys (S89).

When the sum is not less than kmax (NO in S89), the second candidate determination section 39 goes back to the process of S82 and searches for data of index where the top of the word character string (spell) corresponds to the character string W in an ascending order from data of index next to M(i).

On the other hand, when the sum is less than kmax (YES in S89), the second candidate determination section 39 determines the word character string of M(i) (M(i).spell) as an input candidate H(k) (S90). Then, the second candidate determination section 39 goes back to the process of S82 and searches for data of an index where the top of the word character string (spell) corresponds to the character string W in an ascending order from data of index next to M(i).

As described above, in the abbreviation candidate prediction process, of all word character strings stored in the prediction memory 42, word character strings whose tops correspond to the character string W is searched. Then, of the searched word character strings, a word character string with highest priority is determined as an input candidate.

[Next Word Candidate Prediction Process]

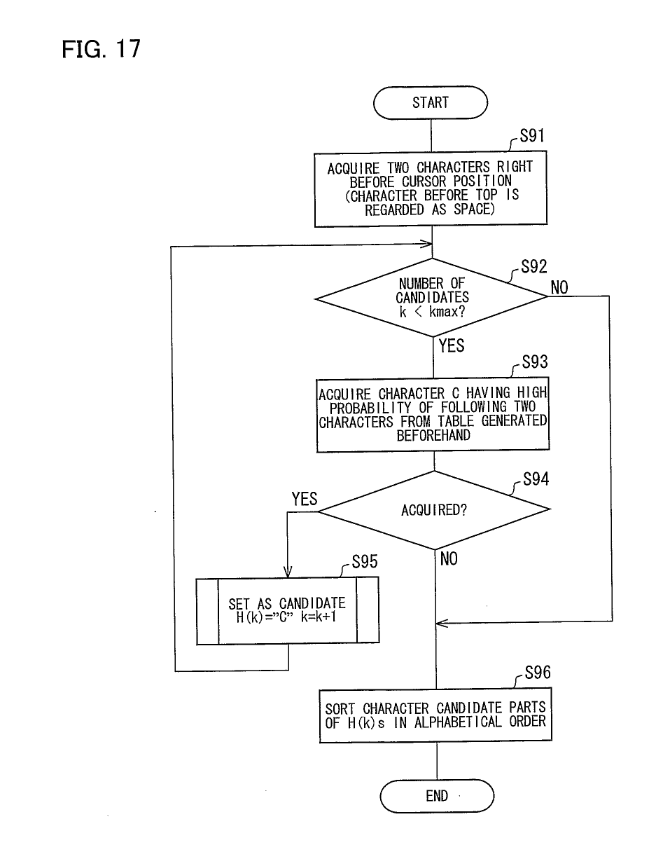

The following details the next character candidate prediction process with reference to FIG. 17. FIG. 17 is a flowchart illustrating an example of the next character candidate prediction process. The next character candidate prediction process corresponds to the process of S55 in the flowchart of FIG. 13. That is, the next character candidate prediction process is carried out by the second candidate determination section 39.

First, the second candidate determination section 39 acquires two characters right before the cursor position (input position) from a character string having been received from the separating character judgment section 37 and stored in the character string editing memory 36 (S91). The second candidate determination section 39 judges that a space is inputted before the top of a character string. For example, when only one character “a” is inputted right before the input position, the second candidate determination section 39 judges that “ ”(space) and “a” are inputted right before the input position.

Next, the second candidate determination section 39 judges whether the sum of the total number of input candidates transmitted to the input candidate assigning section 44 and of the total number of input candidates determined in the next character candidate determination process is less than kmax that is the maximum number of input candidates that can be assigned to candidate selection keys (S92). Here, the input candidate determined in the next character candidate determination process is referred to as H(k).

When the sum is not less than kmax (NO in S92) and a plurality of H(k)s are determined, the second candidate determination section 39 sorts character candidate parts of H(k)s in the alphabetical order (S96). The character candidate part of H(k) indicates one character following two characters right before the input position. Although the process of S96 is not essential, the process is preferable since it allows a user to more easily select a desired candidate selection key when the character candidate parts are sorted and displayed by candidate selection keys. When the sort process is finished in S96, the second candidate determination section 39 transmits the determined H(k)s to the input candidate assigning section 44 in the order in which H(k)s are sorted.

On the other hand, when the sum is less than kmax (YES in S92), the second candidate determination section 39 tries to acquire, from a table generated beforehand (one character prediction memory 43), a character C having high probability of following two characters right before the input position (S93), and confirms whether the character C is acquired or not (S94).

In a case where the second candidate determination section 39 succeeds in acquiring the character C (YES in S94), the second candidate determination section 39 determines the acquired character C as an input candidate (S95). Then, the second candidate determination section 39 goes back to the process of S92 and judges whether the sum of the total number of input candidates transmitted to the input candidate assigning section 44 and of the total number of input candidates determined in the next character candidate determination process is less than kmax that is the maximum number of input candidates that can be assigned to candidate selection keys.

On the other hand, in a case where the second candidate determination section 39 does not succeed in acquiring the character C (NO in S94), the second candidate determination section 39 goes to the process of S96, and when a plurality of H(k)s are determined, the second candidate determination section 39 sorts character candidate parts of H(k)s in the alphabetical order and transmits the sorted input candidates to the input candidate assigning section 44.

As described above, in the next character candidate prediction process, an input candidate of one character is determined so that the total number of input candidates determined in the separator candidate prediction process of S49 in FIG. 13, the abbreviation candidate prediction process of S51, the URL candidate prediction process of S53, and the next character candidate prediction process of S55 is equal to kmax that is the maximum number of input candidates that can be assigned to candidate selection keys.

[URL Candidate Prediction Process]

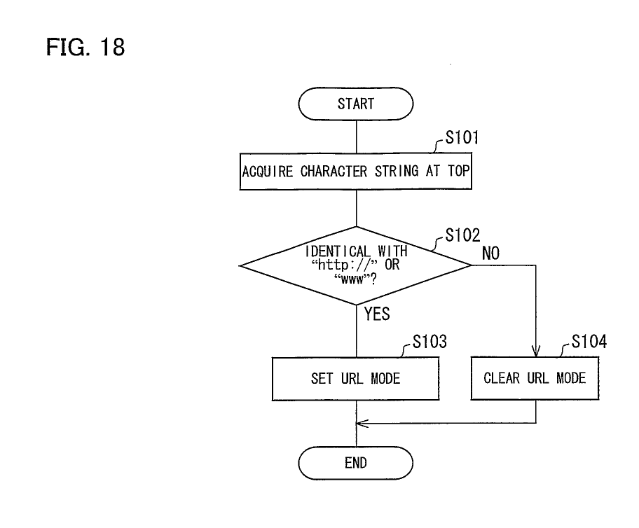

The following details the URL candidate prediction process with reference to FIGS. 18-20. As described above, the URL candidate prediction process is carried out when the URL mode is set in the process of S41 in the flowchart of FIG. 13. First, an explanation is made as to a process for setting the URL mode with reference to FIG. 18. FIG. 18 is a flowchart illustrating an example of the URL mode setting process. The URL mode setting process is carried out by the separating character judgment section 37.

The separating character judgment section 37 reads out a character string stored in the character string editing memory 36 and acquires a character string at the top of the read-out character string (S101). Then, the separating character judgment section 37 confirms whether the acquired character string at the top is identical with “http://” or “www” (S102).

When the separating character judgment section 37 confirms that the acquired character string at the top is identical with “http://” or “www” (YES in S102), the separating character judgment section 37 sets the URL mode (S103). Consequently, the process of S53 in the flowchart of FIG. 13 is carried out.

On the other hand, when the separating character judgment section 37 does not confirm that the acquired character string at the top is identical with “http://” or “www” (NO in S102), the separating character judgment section 37 clears the URL mode (S104). Consequently, the process of S53 in the flowchart of FIG. 13 is not carried out.

The processes of S101 and S102 are only examples and the URL candidate prediction process is not limited to them. For example, setting and clearing of the URL mode may be judged according to a character string other than the aforementioned character string. Specifically, the URL mode may be set when the character string at the top is identical with “https://” or the URL mode may be set when a character string includes a part of “http://”, “www”, and “https://” (e.g., “htt”, “http”, “:/”, “://” etc.). Further, it may be arranged so that information indicating that an input field is an input section for URL is received from an information processing device and the URL mode is set when receiving the information.

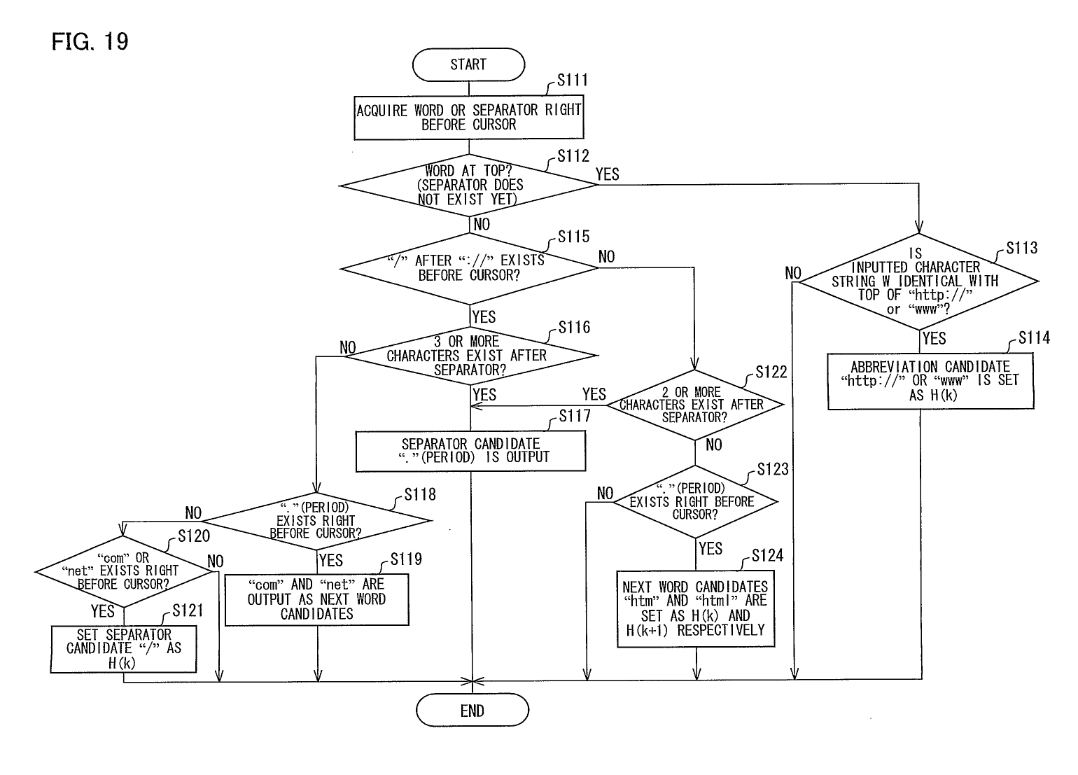

With reference to FIG. 19, an explanation is made as to the URL candidate prediction process that is carried out while the URL mode is set by the above process. FIG. 19 is a flowchart illustrating an example of the URL candidate prediction process.

FIG. 13 illustrates only the URL candidate prediction process carried out when a character right before the input position is not a separator (NO in S43). However, the URL candidate prediction process is carried out when a character right before the input position is a separator (YES in S43). In this case, the URL candidate prediction process is carried out between S43 and S44, between S45 and S46, or between S47 and S48. FIG. 19 illustrates both the URL candidate prediction process when a character right before the input position is not a separator and the URL candidate prediction process when a character right before the input position is a separator. The following firstly explains the URL candidate prediction process carried out by the second candidate determination process 39 and secondly explains the URL candidate prediction process carried out by the first candidate determination section 38.

First, the second candidate determination section 39 acquires a word or a separator right before the cursor (input position) (S111). That is, the second candidate determination section 39 acquires all character strings before the input position. Then, the second candidate determination section 39 confirms whether a character string right before the input position is a word at the top or not (S112). That is, the second candidate determination section 39 confirms whether a separator exists before the input position or not. When the separator does not exist, the second candidate determination section 39 judges that the character string right before the input position is a word at the top (or a part of a word at the top).

When the character string right before the input position is a word at the top (or a part of a word at the top) (YES in S112), the second candidate determination section 39 confirms whether the inputted character string W, i.e., the top of the character string right before the input position is identical with the top of “http://” or the top of “www” (S113). When the top of the character string right before the input position is not identical with the top of “http://” or the top of “www” (NO in S113), the second candidate determination section 39 does not determine an input candidate and finishes the URL candidate prediction process. Here, “http://” and “https://” are specially regarded as one word.

On the other hand, when the top of the character string right before the input position is identical with the top of “http://” or the top of “www” (YES in S113), the second candidate determination section 39 sets the abbreviation candidate “http://” or “www” as an input candidate H(k), and transmits the set input candidate H(k) to the input candidate assigning section 44. Setting the abbreviation candidate as the input candidate H(k) indicates determining as an input candidate a character string necessary for completing the character string right before the input position as a word. In this case, a character string necessary for completing the character string right before the input position as “http://” or “www” is determined as an input candidate.

Here, when it is confirmed in S112 that the word right before the input position is not a word at the top (NO in S112), the second candidate determination section 39 confirms whether “/” after “://” exists before the cursor (input position) (S115). That is, the second candidate determination section 39 confirms whether all character strings before the input position include the character string “://” and a character string after “://” and before the input position does not include “/” or not.

When all character strings before the input position include the character string “://” and a character string after “://” and before the input position does not include “/” (YES in S115), the second candidate determination section 39 confirms whether the number of characters after the separator is 3 or more, i.e., a character string whose first character is next to the separator right before the input position and whose last character is right before the input position is made of 3 characters or more (S116).

When the character string is made of 3 characters or more (YES in S116), the second candidate determination section 39 determines “.”(period) as an input candidate (S117). Then, the second candidate determination section 39 transmits the determined input candidate to the input candidate assigning section 44 and finishes the URL candidate prediction process.

Here, an explanation is made as to a case where a period is determined as an input candidate when 3 or more characters exist after the separator. However, the number of characters existing after the separator is not limited to 3 and may be any number in order that the period is determined as an input candidate. However, in general, when “/” does not exist after “://”, it is frequent that a period is input after 3 or more characters are input. Therefore, it is preferable that a period is determined as an input candidate with timing when 3 or more characters exist after the separator.

On the other hand, when a character string whose first character is next to the separator right before the input position and whose last character is right before the input position is made of 2 characters or less (NO in S116), the second candidate determination section 39 confirms whether the character string right before the input position is “.com” or “.net” or not (5120). In FIG. 19, a step of confirming whether “.” exists right before the cursor (input position) or not (S118) is inserted after S116. This is a step carried out only when the first candidate determination section 38 performs the URL candidate prediction process. The URL candidate prediction process performed by the first candidate determination section 38 will be mentioned later.

In S120, when the character string right before the input position is “.com” or “.net” (YES in S120), the second candidate determination section 39 determines the separator candidate “/” as an input candidate H(k) (S121). On the other hand, when the character string right before the input position is not “.com” or “.net” (NO in S120), the second candidate determination section does not determine an input candidate and finishes the URL candidate prediction process. Here, in S115, when a character string before the input position includes a character string “://” and a character string after “://” and before the input position includes “/” (NO in S115), the second candidate determination section 39 confirms whether 2 or more characters exist after the separator, i.e., whether a character string whose first character is next to the separator right before the input position and whose last character is right before the input position is made of 2 characters or more (S122).

When the character string is made of 2 characters or more (YES in S122), the second candidate determination section 39 determines “.”(period) as an input candidate (S117). Then, the second candidate determination section 39 transmits the determined input candidate to the input candidate assigning section 44 and finishes the URL candidate prediction process. On the other hand, when the character string whose first character is next to the separator right before the input position and whose last character is right before the input position is made of one character (NO in S122), the second candidate determination section 39 does not determine the input candidate and finishes the URL candidate prediction process.

Here, an explanation is made as to a case where a period is determined as an input candidate when 2 or more characters exist after the separator. However, the number of characters existing after the separator is not limited to 2 and may be any number in order that the period is determined as an input candidate. However, in general, when “/” exists after “://”, it is frequent that a period is input after 2 or more characters are input. Therefore, it is preferable that a period is determined as an input candidate with timing when 2 or more characters exist after the separator.

Subsequently, an explanation is made as to the URL candidate prediction process performed by the first candidate determination section 38. The URL candidate prediction process performed by the first candidate determination section 38 starts from S115 in FIG. 19. That is, the first candidate determination section 38 confirms whether the character string before the input position includes “/” after “://” (S115).

When all character strings before the input position include a character string “://” and a character string after “://” and before the input position does not include “/” (YES in S115), the first candidate determination section 38 confirms whether “.” exists right before the cursor (input position) (S118).

That is, in the URL candidate prediction process performed by the first candidate determination section 38, a separator exists right before the input position and therefore the process of S116 is not performed. In a case of YES in S115, the process of S118 is performed. Similarly, in a case of NO in S115, the process of S122 is not performed and the process of S123 is performed.

When “.” does not exist right before the input position (NO in S118), the first candidate determination section 38 does not determine an input candidate and finishes the URL candidate prediction process. On the other hand, when “.” exists right before the input position (YES in S118), the first candidate determination section 38 outputs “com” and “net” as next word candidates (S119). That is, the first candidate determination section 38 determines character strings “com” and “net” as input candidates, transmits the determined candidates to the input candidate assigning section 44, and finishes the URL candidate prediction process. The character string determined as an input candidate may be one of “com” and “net.” Further, “org” etc. may be determined as an input candidate in addition to the above examples.

Here, in S115, when all character strings before the input position includes a character string “://” and a character string after “://” and before the input position includes “/” (NO in S115), the first candidate determination section 38 confirms whether “.” exists right before the cursor (input position) or not (S123).

When “.” does not exist right before the input position (NO in S123), the first candidate determination section 38 does not determine an input candidate and finishes the URL candidate prediction process. On the other hand, when “.” exists right before the input position (YES in S123), the first candidate determination section 38 outputs “htm” and “html” as next word candidates (S124). That is, the first candidate determination section 38 determines character strings “htm” and “html” as input candidates, transmits the determined character strings to the input candidate assigning section 44, and finishes the URL candidate prediction process. Character strings determined as input candidates may be one of “htm” and “html”. Further, “asp” etc. may be determined as an input candidate.

As described above, in the URL candidate prediction process, an input candidate is dynamically determined according to whether a character right before the input position is a separator or not, according to how many characters exist from a separator right before the input position to a character right before the input position, and according to whether “/” exists before “://” or not. Consequently, an input candidate appropriate for an input situation is assigned to a candidate selection key, allowing a user to easily input a URL.

[Specific Example of URL Prediction]

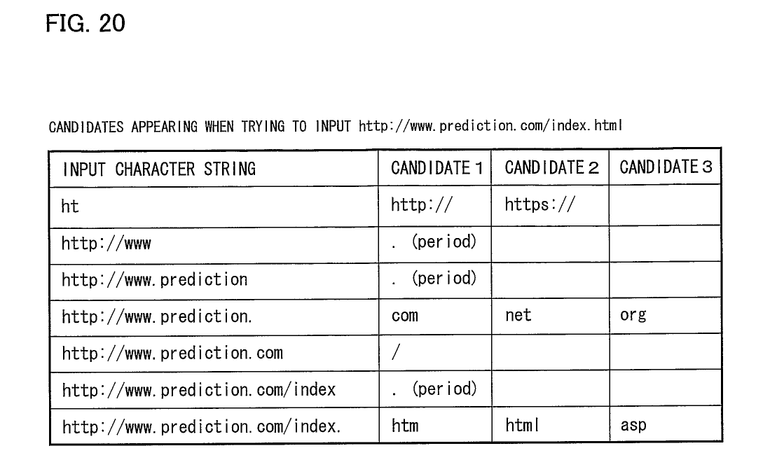

With reference to FIG. 20, the following explains a specific example of determining an input candidate in the URL candidate prediction process. FIG. 20 is a drawing illustrating an example of an input candidate determined in the URL candidate prediction process. FIG. 20 illustrates an example of an input character string and an example of an input candidate determined when the input character string is inputted (stored in the character string editing memory 36) in a case where “http://www.prediction.com/index.html” is inputted.

As illustrated in FIG. 20, when a character string “ht” is inputted (stored in the character string editing memory 36), “ht” is identical with the tops of “http://” and “https://” and therefore “http://” and “https://” are determined as input candidates through the processes of S113 and S114 in FIG. 19. Here, it is assumed that when the top of an input character string is identical with “ht”, the URL mode is set. Next, when a character string “http://www” is inputted (stored in the character string editing memory 36), the character string “http://www” does not have “/” after “://” and three characters (www) exist after the separator “/”(second separator) right before the input position and therefore “.”(period) is determined as an input candidate through the processes of S115-S117 in FIG. 19.

Next, when a character string “http://www.prediction” is inputted (stored in the character string editing memory 36), the character string “http://www.prediction.” does not have “/” after “://” and 3 or more characters (prediction) exist after “.” that is a separator right before the input position, and therefore “.”(period) is determined as an input candidate through the processes of S115-S117 in FIG. 19. At the stage where “pre” of “prediction” is inputted, “.”(period) is determined as an input candidate.

Next, when a character string “http://www.prediction.” is inputted (stored in the character string editing memory 36), the character string “http://www.prediction.” does not have “/” after “://” and “.” exists right before the input position, and therefore “com”, “net”, and “org” are determined as input candidates through the processes of S115, S118, and S119.

Next, when a character string “http://www.prediction.com” is inputted (stored in the character string editing memory 36), the character string “http://www.prediction.com” does not have “/” after “://” and not “/” but “.com” exists right before the input position, and therefore “/” is determined as an input candidate through the processes of S115, S118, S120, and S121 in FIG. 19.

Next, when a character string “http://www.prediction.com/index” is inputted (stored in the character string editing memory 36), the character string “http://www.prediction.com/index” has “/” after “://” and 2 or more characters exist after “/” that is the separator right before the input position, and therefore “.” is determined as an input candidate through the processes of S115, S122, and S117 in FIG. 19. At the stage where “in” of “index” is inputted, “.” is determined as an input candidate.

Then, when a character string “http://www.prediction.com/index.” is inputted (stored in the character string editing memory 36), the character string “http://www.prediction.com/index.” has “/” after “://” and “.” exists right before the input position, and therefore “htm”, “html”, and “asp” are determined as input candidates through the processes of S115, S123, and S124 in FIG. 19.

[Candidate Character String Generation Process]

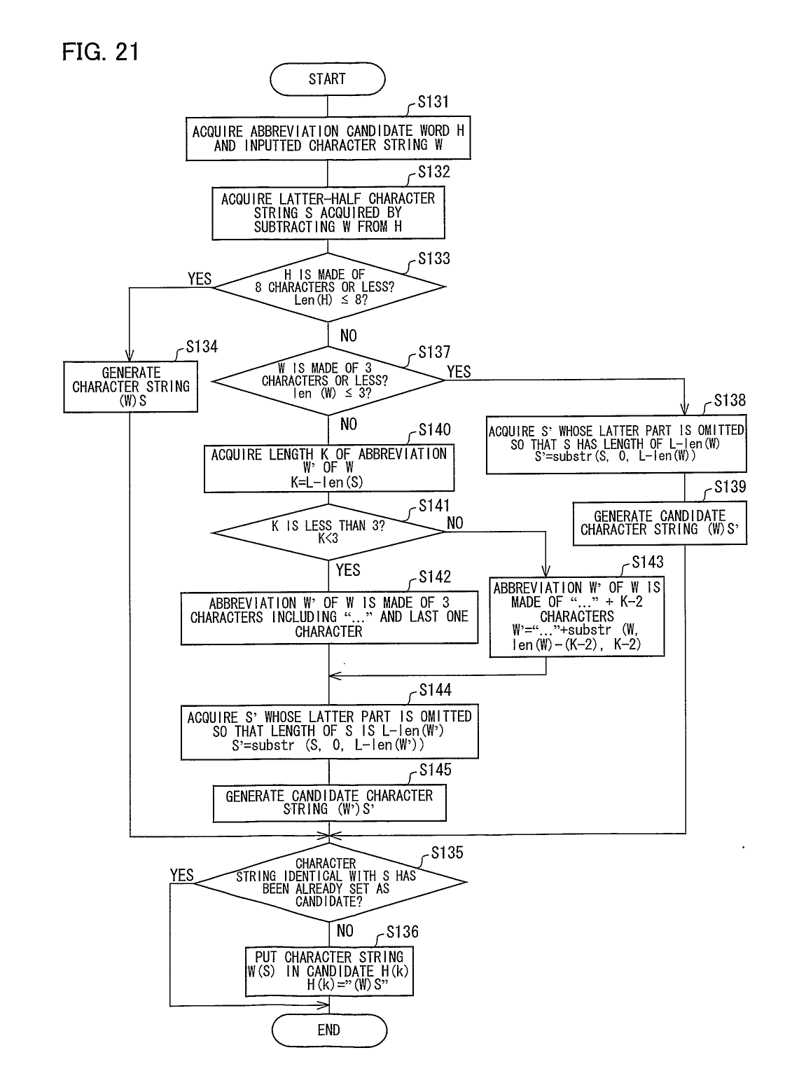

Next, with reference to FIG. 21, the following explains a candidate character string generation process for causing an input candidate determined through the above processes to be displayed by a candidate selection key. The candidate character string generation process is performed when the first candidate determination section 38 determines a next word candidate as an input candidate (S47 in FIG. 13), and when the second candidate determination section 39 determines a separator candidate, an abbreviation candidate, or a next character candidate as an input candidate (S51 and S55 in FIG. 13). Here, firstly, the process performed when the second candidate determination section 39 determines an abbreviation candidate as an input candidate is explained.

FIG. 21 is a flowchart illustrating an example of the candidate character string generation process. When the second candidate determination section 39 determines an abbreviation candidate as an input candidate, the second candidate determination section 39 acquires an abbreviation candidate word H and an inputted character string W (S131). The abbreviation candidate word H is a word detected in the abbreviation candidate prediction process. The inputted character string W is a character string that constitutes the abbreviation candidate word H and that has been already inputted, and is a character string right before the input position (character string whose first character is next to a separator right before the input position and whose last character is right before the input position).

Next, the second candidate determination section 39 obtains a latter-half character string S that is obtained by subtracting the inputted character string W from the abbreviation candidate word H (S132). Therefore, when the character string S obtained in this manner is inputted at the input position, the inputted character string W is completed as the abbreviation candidate word H. That is, the character string S is an input candidate. Here, S is referred to as a character string of an input candidate.

Next, the second candidate determination section 39 judges whether the abbreviation candidate word H is made of not more than 8 characters or not (S133). This is because it is assumed that the number of characters that can be displayed by a candidate selection key is 8. That is, when the number of characters in the abbreviation candidate word H is more than the number of characters that can be displayed by a candidate selection key, the abbreviation candidate word W could not be displayed by the candidate selection key without any change, and therefore it is judged in S133 whether the number of characters in the abbreviation candidate word H is more than the number of characters that can be displayed by the candidate selection key or not. Of course, when the number of characters that can be displayed by the candidate selection key changes, the number to be compared with the number of characters in the abbreviation candidate word H in S133 changes accordingly. The number of characters that can be displayed by the candidate selection key is hereinafter referred to as the number of displayable characters L.

When the abbreviation candidate word H is made of not more than 8 characters (YES in S133), the second candidate determination section 39 generates a character string (W)S (S134). That is, the second candidate determination section 39 generates a character string by combining the inputted character string W and the character string S of the input candidate. Here, a character string generated by combining a character string of an input candidate and an inputted character string is referred to as a candidate character string.

The inputted character string W is a portion of the abbreviation candidate word H that has been already inputted, and the character string S of the input candidate is a portion of the abbreviation candidate word H that has not yet been inputted. Therefore, the candidate character string generated in S134 is identical with the character string of the abbreviation candidate word H.

When the character string generated by combining the inputted character string W and the character string S of the input candidate is displayed, the character string is displayed in such a manner that the inputted character string W and the character string S of the input candidate are discernable from each other by a user. That is, parenthesizing W in the character string (W)S indicates making the inputted character string W and the character string S of the input candidate discernable from each other. How to display the inputted character string W and the character string S of the input candidate is not particularly limited as long as the user can discern the inputted character string W from the character string S of the input candidate. Here, it is assumed that the inputted character string W and the character string S of the input candidate are displayed in different colors.

Then, the second candidate determination section 39 confirms whether a character string identical with the character string S of the input candidate has been already set as an input candidate (S135). When a character string identical with the character string S of the input candidate has been already set as an input candidate (YES in S135), the second candidate determination section 39 does not determine the character string S of the input candidate as an input candidate and finishes the candidate character string generation process.

On the other hand, when a character string identical with the character string S of the input candidate has not been set as a candidate (NO in S135), the second candidate determination section 39 puts the character string W(S) in the candidate H(k) (S136). Thus, the character string W(S) is displayed by the candidate selection key. After determining the input candidate, the second candidate determination section 39 finishes the candidate character string generation process.

Here, in S133, when the abbreviation candidate word H is made of not less than 9 words (NO in S133), the second candidate determination section 39 judges whether the inputted character string W is not more than 3 characters or not (S137).

This is because in a case where the whole of the abbreviation candidate word H can not be displayed by the candidate selection key, when the abbreviation candidate word H is displayed by the candidate selection key, an inputted character string is indicated by 3 characters. Specifically, when the inputted character string is made of 4 or more characters in that case, the inputted character string is indicated by ( . . . + last one character of inputted character string). For example, when the inputted character string reads “abcde”, the inputted character string is indicated by “. . . e”.

When the inputted character string W is made of not more than 3 characters (YES in S137), the second candidate determination section 39 obtains a character string S′ of an input candidate. The latter part of the character string S′ is omitted so that the length of the character string S of the input candidate is (the number of displayable characters L—the number of characters in the inputted character string len(W)). That is, the second candidate determination section 39 regards a character string extending from the top of the character string S of the input candidate by L-len(W) characters as the character string S′ of the input candidate. The process of S137 is represented by S′=substr(S, 0, L-len(W)). Therefore, in this case, a combination of whole characters of the inputted character string W and the top portion S′ of the character string S of the input candidate is regarded as an input candidate. After generating the character string S′ of the input candidate, the second candidate determination section 39 goes to the process of 5135.

In S137, when the inputted character string W is made of not less than 4 characters (NO in S137), the second candidate determination section 39 calculates the length K of an abbreviated character string W′ of the inputted character string W (S140). Specifically, the second candidate determination section 39 calculates the length (the number of characters) K of the abbreviated character string W′ of the character string W by the equation K=L-len(S).

Subsequently, the second candidate determination section 39 judges whether the obtained value of K is less than 3 or not (S141). When K is less than 3 (YES in S141), the second candidate determination section 39 causes the abbreviated character string W′ of W to be made of 3 characters including “ . . . ” and “last one character of W” (S142). The process of S142 is represented by W′=“ . . . ”+substr(W,len(W)−1, 1).

On the other hand, when K is not less than 3 (NO in S141), the second candidate determination section 39 causes the abbreviated character string W′ to be made of “ . . . ” and “last (K-2) characters of W” (S143). The process of S143 is represented by W′=“ . . . ”+substr(W,len(W)-(K-2),K-2).

As described above, the second candidate determination section 39 obtains the abbreviated character string W′ of W in S142 or S143, and obtains the character string S′ by omitting the end character string of the character string S of the input candidate so that the length of the character string S is L-len(W′) (S144). The process of S144 is represented by S′=substr(S, 0, L-len(W′)).

Then, the second candidate determination section 39 generates a candidate character string (W′)S′ from the character string S′ and the abbreviated character string W′ of W (S145). The second candidate determination section 39 having generated the candidate character string (W′)S′ goes to the process of S135.

The second candidate determination section 39 generates a candidate character string as described above, and thus an inputted character string is displayed by a candidate selection key. This allows a user to more easily recognize what word is inputted by selecting what candidate selection key, increasing user's operativity.

Further, with the processes of S135 and S 136, an input candidate is determined while cutting characters in the number that is not more than the maximum number of characters that can be displayed by a candidate selection key. Consequently, when a plurality of input candidates have the same character string, only one of the input candidates having the same character string is assigned to the candidate selection key. This prevents the same character string from being assigned to a plurality of candidate selection keys, making effective use of the candidate selection key.

Similarly, when the second candidate determination section 39 determines a separator candidate or a next word candidate as an input candidate, a candidate H=W+S (S is a one-character candidate) is generated and then the process illustrated in FIG. 21 is carried out. Consequently, a combination of a character string right before the one-character candidate and the one-character candidate following the character string is displayed by a candidate selection key. Further, when the first candidate determination section 38 determines the next word candidate as an input candidate, the candidate character string process illustrated in FIG. 21 is performed while W=“ ”(blank character string). It may be arranged so that the candidate character string generation process is not performed for the separator candidate and the next word candidate.

[Candidate Character String Unification Process]

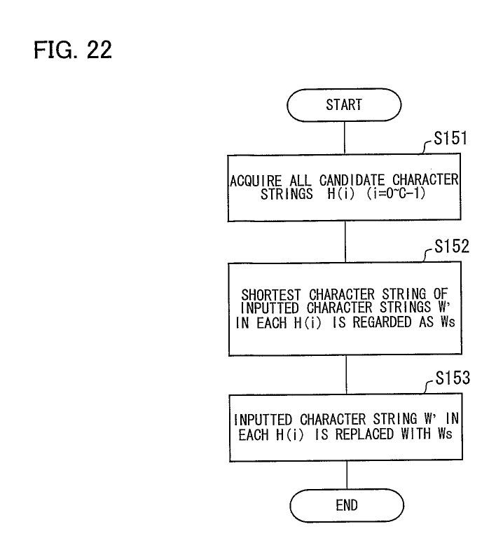

With reference to FIG. 22, the following details the candidate character string unification process performed in S48 in FIG. 13. FIG. 22 is a flowchart illustrating an example of the candidate character string unification process. The candidate character string unification process is carried out by the input candidate assigning section 44.

That is, when the input candidate assigning section 44 is informed by the first candidate determination section 38 or the second candidate determination section 39 that the input candidate determination process has been finished, the input candidate assigning section 44 acquires all candidate character strings received from the first candidate determination section 38 or the second candidate determination section 39 (S151). As described above, the candidate character string is a combination of a character string of an input candidate and an inputted character string. Here, the candidate character string is expressed as H(i) (0≦i≦C−1). i is an integer of 0 or more and C is the number of candidates that can be assigned to candidate selection keys.

Then, when a plurality of candidate character strings H(i) exist, the input candidate assigning section 44 regards as Ws the shortest character string (character string with the least characters) of inputted character strings W′ included in the detected candidate character strings (S152). The process of S152 is represented by Ws=min(W′(i)).

Then, the input candidate assigning section 44 replaces the inputted character strings W′ of the acquired candidate character strings with Ws (S153). The process of S153 is represented by W′(i)=W′s. After replacing the inputted character strings W′ of the candidate character strings with Ws, the input candidate assigning section 44 transmits all input candidates including the replaced candidate character strings to the input candidate display control section 34 and causes the input candidates to be displayed by the candidate selection keys.

As described above, in the candidate character string unification process, when a plurality of character strings displayed by candidate selection keys include inputted character strings W′, character strings at the ends of the character strings right before the input positions are unified into the shortest inputted character string W′, i.e., Ws. Consequently, inputted character strings displayed by individual candidate selection keys have the same length with respect to each candidate selection key, allowing a user to more easily distinguish an inputted character string from a character string of an input candidate to be inputted at the input position.

Note that the length of Ws is not necessarily unified into the length of the shortest inputted character string. As long as the lengths of the inputted character strings are the same in all input candidates, the user can easily distinguish the inputted character string from the character string of the input candidate to be inputted at the input position. However, when the lengths of the inputted character strings are unified into the length of the shortest inputted character string, the length of a displayed character string of an input candidate can be lengthened. Therefore, it is preferable that the inputted character strings are unified into the shortest inputted character string.

[Specific Example of Candidate Display]

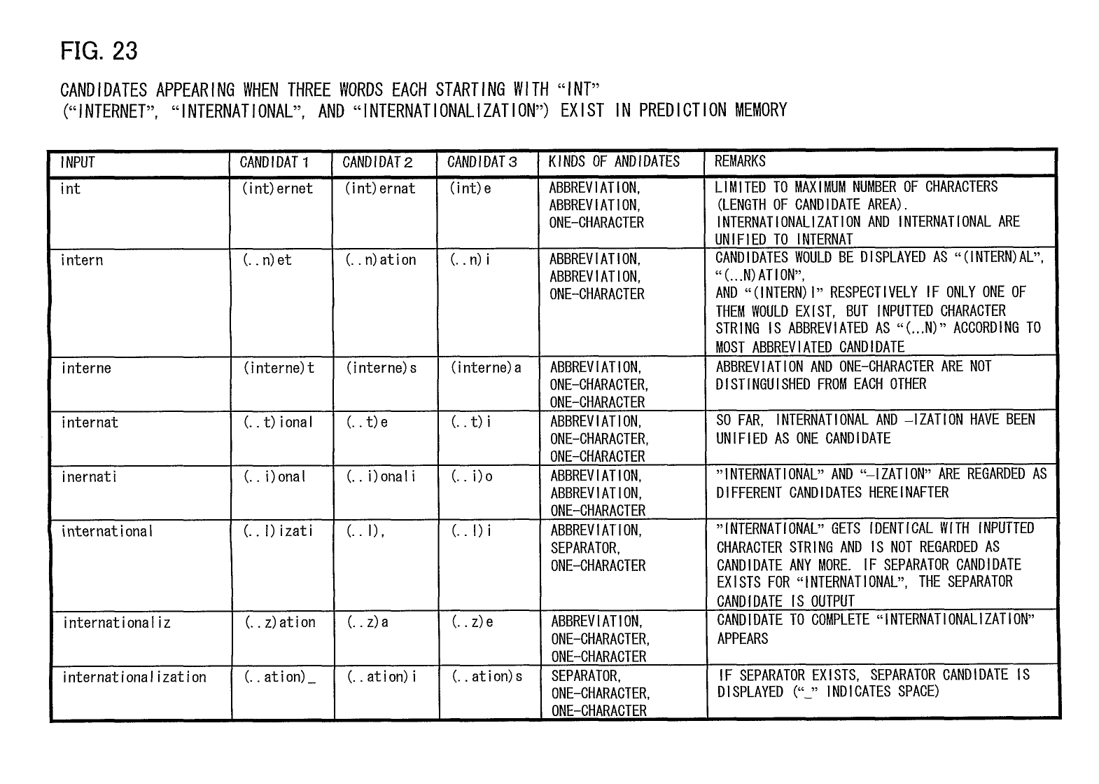

With reference to FIG. 23, the following explains a specific example of generating a candidate character string in the candidate character string generation process and the candidate character string unification process. FIG. 23 is a drawing illustrating an example of a candidate character string determined in the candidate character string generation process and the candidate character string unification process. FIG. 23 illustrates an example of an input character string and an example of a candidate character string displayed while the input character string is inputted (stored in the character string editing memory 36) in a case where three words “internet”, “international”, and “internationalization” are stored in the prediction memory 42.

When a character string “int” is inputted (stored in the character string editing memory 36), “int” is identical with the tops of “internet”, “international”, and “internationalization”, and therefore the three words are determined as input candidates through the abbreviation candidate determination process illustrated in FIG. 16. That is, the three words are regarded as the abbreviation candidate words H in FIG. 21.

Here, “internet” includes 8 characters (len(H)=8), “international” includes 13 characters (len(H)=13), and “internationalization” includes 20 characters (len(H)=20). Here, “int” is an inputted character string W.

Since the inputted character string W includes 3 characters, a character string S of the input character candidate “internet” is “ernet” (lens(S)=5), a character string S of the input candidate “international” is “ernational” (lens(S)=10), and a character string S of the input candidate “internationalization” is “ernationalization” (lens(S)=17).

Therefore, the abbreviation candidate word “internet” is expressed as “(int)ernet” that is a candidate character string obtained by combining the inputted character string “int” and the character string “ernet” of the input candidate through the processes of S133 and S134 in FIG. 21. Note that the parentheses added to “int” indicate that “int” and “ernet” are displayed in such a manner that they are discernable from each other. In reality, the inputted character string and the character string of the input candidate are displayed in any discernable manner, such as parenthesizing them and differently coloring them. The same holds for the following explanations.

In contrast, the abbreviation candidate words “international” and “internationalization” are subjected to the processes of S133 and S137 and then to the process of S138 in FIG. 21. In both of the abbreviation candidate words “international” and “internationalization”, S′ is “ernat.” Therefore, in the process of S139, the same candidate character string “(int)ernat” is generated for both “international” and “internationalization.”

The candidate character string generation process illustrated in FIG. 21 is carried out each time when one abbreviation candidate word H is detected. When one candidate character string is determined, the same candidate character string is not generated due to the process of S 135. Therefore, in this case, of two abbreviation candidate words “international” and “internationalization”, only one abbreviation candidate word that is determined as the abbreviation candidate word H previously is determined as the candidate character string “(int)ernat”. Note that the same candidate character string is displayed regardless of which of “international” and “internationalization” is determined as a candidate character string. Further, regardless of what word the displayed candidate character string is derived from, when the displayed candidate character string is selected, the same character string (“ernat” in this case) is inputted.

As described above, two candidate character strings “(int)ernet” and “(int)ernat” are generated. Here, it is assumed that there are three input candidates (N=3), and therefore one-character candidate is determined as an input candidate through the processes of S52 and S55 in FIG. 13. That is, one character that is likely to be inputted after two characters “nt” right before the input position is read out from the one character prediction memory 43 and is determined as an input candidate. In the example of the drawing, it is assumed that one character that is likely to be inputted after “nt” is “e.”

When one-character candidate is determined as an input candidate, a candidate character string is generated based on H=W+S in FIG. 21 as described above. That is, since the inputted character string W is assumed to be “int” here, a character string “(int)e” is generated as a candidate character string in the processes of S133 and S134 in FIG. 21.

Next, when a character string “intern” is inputted (stored in the character string editing memory 36), “(intern)et” is generated as a candidate character string from the abbreviation word candidate “internet” through the processes of S133-S135 in FIG. 21. Further, since “( . . . n)ation” is determined as a candidate character string both in the abbreviation candidate words “international” and “internationalization” through the processes of S133, S137, S140, S141, S143, S145, and S146 in FIG. 21, one of them is determined as a candidate character string in the process of 5135.

Then, one-character candidate is determined as a remaining input candidate. Here, it is assumed that one character that is likely to be inputted after two characters “rn” right before the input position is “i”. Further, the one-character candidate is subjected to the candidate character string generation process. In this case, the candidate character string is “(intern)i”.

As described above, when the character string “intern” is inputted, “(intern)et” is generated from “internet”, “( . . . n)ation” is generated from “international” and “internationalization”, and “(intern)i” is generated from the one-character candidate. The three candidate character strings include inputted character strings with different lengths (“intern” and “. . . n”).

The inputted character strings with different lengths are unified into the shortest inputted character string through the candidate character string unification process illustrated in FIG. 22. In this case, since “. . . n” is the shortest inputted character string, the inputted character strings are replaced with “. . . n” with respect to all candidate character strings including the inputted character strings. Consequently, three candidate character strings “( . . . n)et”, “( . . . n)ation”, and “( . . . n)i” are displayed as illustrated in the drawing.

Next, when a character string “interne” is inputted (stored in the character string editing memory 36), “(interne)t” is generated as a candidate character string from the abbreviation word candidate “internet” through the processes of S133-S135 in FIG. 21. Here, since the inputted character string “interne” is not identical with the tops of “international” and “internationalization”, these words are not regarded as abbreviation candidates.

Consequently, one-character candidates are determined as remaining two input candidates. Here, since last two characters of the inputted character string “interne” are “ne”, one-characters that are likely to follow “ne” with higher probability are serially determined as one-character candidates. Here, it is assumed that “s” and “a” are determined as the one-character candidates. These one-character candidates are subjected to the candidate character string generation process. In this case, the candidate character strings are determined as “(interne)s” and “(interne)a”.

As described above, when the character string “interne” is inputted, “(interne)t” is determined as a candidate character string based on “internet” and “(interne)s” and “(interne)a” are determined as candidate character strings based on the one character strings, and are displayed as illustrated in FIG. 23. Note that, as illustrated in the drawing, the abbreviation candidate and the one-character candidate are displayed in such a manner that they are not particularly discerned from each other.

On the other hand, when a character string “internat” is inputted (stored in the character string editing memory 36), the inputted character string “internat” is not identical with the top of “internet” and therefore “internet” is not regarded as an abbreviation candidate. In this case, “international” and “internationalization” are regarded as abbreviation candidates.

When candidate character strings are generated from the abbreviation candidates “international” and “internationalization” through the process in FIG. 21, a candidate character string “( . . . n)ional” is generated both in “international” and “internationalization”. Therefore, in this case, too, only the candidate character string “( . . . n)ional” is generated from “international” and “internationalization.”

Consequently, one-character candidates are determined as remaining two input candidates. Here, it is assumed that “e” and “i” are determined as one-character candidates. These one-character candidates are subjected to the candidate character string generation process and therefore “( . . . ernat)e” and “( . . . ernat)i” are determined as candidate character strings.

Since the three candidate character strings thus determined have inputted character strings with different lengths, the inputted character strings are unified into the inputted character string with the shortest length. Consequently, “( . . . n)ional”, “( . . . n)e”, and “( . . . n)i” are displayed as input candidates as illustrated in FIG. 23.

Next, when a character string “internati” is inputted (stored in the character string editing memory 36), the inputted character string “internati” is identical with the tops of “international” and “internationalization”, and therefore “international” and “internationalization” are regarded as abbreviation candidates.

When candidate character strings are generated from the abbreviation candidates “international” and “internationalization” through the process in FIG. 21, a candidate character string “( . . . n)onal” is generated from “international” and a candidate character string “( . . . n)onali” is generated from “internationalization”. That is, when “internati” is inputted, “international” and “internationalization” are regarded as different candidate character strings, and therefore candidate character strings derived from these two words are displayed as different input candidates.

Thereafter, a one-character candidate is determined in the aforementioned manner and the candidate character string unification process is performed. Consequently, “( . . . i)onal”, “( . . . i)onali”, and “( . . . i)o” are displayed as candidate character strings. “( . . . i)o” is an abbreviation candidate.

When a character string “international” is inputted (stored in the character string editing memory 36), the inputted character string “international” is completely identical with “international” and therefore it is judged whether a separator to be inputted after “international” exists or not through the process of S49 in FIG. 13, i.e., the separator candidate prediction process. Here, it is assumed that “,” is registered as separator information for “international” and therefore “,” is determined as an input candidate.

Further, since the inputted character string “international” is identical with the top of the “internationalization”, “internationalization” is regarded as an abbreviation candidate. When a candidate character string is determined from “internationalization” through the process of FIG. 21, a candidate character string “( . . . l)izati” is determined.

Two input candidates are determined through the above process and therefore a one-character candidate is determined in order to provide remaining one input candidate. Here, it is assumed that “i” is determined as a one-character candidate. Therefore, a candidate character string “(ational)i” is generated based on the determined one-character candidate through the candidate character string generation process.

Thus, all of three input candidates are determined and the determined three input candidates are subjected to the candidate character string unification process in FIGS. 22, and “( . . . l)izati”, “( . . . l),”, and “( . . . l)i” are displayed as candidate character strings as illustrated in FIG. 23. In this manner, when a separator is regarded as an input candidate, an inputted character string may be displayed in addition to the separator.

Next, when a character string “internationaliz” is inputted (stored in the character string editing memory 36), the inputted character string “internationaliz” is identical with the top of “internationalization” and therefore “internationalization” is regarded as an abbreviation candidate. When a candidate character string is determined from “internationalization” through the process in FIG. 21, a candidate character string “( . . . z)ation” is determined.

Then, one-character candidates are determined as remaining two input candidates. Here, it is assumed that “a” and “e” are determined as input candidates. The determined one-character candidates are subjected to the candidate character string generation process and candidate character strings including the inputted character string are provided.

Thus, all of the three input candidates are determined and the determined three input candidates are subjected to the candidate character string unification process in FIG. 22 and “( . . . z)ation”, “( . . . z)a”, and “( . . . z)e” are displayed as candidate character strings in FIG. 23. In this manner, when “internationaliz” is inputted, a character string for completing the word “internationalization” is displayed to the last character.

Lastly, when a character string “internationalization” is inputted (stored in the character string editing memory 36), the inputted character string “internationalization” is completely identical with “internationalization” and therefore it is detected whether a separator to be inputted after “internationalization” exists or not through the separator candidate prediction process. Here, it is assumed that “ ”(space) is registered as separator information for “internationalization” and therefore “ ”(space) is determined as an input candidate.

Then, one-character candidates are determined as remaining two input candidates. Here, it is assumed that “i” and “s” are determined as input candidates. The determined one-character candidates are subjected to the candidate character string generation process and candidate character strings including the inputted character string are provided.

Thus, all of the three input candidates are determined and the determined three input candidates are subjected to the candidate character string unification process in FIG. 22 and “( . . . n)_”, “( . . . n)i”, and “( . . . n)s” are displayed as candidate character strings as illustrated in FIG. 23. Note that the space is indicated by an underline (_) in FIG. 23. In this manner, a space may be indicated by a certain sign or may be indicated by a character string “Space” as illustrated in FIG. 4. The point is that a space should be indicated in such a manner as to allow a user to recognize that operating the candidate selection key would make a space inputted.

### Specific Examples

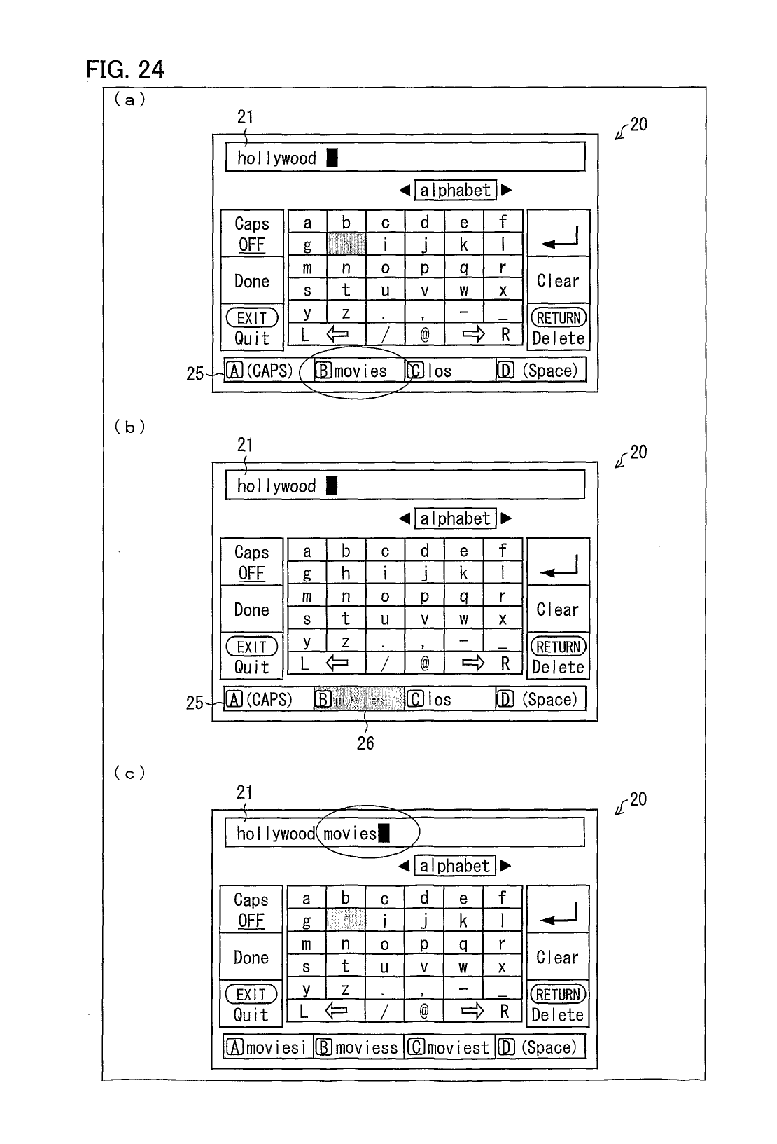

With reference to FIGS. 24-41, the following explains display examples of inputting characters with use of the input window 20 illustrated in FIG. 4 by the remote control device 4 illustrated in FIG. 3.

[Example of Inputting Input Candidate Displayed by Candidate Selection Key]

FIG. 24 is a drawing explaining how to input an input candidate assigned to the candidate selection key 25. Here, it is assumed that a word “Hollywood” is registered in the prediction memory 42 and “movies” and “los” are registered as word information for “Hollywood”.

Further, as illustrated in (a) of FIG. 24, in the input frame 21, a space is inputted after the character string “Hollywood” and a cursor is displayed after the space. The position of the cursor is the input position.

As described above, in the character input device 5, when a character string stored in the character string editing memory 36 is updated, the character string display control section 32 causes a character string stored in the character string editing memory 36 to be displayed in the input frame 21. Therefore, a newest character string stored in the character string editing memory 36 is displayed in the input frame 21. At the newest character string stored in the character string editing memory 36, the position of the cursor is set to the input position.

In the example of (a) of FIG. 24, since a space is provided right before the input position, a process for switching between a capital alphabet and a lowercase alphabet (Caps key) is assigned to the candidate selection key 25 through the processes of S41-S45 in FIG. 13. Here, it is assumed that “movies” and “los” are registered as word information for “Hollywood” and therefore “movies” and “los” are assigned to the candidate selection keys 25 through the processes of S41-S46 in FIG. 13.

Specifically, in the example of the drawing, the Caps key is assigned to the candidate selection key 25 indicating a character “A”, “movies” is assigned to the candidate selection key 25 indicating a character “B”, and “los” is assigned to the candidate selection key 25 indicating a character “C”. Further, the space key is fixedly assigned to the candidate selection key 25 indicating a character “D”.

When the candidate determination button 15 indicating a character “B” is pressed among the candidate determination buttons 15 of the remote control device 4 in FIG. 3, the input candidate “movies” assigned to the candidate selection key 25 indicating “B” is inputted at the input position. In this manner, usage of the candidate determination button 15 allows inputting the character string “movies” with one touch of the button.

When the determination button 11 of the remote control device 4 is pressed while the focus 26 is put on the candidate selection key 25 indicating “B” as illustrated in (b) of FIG. 24, the input candidate “movies” assigned to the candidate selection key 25 indicating “B” is inputted at the input position as illustrated in (c) of FIG. 24. In this case, too, it is possible to more easily and promptly input “movies” than a case where “movies” is inputted by selecting characters one by one from the character input keys 23.

[Display Example of Dynamically Assigning Caps Key]

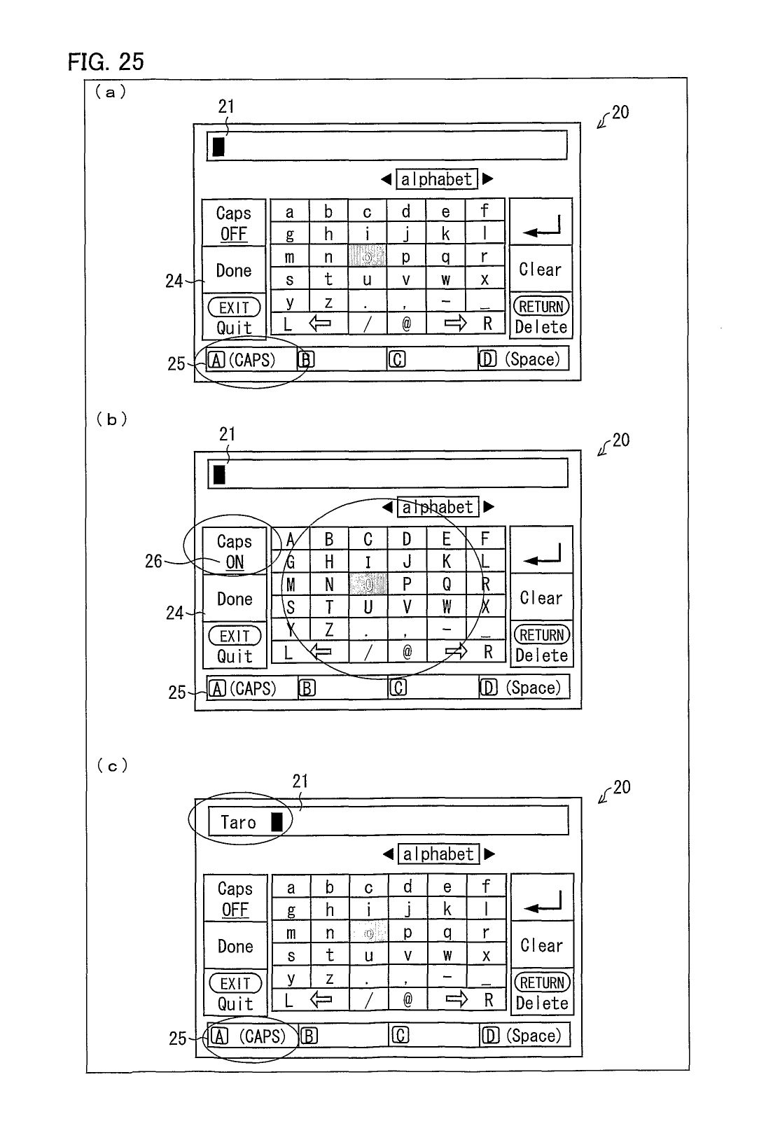

FIG. 25 is a drawing illustrating a display example of assigning the Caps key to the candidate selection key 25. In (a) of FIG. 25, a character is not displayed in the input frame 21 and a cursor is displayed at the left end of the input frame. That is, (a) of FIG. 25 illustrates a state where the input position is at the starting position.

In the character input device 5, when the input position is at the top, the process for switching a capital alphabet and a lowercase alphabet, i.e., the Caps key, is assigned to the candidate selection key 25 through the processes of S44 and S45 in FIG. 13, as illustrated in (a) of FIG. 25. In the example of the drawing, the Caps key is assigned to the candidate selection key 25 indicating “A”, as in the example of (a) of FIG. 24. Assigning a specific process to a specific one of the candidate selection keys 25 in this manner is preferable since it allows a user to more easily recognize which key the specific process is assigned to.

In the state of (a) of FIG. 25, when an input operation is performed on the candidate selection key 25 indicating “A”, the input window 20 is updated to be in the state of (b) of FIG. 25. Note that performing the input operation on the candidate selection key 25 indicates pressing the candidate determination button 15 corresponding to the candidate selection key 25 or putting the focus 26 on the candidate selection key 25 and pressing the determination button 11, as explained with respect to FIG. 24.

In (b) of FIG. 25, display of the Caps key that is an editing process key is changed to “Caps ON”. Further, character input keys are changed to keys indicative of capital alphabets. Here, the input position remains to be at the top of characters, and therefore the Caps key continues to be assigned to the candidate selection key 25 indicating “A”.

Further, in the character input device 5, when a character right before the input position is a Caps separator, the Caps key is assigned to the candidate selection key 25 through the processes of S44 and S45 in FIG. 13. Consequently, as illustrated in (c) of FIG. 25, when a character string is inputted in the input frame 21 and when a space (Caps separator) exists right before the input position, the Caps key is assigned to the candidate selection key 25.

[Display Example of Dynamically Assigning Space Key]

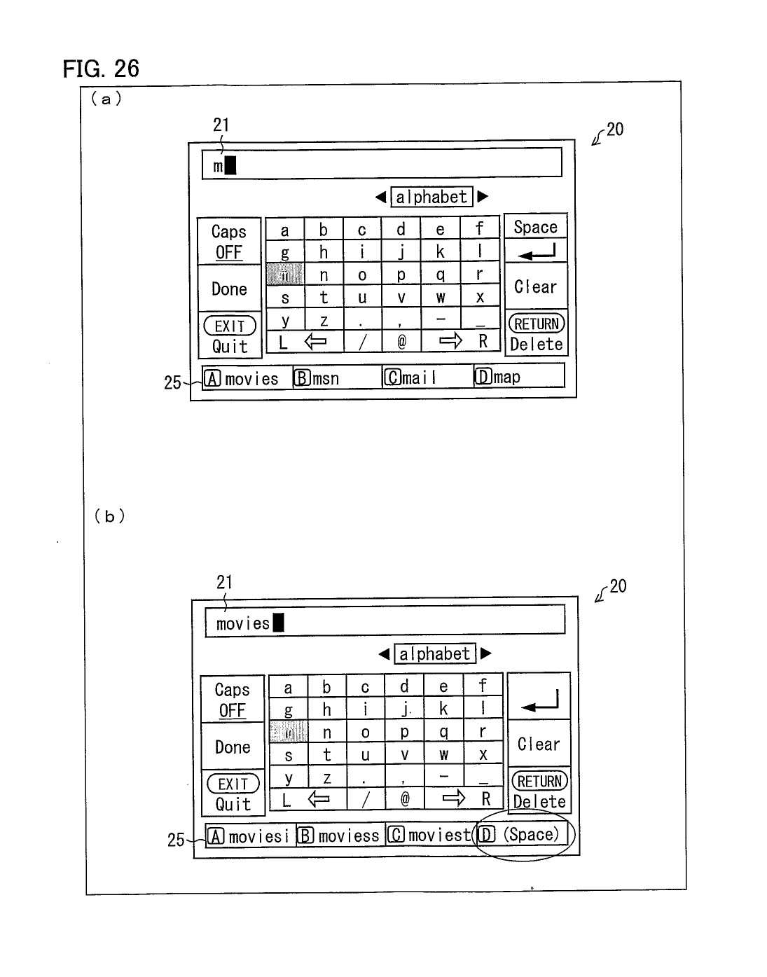

FIG. 26 is a drawing illustrating a display example of dynamically assigning a space key to the candidate selection key 25. In FIG. 26(a), a character “m” is displayed in the input frame 21, and a cursor is displayed next to “m”. A space key is not assigned to the candidate selection key 25 in FIG. 26(a). That is, the above example shows a case where a space key is fixedly assigned to the candidate selection key 25, whereas the present example shows a case where a space key is not fixedly assigned to the candidate selection key 25 and instead dynamically assigned to the candidate selection key 25 according to necessity. Note that, in order that the space key can be inputted while the space key is not assigned to the candidate selection key 25, the space key is provided as the editing process key 24 in the example of the drawing (adjacent to the upper side of an end-of-line key).

Further, as illustrated in the drawing, the candidate selection keys 25 indicating “A”-“D” display “movies”, “msn”, “mail”, and “map”, respectively. That is, in the example of FIG. 26, it is assumed that at least these four words are stored in the prediction memory 42. As described above, when the space key is not fixedly assigned to the candidate selection key 25, an input candidate other than the space key can be assigned to the candidate selection key. This allows more effectively using the candidate selection key.

FIG. 26(b) illustrates a display example of performing the input operation on the candidate selection key 25 indicating “A” in the state of FIG. 26(a). As illustrated in FIG. 26(b), by performing the input operation on the candidate selection key 25 indicating “A”, the input candidate “movies” assigned to the candidate selection key 25 indicating “A” is inputted in the input frame 21.

In the state of FIG. 26(b), the character string right before the cursor is completely identical with the word “movies” stored in the prediction memory 42. Consequently, a separator candidate that follows “movies” is determined as an input candidate in the process of S49 in FIG. 13, i.e., the separator candidate prediction process. Therefore, in a case where a space is stored in the prediction memory 42 as the separator that follows “movies”, the space key is assigned to the candidate selection key 25 as illustrated in FIG. 26(b). Note that it is preferable to display the space key at a predetermined one of the candidate selection keys 25 in order to prevent the space key from getting mixed with input candidates such as abbreviation candidates and next word candidates. The present example is designed such that the space key is always assigned to the candidate selection key 25 indicating “D”.

[Merits in Learning Separator and Word Separately]

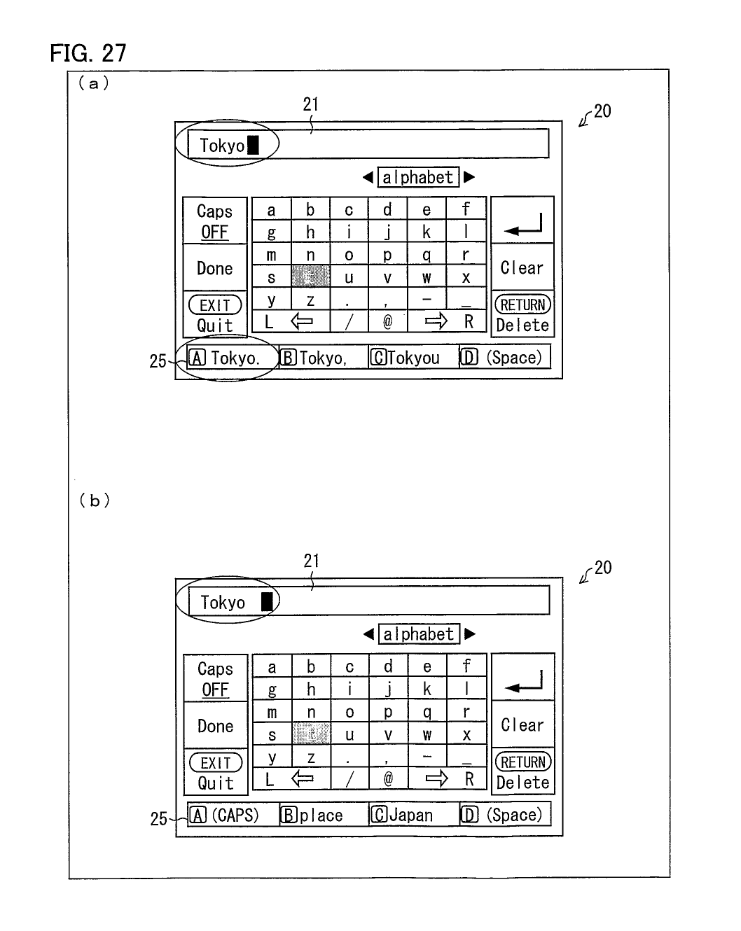

As explained with respect to FIGS. 5-11, in the character input device 5, a character string inputted by a user is not directly stored in the prediction memory 42. Instead, a separator and a word are cut from the character string inputted by the user, the word and the separator following the word are stored in such a manner that they are related to each other, and continuous two words with the separator therebetween are stored in such a manner that they are related to each other. This allows flexibly responding to the change of the inputted separator. With reference to FIG. 27, an explanation is made here as to merits in learning a separator and a word separately.

FIG. 27(a) illustrates a display example in which

“Tokyo” is inputted while two character strings “Tokyo, Japan” and “Tokyo. place” are learnt. When “Tokyo, Japan” and “Tokyo. place” are learnt, the learning section 41 causes the words “Tokyo”, “Japan”, and “place” to be stored in the prediction memory 42 and causes “,” and “.” to be stored as separator information for “Tokyo” in the prediction memory 42. Further, the learning section 41 causes “Japan” and “place” to be stored as word information for “Tokyo” in the prediction memory 42.

When “Tokyo” is inputted, a character string right before the cursor is identical with the word “Tokyo” in the prediction memory 42 and therefore the separators “,” and “.” related to “Tokyo” are assigned to the candidate selection keys 25. Here, it is assumed that a space key is fixedly assigned to the candidate selection key 25 indicating “D”.

FIG. 27(b) illustrates a state where a space is inputted next to “Tokyo” in the state of FIG. 27(a) by operating the candidate selection key 25 indicating “D”. As illustrated in FIG. 27(b), “Japan” and “place” that are stored as the word information for “Tokyo” in the prediction memory 42 are assigned to the candidate selection keys 25.

That is, in the character input device 5, even when a character next to “Tokyo” is not the learnt separator “,” or “.”, “Japan” and “place” are determined as next word candidates for “Tokyo”. That is, in the character input device 5, even when any separator that is not learnt is inputted next to a word, it is possible to output a word that follows the word.

(Displaying Abbreviation Candidate, Separator Candidate, and One-Character Candidate in a Mixed Manner)

In the character input device 5, input candidates are determined according to the flow of FIG. 13, and therefore candidates corresponding to operation keys such as the Caps key and the Done key, next word candidates, separator candidates, abbreviation candidates, URL candidates, and next word candidates are dynamically assigned to the candidate selection keys 25. That is, in the character input device 5, by combining the aforementioned input candidate determination methods, appropriate input candidates are dynamically assigned to the candidate selection keys 25 according to situations.

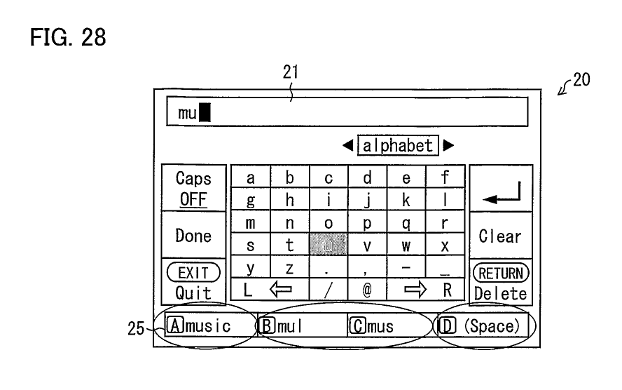

FIG. 28 is a display example of inputting “mu” in a case where a word “music” is registered in the prediction memory 42. Since the inputted character string “mu” is identical with the top of the registered word “music”, “music” is assigned to the candidate selection key 25 as illustrated in FIG. 28.

Further, a character that is likely to follow the inputted character string “mu” is assigned as a one-character candidate to the candidate selection keys 25 indicating “B” and “C”. Note that a space key is fixedly assigned to the candidate selection key 25 indicating “D”.

As described above, in the character input device 5, various input candidate determination processes as illustrated in FIG. 13 are performed in combination, and therefore the determined input candidates including various candidates in combination are outputted. Consequently, input candidates assigned to the candidate selection keys 25 are suitably determined according to the input state. In the example of the drawing, there are only four candidate selection keys 25 indicating “A”-“D”, respectively, and therefore it is important to change input candidates according to the input state.

In the character input device 5, an input candidate is determined based on a character string right before the input position, and a one-character candidate that is stored in relation to a character string made of a predetermined number of characters right before the input position is determined as an input candidate.

Since the one-character candidate is a character that is stored in relation to a character string made of a predetermined number of characters, it is possible to provide a one-character candidate with respect to combination of any characters. That is, a one-character candidate can be determined as an input candidate regardless of what character string exists before the input position.

Therefore, with the arrangement of the present invention, even when a character string right before the input position is not identical with a word that is stored beforehand, it is possible to assign an input candidate to a candidate selection key. Further, even when a word that is stored beforehand is not identical with a word which a user wants to input, it is possible to assign to a candidate selection key a one-character candidate that serves to aid the user to input characters. This allows the user to easily and promptly input a desired character string with use of candidate selection keys.

[Display Example of Inputting URL]

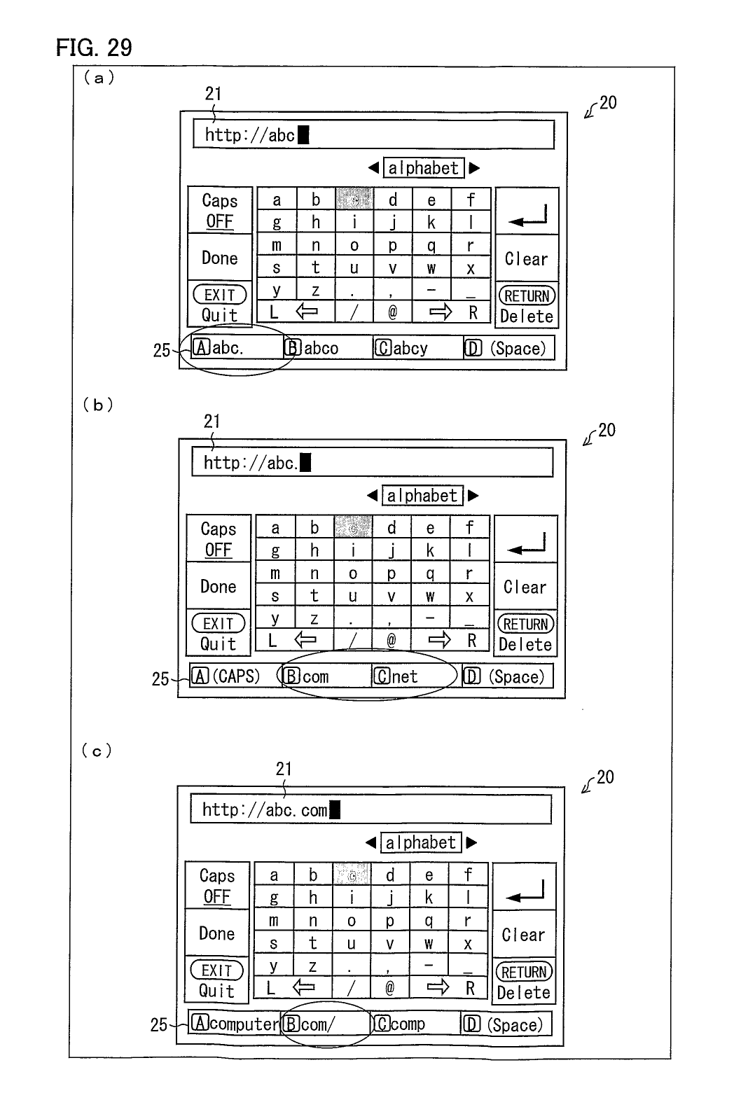

With reference to FIG. 29, the following explains a display example of inputting in the URL mode. FIG. 29 illustrates a display example in a case where an address “http://abc.com/” is inputted. In (a) of FIG. 29, a character string “http://abc” is inputted in the input frame 21. In this case, the top of the inputted character string is identical with “http://” and therefore the URL mode is set according to the process in FIG. 18.

Further, in the example of the drawing, “/” after “//” does not exist before the cursor, and 3 characters exist from a separator before the cursor (“/” in this case) to a character right before the cursor. Therefore, “.” is determined as a separator candidate through the processes of S115, S116, and S117 in FIG. 19. Consequently, “.” is assigned to the candidate selection key 25 as illustrated in the drawing.

When “.” is inputted in the input window 20 in the state of (a) of FIG. 29, the input window 20 is changed to be in the state of (b) of FIG. 29. That is, since “/” after “//” does not exist before the cursor and “.” exists right before the cursor, “com” and “net” are assigned to the candidate selection keys 25 through the processes of S115, S118, and S119, and are displayed as illustrated in the middle drawing of FIG. 29.

Then, when “com” is inputted in the input window 20 in the state of (b) of FIG. 29, the input window 20 is changed to be in the state of (c) of FIG. 29. That is, since “/” after “//” does not exist before the cursor and “com” exists right before the cursor, “/” is assigned to the candidate selection key 25 through the processes of S115, S120, and S121 in FIG. 19, and are displayed as illustrated in the drawing.

That is, the character input device 5 allows a user to input the address “http://abc.com/” only with two input operations of the candidate selection keys 25 in the state where “http://abc” is inputted. In this manner, the character input device 5 allows the user to promptly input a URL only with simple key operations.

(Example of Displaying Input Candidate)

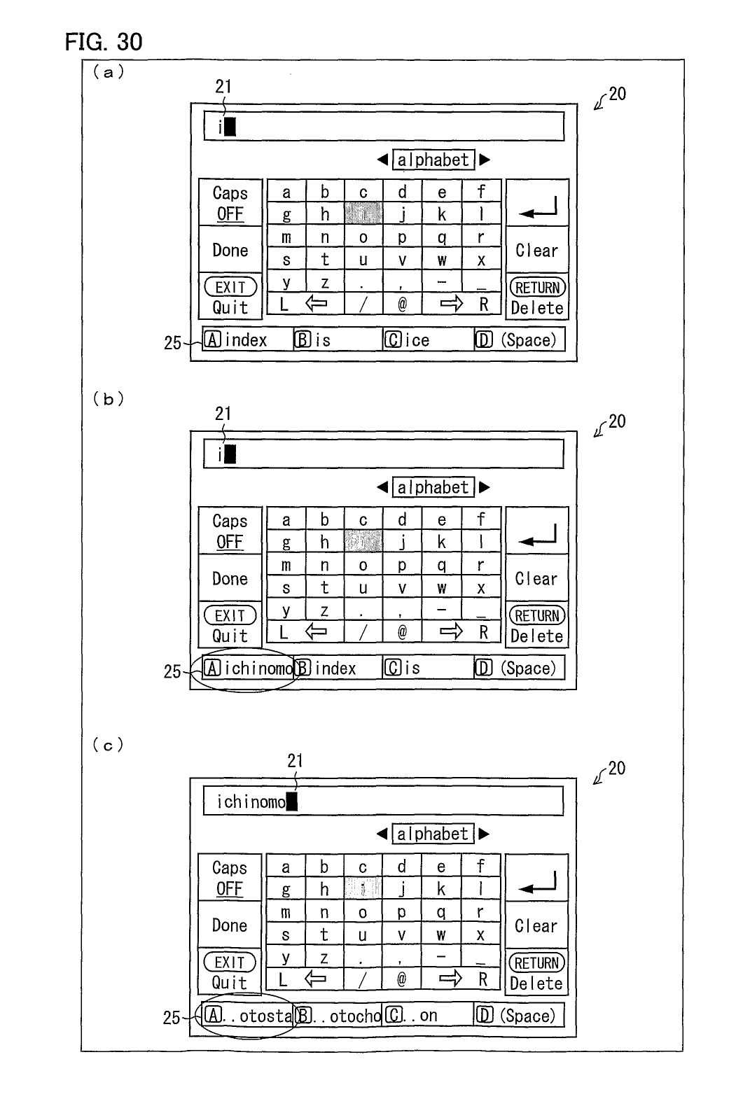

In the character input device 5, the number of characters that are displayable in the candidate selection keys 25 is limited. Therefore, a display with limited number of characters that is intelligible to a user is realized by devising how to display input candidates. Here, an explanation is made as to an example of displaying input candidates with reference to FIG. 30. FIG. 30 is a drawing illustrating an example of displaying input candidates.

FIG. 30(a) illustrates a display example where a character “i” is inputted while three words “index”, “is”, and “ice” are stored in the prediction memory 42. In this case, “index”, “is”, and “ice” each starting with “i” are selected as abbreviation candidates and are determined as input candidates. Then, candidate character strings are generated through the candidate character string determination process in FIG. 21, and the generated candidate character strings are displayed in the candidate selection keys 25.

Here, it is assumed that 8 characters can be displayed in each of the candidate selection keys 25 indicating “A”-“D”, respectively. Therefore, all character strings of each of the three words, including the inputted character “i”, are displayed in the candidate selection key 25.

FIG. 30(b) illustrates a display example where the character “i” is inputted in a case where two words “ichinomotostation” and “ichinomotocho” as well as the three words are learnt. Each of “ichinomotostation” and “ichinomotocho” includes more than 8 characters and therefore all character strings of each word cannot be displayed in the candidate selection key 25.

It would be possible to display the tops of the two words. However, both of top 8 characters of “ichinomotostation” and “ichinomotocho” are “ichinomo” and are common. Consequently, when both of the top 8 characters of “ichinomotostation” and the top 8 characters of “ichinomotocho” are displayed in the candidate selection keys 25, two candidate selection keys 25 with the same description are displayed. “Ichinomotostation” is assigned to one of the two candidate selection keys 25 and “ichinomotocho” is assigned to the other of the two candidate selection keys 25. This is not preferable since a user cannot see which of the two candidate selection keys 25 is to be selected and the user is bewildered.

Therefore, the character input device 5 is designed such that a plurality of candidate character strings including the same character string are not determined through the process of S135 in FIG. 21. Therefore, when the two words “ichinomotostation” and “ichinomotocho” are registered, the candidate selection key 25 corresponding to the two words is only the candidate selection key 25 indicating “A” in which a candidate character string “ichinomo” is displayed. Thus, the user does not get bewildered in determining which of the two candidate selection keys 25 is to be determined.

When the input operation is performed on the candidate selection key 25 indicating “A” in which the character “ichinomoto” is displayed, the input window 20 is changed to be in the state of FIG. 30(c). As illustrated in FIG. 30(c), the character string “ichinomo” is displayed in the input frame 21, a character string “ . . . otosta” is displayed in the candidate selection key 25 indicating “A”, and “ . . . otocho” is displayed in the candidate selection key 25 indicating “B”.

As described above, in the character string device 5, when parts of words are cut out and are regarded as candidate character strings and consequently the candidate character strings assigned to the candidate selection keys 25 become identical with each other, only one of the two candidate character strings is assigned to the candidate selection key 25.

When the input operation is performed on the candidate selection key 25 in which the candidate character string corresponding to a plurality of input candidates is displayed, only a character string of an input candidate that is included in the candidate character string (“ichinomo” in this case) is displayed as illustrated in FIG. 30(c).

Consequently, the user can easily recognize that inputting “ichinomotostation” requires using the candidate selection key 25 indicating “A” and inputting “ichinomotocho” requires using the candidate selection key 25 indicating “B”.

Note that the character input device 5 is designed such that when the input operation is performed on the candidate selection key 25, only a character string of an input candidate in a candidate character string displayed in the candidate selection key 25 is inputted. That is, the character input device 5 is designed such that only a character string of an input candidate in a candidate character string displayed in the candidate selection key 25 is always inputted regardless of whether a plurality of input candidates are displayed as the same candidate character string.

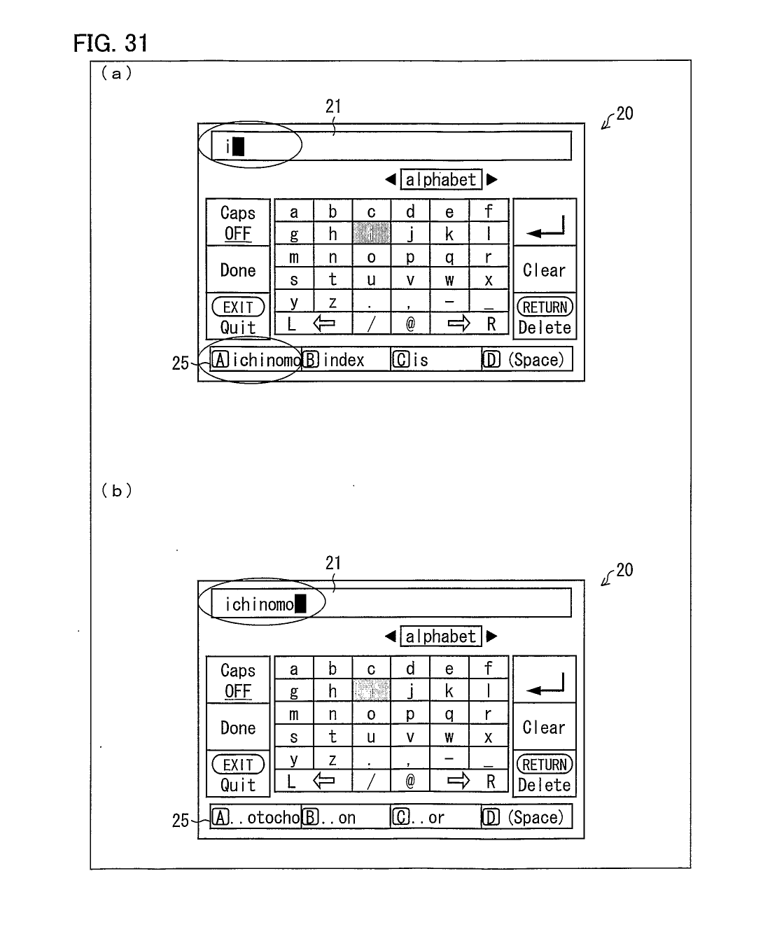

This is explained with reference to FIG. 31. FIG. 31 illustrates a display example in a case where three words “ichinomotocho”, “index”, and “is” are stored in the prediction memory 42. As illustrated in FIG. 31(a), when a character “i” is inputted, “ichinomotocho”, “index”, and “is” are determined as abbreviation candidates and are assigned to the candidate selection keys 25. Since “ichinomotocho” includes more number of characters than characters that can be displayed in the candidate selection key 25, and therefore only the top of “ichinomotocho”, i.e., “ichinomo”, is displayed.

In the state of FIG. 31(a), when the candidate selection key 25 in which the candidate character string “ichinomo” is displayed is selected, the input window 20 is updated to be in the state of FIG. 31(b). That is, as illustrated in FIG. 31(b), the character string “ichinomo” that has been displayed in the candidate selection key 25 is displayed in the input frame 21. And an input candidate “ . . . otocho” required to complete the inputted character string “ichinomo” as the word “ichinomotocho” is assigned to the candidate selection key 25.

In this manner, the character input device 5 is designed such that when the number of characters in a candidate character string is more than the number of characters that can be displayed in the candidate selection key 25, the top of a character string of an input candidate that is included in the candidate character string is assigned to the candidate selection key 25. Only the assigned top is firstly determined and then a remaining part following the top is assigned as an input candidate to the candidate selection key 25.

The character input device 5 may be arranged as follows: when only the top of the character string of an input candidate that is included in the candidate character string is displayed in the candidate selection key 25, and when only one word that follows the top exists, the input operation is performed on the candidate selection key 25 to which the top is assigned and thus the whole character string of the word is inputted. For example, the character input device 5 may be arranged so that in the state of FIG. 31(a), the input operation is performed on the candidate selection key 25 indicating “A” and thus the whole character string of “ichinomotocho” is inputted.

However, in this arrangement, the input operation is performed on the candidate selection key 25 displaying “ichinomoto” but the character string “ichinomotocho” is inputted, and consequently the user may be bewildered. For that reason, the character input device 5 is designed such that only a character string as an input candidate that is included in a candidate character string displayed in the candidate selection key 25 is always inputted.

Further, in the character input device 5, the candidate selection key 25 displays a candidate character string, i.e., a character string made by combining a character string as an input candidate and an inputted character string. This allows a user to more easily recognize the complete form of a word, allowing the user to more easily select a desired input candidate. Further, in the character input device 5, the lengths of inputted character strings displayed in the candidate selection keys 25 are the same with respect to each input candidate.

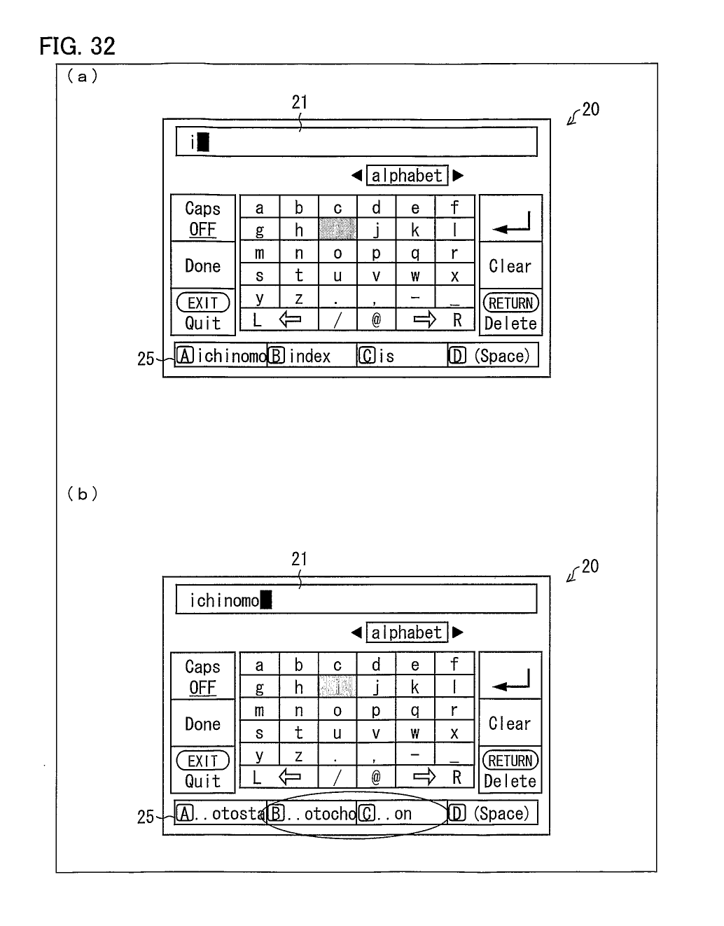

FIG. 32 is a drawing illustrating a display example in which the lengths of input character strings are the same with respect to each input candidate. FIG. 32(a) illustrates a display example in which “i” is inputted while “ichinomotostation”, “ichinomotocho”, “index”, and “is” are stored in the prediction memory 42. As illustrated in FIG. 32(a), the inputted character string “i” is displayed in each input candidate.

Note that although FIGS. 24-41 illustrate examples in which inputted character strings and input candidates are displayed without any discrimination therebetween, it is preferable that inputted character strings and input candidates are displayed in different colors etc. so that the user can distinguish the inputted character strings from the input candidates.

In the state of FIG. 32(a), when the input operation is performed on the candidate selection key 25 displaying “ichinomo”, the input window 20 is changed to be in the state of FIG. 32(b). As illustrated in FIG. 32(b), the words “ichinomotostation” and “ichinomotocho” whose tops are identical with the inputted character string “ichinomo” are assigned to the candidate selection keys 25. Further, a one-character candidate “n” is assigned to the candidate selection key 25 indicating “C”.

As illustrated in FIG. 32(b), in all the candidate selection keys 25, the inputted character string is “ . . . o”. This allows the user to more easily distinguish the inputted character string from the input candidate. Such display is realized by the candidate character string generation process in FIG. 21.

[Regarding How to Select One-Character Candidate]

As described above, a one-character candidate is determined on the basis of a database prepared in advance according to the chain probability of characters (one-character prediction memory 43). The one-character candidate is an input candidate of one character having high probability of following two characters right before the input position

A one-character candidate is assigned to the candidate selection key 25 in order to save the user's trouble in operation. Therefore, there is little merits in assigning to the candidate selection key 25 a character that can be inputted with small number of operations of the focus 26, i.e., a character near the focus 26. It is preferable to assign to the candidate selection key 25 a character that is positioned far from the focus 26.

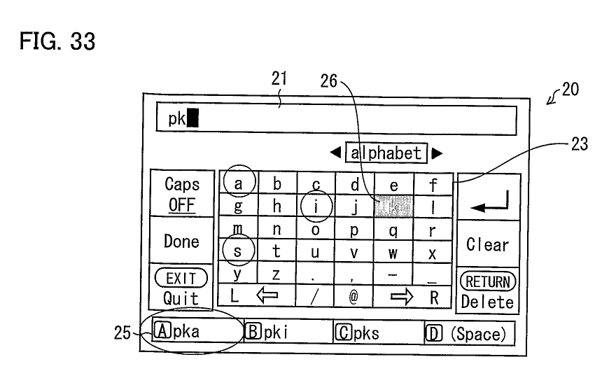

Therefore, it may be arranged so that when the second candidate determination section 39 determines a one-character candidate as an input candidate, the second candidate determination section 39 acquires the position of the focus 26 on the input window 20 and preferentially determines a character far from the position of the focus 26 as a selection candidate. This is explained with reference to FIG. 33. FIG. 33 is a drawing explaining how to preferentially determine a character far from the position of the focus 26 as a selection candidate.

As illustrated in FIG. 33, two characters “pk” are inputted in the input frame 21. Further, as illustrated in FIG. 33, the focus 26 is put on the character input key 23 indicating “k”. When determining a one-character candidate in this case, the second candidate determination section 39 reads out from the one-character prediction memory 43 one-characters having high probability of following the two characters “pk” in the order of the probability. Here, it is assumed that four characters “e”, “i”, “s”, and “a” are read out in the order of the probability.

The second candidate determination section 39 requests the operation acquiring section 31 to inform the current position of the focus 26. As illustrated in FIG. 33, the focus 26 is put on the character input key 23 indicating “k”, of which the operation acquiring section 31 informs the second candidate determination section 39. The second candidate determination section 39 having been informed confirms whether characters near the focus 26 are included in the read-out one-character candidates.

The characters near the focus 26 may be predetermined. For example, by predetermining that the position adjacent to the upper/lower side or to the left/right side of the focus 26 is a position near the focus 26, it is possible to judge whether a character is near the focus 26 or not. As illustrated in FIG. 33, the focus 26 is adjacent to the lower side of the character input key 23 indicating “e”. Consequently, “e” indicated by the character input key 23 can be inputted only by pressing the “up” direction button 12 of the remote control device 4 one time and then pressing the determination button 12 of the remote control device 4. That is, “e” indicated by the character input key 23 can be inputted without much trouble in a case where the direction button 12 and the determination button 11 are used.

Therefore, the second candidate determination section 39 excludes such character positioned near the focus 26 from the one-character candidates and determines a character positioned far from the focus 26 (a character that requires much number of operations to input) as an input candidate, as illustrated in FIG. 33. Specifically, among “e”, “i”, “s”, and “a” that are read out from the one-character prediction memory 43, “e” is excluded and “i”, and “a” are determined as input candidates. This saves the user's trouble both in inputting “e” next time and in inputting “i”, “s”, and “a” next time.

Note that the character positioned near the focus 26 indicates a character that requires small number of operations in order to put the focus 26 on the character, and does not indicate only physical distance between a key and the focus 26. In other words, a character that requires small number of pressing the direction button 12 of the remote operation device 4 is the character positioned near the focus 26. Therefore, when the focus 26 is designed to be capable of moving in a skew direction, eight characters adjacent to upper, lower, right, left, and skew sides of the focus 26 may be regarded as characters positioned near the focus 26.

An explanation was made above as to a case where characters that get ready to input by pressing the direction button 12 of the remote control device 4 one time in order to move the focus 26 from the current position thereof are regarded as characters positioned near the focus 26. However, the present invention is not limited to this case. For example, characters that get ready to input by pressing the direction button 12 of the remote control device 4 two times may be regarded as characters positioned near the focus 26 or characters that get ready to input by pressing the direction button 12 of the remote control device 4 three times may be regarded as characters positioned near the focus 26.

[Editing of Read Character String]

As described above, the character input device 5 is designed such that when a character string has been already inputted in the input field, the character string reading section 33 reads the inputted character string and causes the inputted character string to be stored in the character string editing memory 36. Thus, it is possible to perform editing operation such as adding a new character string to the inputted character string. Here, with reference to FIG. 34, an explanation is made as to a display example in a case where a character string inputted in the input field is read.

(a) of FIG. 34 illustrates a screen of a web page. To be more specific, (a) of FIG. 34 illustrates a screen of a search site where a keyword is inputted and information concerning the inputted keyword is searched for via the Internet. As illustrated in (a) of FIG. 34, a character string “abc” is inputted in a text box 51 for inputting a search keyword.

When the text box 51 is set as the input field, the input window 20 illustrated in (b) of FIG. 34 is displayed on the same screen as the screen where the web page is displayed. As illustrated in the drawing, the character string “abc” inputted in the text box 51 is displayed in the input frame 21. Further, as illustrated in the drawing, a Clear key is assigned to the candidate selection key 25 indicating “A” and a Space key is assigned to the candidate selection key 25 indicating “D”.

Therefore, when a user wants to delete the character “abc” inputted in the text box 51 and to search by using another keyword, the user is only requested to perform operational input on the candidate selection key 25 indicating “A”. When the user wants to search by using another keyword in addition to the character “abc”, the user is only requested to perform operational input on the candidate selection key 25 indicating “D”. In either case, the user can perform a necessary operation with only one touch of the key.

[Example of Displaying Done Key]

The character input device 5 is designed such that inputting a character string and determining the character string with use of the Done key causes the inputted character string to be inputted in the input field. A learning process is performed with the operation on the Done key serving as a trigger, and a word inputted right before the operation of the Done key and the operation of the Done key are related to each other and stored (see (b) of FIG. 7 etc.). When the word inputted right before the operation of the Done key is inputted, the Done key is assigned as an input candidate to the candidate selection key 25.

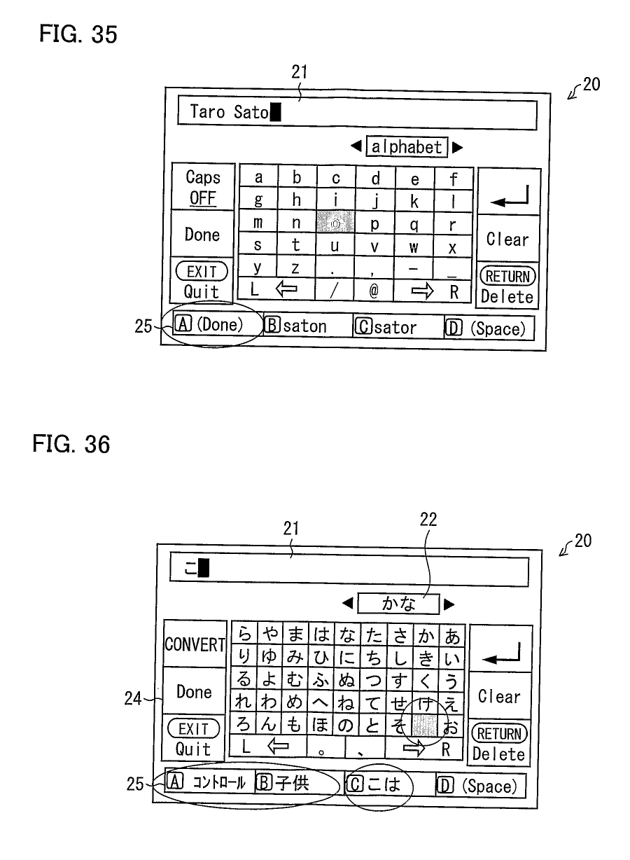

An explanation is made to FIG. 35 that is a display example in a case where the Done key is assigned to the candidate selection key 25. Here, it is assumed that the learning section 41 has already learnt that a character string “Taro Sato” was inputted and determined (Done key was operated).

When the character string “Taro Sato” is inputted, separator information for the word “Sato” right before the input position is read out from the prediction memory 42. Here, it is assumed that the learning section 41 has already learnt that a character string “Taro Sato” was inputted and determined (Done key was operated), and therefore the separator information for the word “Sato” includes information “End”, as with the cases of “Japan” and “station” in (a) of FIG. 7) (see (a) of FIG. 7).

That is, it is stored in the prediction memory 42 that the operation of the Done key is performed after “Sato” in such a manner that the operation of the Done key is related to “Sato”. In this case, the second candidate determination section 39 determines the Done key as an input candidate. As a result, a character string “Done” is displayed in the candidate selection key 25, as illustrated in FIG. 35. By performing operational input on the candidate selection key 25 in which the character “Done” is displayed, it is possible to determine the input of the character string.

[Example of Inputting Japanese]

An explanation was made above as to an example where alphabets are inputted. The character input device 5 is designed to allow not only inputting of alphabets but also inputting of various kinds of characters. Here, with reference to FIGS. 36-41, a case of inputting Japanese is explained as an example of inputting characters other than alphabets.

When inputting Japanese, the character input device 5 performs almost the same process as when inputting alphabets. That is, when inputting Japanese, too, input candidates are determined through the flow illustrated in the flowchart of FIG. 13. Thus, input candidates as illustrated in FIG. 36 for example are displayed in the candidate selection keys 25.

FIG. 36 illustrates a display example of the input window 20 in a case of inputting Japanese. As illustrated in the drawing, the mode switching key 22 indicates “kana”, and hiragana characters and punctuation marks are displayed in the character input keys 23. Further, instead of the Caps key, a conversion key for converting hiragana characters to kanji characters is displayed in the editing process key 24. Here, it is assumed that two words [symbol] (corresponding to control in English) and [symbol] (corresponding to child in English) are registered as words starting with [symbol] in the prediction memory 42.

In this manner, hiragana characters, katakana characters, and kanji characters are mixed when inputting Japanese. Therefore, not only spellings of words but also pronunciations of the words are registered in the prediction memory 42. That is, it is judged that an inputted character string is identical with a registered word not only when the inputted character string is identical with the registered word (or the top of the registered word) but also when the pronunciation of the inputted character string is identical with the pronunciation of the registered word (or the top of the registered word). In this regard, inputting of Japanese is different from inputting of alphabets.

As illustrated in the drawing, a character [symbol] (pronounced as “ko”) is inputted in the input frame 21. Consequently, the registered [symbol] and [symbol] are assigned to and displayed in the candidate selection key 25. Further, as in the case of alphabets, one-character prediction is possible. In the example of the drawing, the candidate selection key 25 indicating “C” displays [symbol] (pronounced as “ha”) as a one-character candidate following

[symbol]

In the drawing, a Space key is assigned to the candidate selection key 25 indicating “D”. Alternatively, other input candidates may be assigned to the candidate selection key 25 indicating “D” since inputting of Japanese requires the Space key less frequently than inputting alphabets.

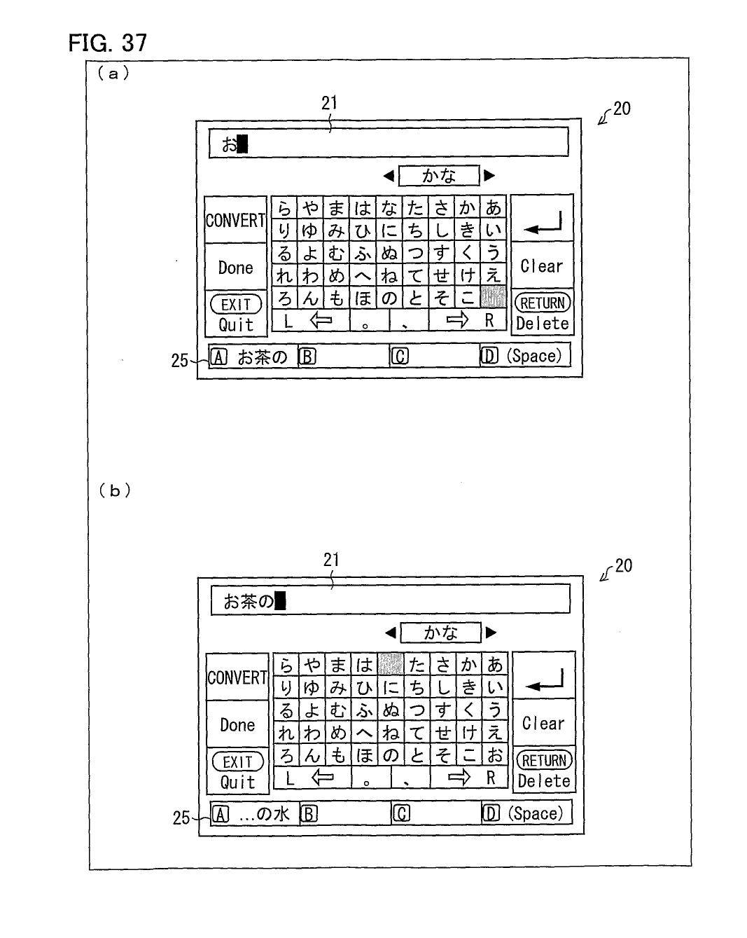

Further, also in inputting Japanese, it is preferable to display only a character string as an input candidate in a candidate character string displayed in the candidate selection key 25. This is explained with reference to FIG. 37. (a) of FIG. 37 is a drawing illustrating a display example of inputting a character [symbol] (pronounced as “o”) while a word [symbol] (pronounced as “ochanomizu”) is registered in the prediction memory 42. Here, it is assumed that the maximum number of characters that are displayable in the candidate selection key 25 is 3 when a character is a full-size character.

As illustrated in (a) of FIG. 37, when the character [symbol] is inputted, the character [symbol] is displayed in the input frame 21. The character [symbol] is identical with the top of the word [symbol] registered in the prediction memory 42 and therefore [symbol] is determined as an input candidate.

Here, it is assumed that the maximum number of characters that are displayable in the candidate selection key 25 is 3 and therefore the whole character string of [symbol] made of 4 full-size characters cannot be displayed. Therefore, as illustrated in (a) of FIG. 37, top 3 characters of [symbol] i.e., [symbol] are displayed in the candidate selection key 25.

When input operation is performed on the candidate selection key 25 in which [symbol] is displayed, the input window 20 is changed to be in the state illustrated in (b) of FIG. 37. That is, the character string [symbol] displayed in the candidate selection key 25 is inputted in the input frame 21 and a character [symbol] following the inputted character string [symbol] is displayed in combination with a character string [symbol] that is an abbreviation of the inputted character string

[symbol]

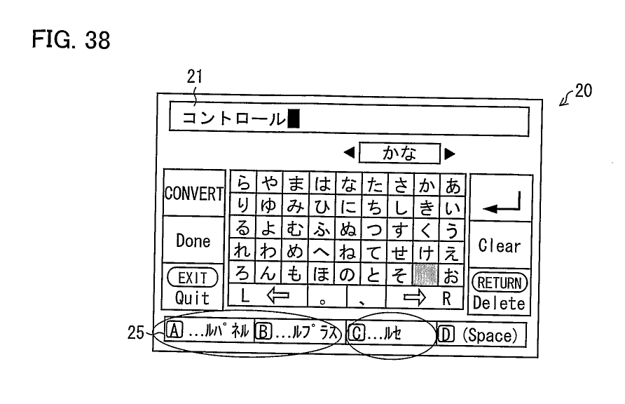

Further, also in inputting Japanese, it is preferable that the lengths of the inputted character strings are the same with respect to each candidate selection key 25. FIG. 38 illustrates a display example where [symbol] is inputted while words [symbol] (corresponding to control panel in English) and [symbol] (corresponding to control plus in English) are stored in the prediction memory 42.

In this case, the tops of the words [symbol] and [symbol] that are registered in the prediction memory 42 are identical with the inputted character string [symbol] and therefore [symbol] and [symbol] are determined as input candidates. Two input candidates are thus determined, and a one-character candidate is determined as remaining one input candidate. Here, it is assumed that [symbol] is determined as a one-character that follows two characters [symbol] right before the input position.

Thus, all of the three input candidates are determined. However, since both of [symbol] and [symbol] have more number of characters than characters that are displayable in the candidate selection key 25, it is impossible to display all characters constituting the word.

Therefore, as illustrated in the drawing, in the cases of [symbol] and [symbol] the inputted character string [symbol] is converted into its abbreviation [symbol] and the candidate character strings are displayed as [symbol] and [symbol] respectively. Further, in the case of the one-character candidate [symbol] when the inputted character string is displayed to show the maximum number of characters, the candidate character string is [symbol] However, when the lengths of the inputted character strings displayed in the candidate selection keys 25 are different, it is difficult for a user to recognize the boarder between the inputted character and the input candidate. Therefore, the inputted character strings are unified to [symbol] for all the input candidates.

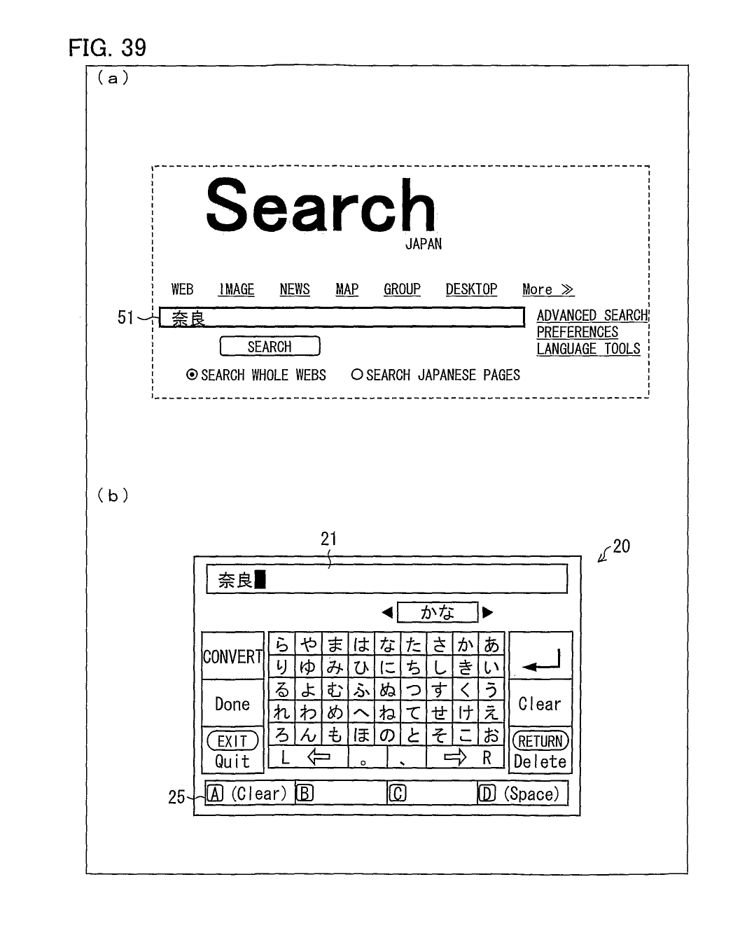

Further, also in the case of inputting Japanese, as in the case of inputting alphabets, when a character string in the input field is read, a Clear key and a Space key are assigned to the candidate selection keys 25. FIG. 39 is a drawing illustrating a display example where a character string in an input field is read in the case of inputting Japanese.

As in the case of (a) of FIG. 34, an explanation is made here as to a case where a screen of a search site where a keyword is inputted and information relating to the inputted keyword is searched for via the Internet has a text box 51 and the text box 51 is set as an input field. Here, it is assumed that a character string [symbol] is inputted in the text box 51 as illustrated in FIG. 39(a).

When the text box 51 is set as an input field as illustrated in FIG. 39(a), the input window 20 illustrated in FIG. 39(b) is displayed. As illustrated in the drawing, the character string [symbol] having been inputted in the text box 51 is displayed in the input frame 21. Further, as illustrated in the drawing, the Clear key and the Space key are assigned to the candidate selection keys 25.

Thus, it is possible to delete the character string [symbol] with one touch of the key and to input another search keyword. Further, since it is possible to input a space after the character string [symbol] with one touch of the key, it is possible to easily add a new search keyword.

Further, also in the case of inputting Japanese, as in the case of inputting alphabets, a determination operation (Done key operation) is performed after inputting a word, and the word inputted right before the determination operation and the Done key are stored in the prediction memory 42 in such a manner that the determination operation and the Done key are related to each other. Consequently, it is possible to assign the Done key to the candidate selection key 25 when the word inputted right before the determination operation is inputted.

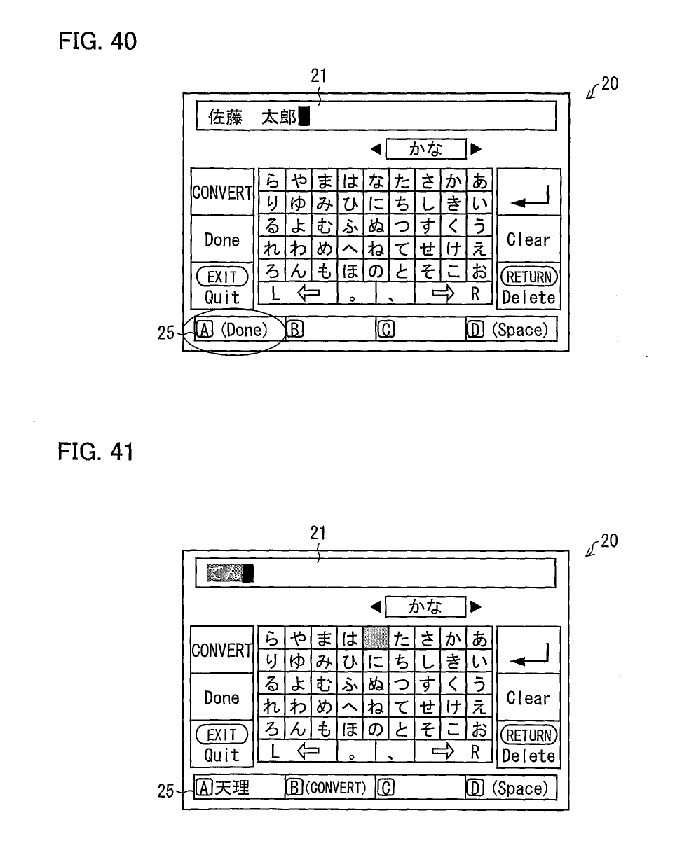

FIG. 40 is a drawing illustrating a display example in a case where [symbol] is inputted after learning that the determination operation is performed after the word [symbol] As illustrated in the drawing, the character string [symbol] is displayed in the input frame 21 and the Done key is assigned to the candidate selection key 25. This allows a user to determine the character string [symbol] with one touch of the key.

Further, in the case of inputting Japanese, the conversion key for converting kana characters to kanji characters may be assigned to the candidate selection key 25. This is explained with reference to FIG. 41. FIG. 41 is a drawing illustrating a display example in which the conversion key is assigned to the candidate selection key 25.

As illustrated in the drawing, a character string [symbol] (pronounced as “ten”) is inputted in the input frame 21. Further, as illustrated in the drawing, a conversion key is assigned to the candidate selection key 25. This allows a user to convert the inputted character string [symbol] to katakana characters or kanji characters with one touch of the key.

The conversion key may be assigned to the candidate selection key 25 when two characters right before the input position are not subjected to a kana-kanji conversion. This is because conversion of two hiragana characters to a kanji character is relatively frequent. Needless to say, the conversion key may be assigned to the candidate selection key 25 when one character right before the input position is not subjected to a kana-kanji conversion. Further, the conversion key may be assigned to the candidate selection key 25 when three or more characters right before the input position are not subjected to a kana-kanji conversion.

[Example of Function to be Assigned to Candidate Selection Key 25]

Explanations were made above as to examples where the editing keys such as the Caps key, the Done key, the Clear key, and the conversion key are assigned to the candidate selection keys 25. Further, functions other than these may be assigned to the candidate selection keys 25.

For example, at least one of the Quit key, the L key and the R key, the Delete key, the end-of-line key, and the input mode switching key 22 that are illustrated in FIG. 4 may be assigned to the candidate selection key 25 as needed. Further, in addition to the functions cited here, any functions used in inputting and editing character strings may be assigned to the candidate selection keys 25.

The present invention is not limited to the above embodiments, and a variety of modifications are possible within the scope of the following claims, and embodiments obtained by combining technical means respectively disclosed in the above embodiments are also within the technical scope of the present invention.

[How to Realize the Present Invention by Using Software]

Lastly, each block of the character input device 5, especially the separating character judgment section 37, the first candidate determination section 38, the second candidate determination section 39, the editing candidate determination section 40, the learning section 41, and the input candidate assigning section 44 may be realized by hardware logic or may be realized by software by using CPUs as described below.

Namely, the character input device 5 includes: a CPU (central processing unit) for executing a program for realizing each function; a ROM (read only memory) that stores the program; a RAM (random access memory) that develops the program; a storage device (storage medium) such as a memory for storing the program and various data; and the like. The object of the present invention can be realized in such a manner that the character input device 5 is provided with a computer-readable storage medium for storing program codes (such as executable program, intermediate code program, and source program) of programs of the character string device 5 which programs serve as software for realizing the functions, and a computer (alternatively, CPU or MPU) reads out and executes the program codes stored in the storage medium.

The storage medium is, for example, tapes such as a magnetic tape and a cassette tape, or discs such as magnetic discs (e.g. a floppy disc® and a hard disc), and optical discs (e.g. CD-ROM, MO, MD, DVD, and CD-R). Further, the storage medium may be cards such as an IC card (including a memory card) and an optical card, or semiconductor memories such as mask ROM, EPROM, EEPROM, and flash ROM.

Further, the character input device 5 may be arranged so as to be connectable to a communication network so that the program code is supplied to the character input device 5 through the communication network. The communication network is not particularly limited. Examples of the communication network include the Internet, intranet, extranet, LAN, ISDN, VAN, CATV communication network, virtual private network, telephone network, mobile communication network, and satellite communication network. Further, a transmission medium that constitutes the communication network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared ray, Bluetooth®, 802.11, HDR, mobile phone network, satellite connections, and terrestrial digital network. Note that the present invention can be also realized by the program codes in the form of a computer data signal embedded in a carrier wave, which is the program that is electrically transmitted.

As described above, the character input device of the present invention includes process candidate determination means for assigning to the candidate selection key a process that is related to inputting of characters and that is other than inputting at the input position the character string of the input candidate, and therefore is capable of presenting an input candidate with high accuracy to a user. This allows the user to easily and swiftly input characters.

Further, as described above, the character input device of the present invention includes: input candidate determination means for determining the input candidate on a basis of a right-before-character string that is a continuous character string whose last character is right before the input position and which does not include a separator; a one-character candidate storage section for storing a character string having a predetermined number of characters and a one-character candidate that is a character inputted after the character string, in such a manner that the character string and the one-character candidate are related to each other; and one-character candidate determination means for referring to the one-character candidate storage section and determining as an input candidate the one-character candidate stored in relation to the character string having the predetermined number of characters right before the input position.

Consequently, even when the right-before-character string is not identical with a word stored in advance or when a word stored in advance is not identical with a word that a user wishes to input, it is possible to assign to a candidate selection key a one-character candidate that serves to aid a user to input a character. This allows the user to easily and swiftly input a desired character string with use of a candidate selection key.

Further, as described above, the character input device of the present invention includes: separator judgment means for judging whether a character right before the input position is a separator for separating words; first candidate determination means for, when a character right before the input position is a separator, regarding as an input candidate a candidate of a word inputted after a word right before the separator; and second candidate determination means for, when a character right before the input position is not a separator, regarding as an input candidate a candidate of a character string for completing as a word a right-before character string that is a continuous character string whose last character is right before the input position and which does not include a separator.

This allows presenting to a user an input candidate with high accuracy according to whether a character right before the input position is a separator or not. This allows the user to easily and swiftly input characters.

Further, it is preferable to arrange the character input device so that a character string stored in a character string storage section for storing a character string is output to an outside of the character input device by carrying out an input determination process, there is provided a chain process storage section for storing a word and the input determination process carried out after inputting the word in such a manner that the word and the input determination process are related to each other, and when a right-before-character string that is a continuous character string whose last character is right before the input position and which does not include a separator is identical with a word stored in the chain process storage section, the candidate process determination means assigns the input determination process to the candidate selection key.

With the arrangement of the present invention, the character string stored in the character string storage section is output to the outside of the character input device by carrying out the input determination process. Note that the outside of the character input device is an input field to which a character is to be inputted by the character input device. That is, with the arrangement of the present invention, the determination process is performed while a character string is completed in the character input device, and thus the completed character string is inputted in the input field.

When inputting characters, there is a case where the same character string is repeatedly inputted, such as a case of inputting one's name and address, and a case of inputting greeting message. In such a case, the input operation can be simplified by storing character strings such as name and address and greeting message in advance and assigning these character strings to candidate selection keys as input candidates. Assigning character strings stored in advance to candidate selection keys have been conventionally performed.

In contrast thereto, with the arrangement of the present invention, not only a word is stored but also a word and an input determination process carried out to follow input of the word are stored in such a manner that the word and the input determination process are related to each other. When the right-before character string is identical with a word stored in the chain process storage section, the input determination process is assigned to the candidate selection key.

That is, with the arrangement of the present invention, the determination process performed to follow input of a character string can be performed with use of a candidate selection key. This allows a user to easily and swiftly perform input of a character string and the determination process for the character string.

Further, it is preferable to arrange the character input device of the present invention so that when the input position is at a starting position or when a space or a period exists right before the input position, the process candidate determination means assigns a process for switching between inputting of a lowercase alphabet and inputting of a capital alphabet to the candidate selection key.

When inputting alphabets, there is a case where a capital alphabet is inputted at the starting position of the input position, right after a space, or right after a period. Therefore, in the arrangement, when inputting alphabets, in a case where the input position is at the starting position or a case where a space or a period exists right before the input position, the process for switching between input of a lowercase alphabet and input of a capital alphabet is assigned to the candidate selection key. This allows a user to easily and swiftly change input of a lowercase alphabet to input of a capital alphabet with use of a candidate selection key.

Further, with the arrangement of the present invention, when the input position is at a starting position or when a space or a period exists right before the input position, the process is assigned to the candidate selection key. Consequently, in other cases, it is possible to assign a candidate of a word etc. to a candidate selection key.

That is, with the arrangement of the present invention, in a case where the process for switching between input of a lowercase alphabet and input of a capital alphabet is likely to be carried out with high probability, the process is assigned to the candidate selection key. In other cases, other input candidate is assigned to the candidate selection key. This allows effectively using the candidate selection key.

Further, it is preferable to arrange the character input device of the present invention so as to further include character string reading means for reading a character string from the outside of the character input device, when the character string reading means reads a character string from the outside of the character input device, the process candidate determination means assigning to the candidate selection key a process for completely clearing the read character string.

Reading a character string from the outside of the character input device is preferable since it allows the read character string to be processed and edited by the character input device and outputted again. However, there is a case where the read character string is not used. In this case, a user is required to take trouble in clearing the read character string.

With the arrangement of the present invention, when a character string is read from the outside of the character input device, the process for completely clearing the read character string is assigned to the candidate selection key. Consequently, with the arrangement of the present invention, when the read character string is not used, it is possible to easily, swiftly, and completely clear the read character string with use of the candidate selection key.

Further, it is preferable to arrange the character input device of the present invention so that a character is inputted at the input position by moving a focus among adjacent character input keys displayed by the display section which correspond to characters, respectively, and selecting one of the character input keys, and when determining the one-character candidate as an input candidate, the one-character candidate determination means preferentially determines as an input candidate a one-character candidate of a character corresponding to a character input key positioned far from a position of a focused character input key on the display section.

The character input device may employ various methods for inputting characters. For example, the method may be such that a display section is caused to display character input keys and a focus is moved among adjacent character input keys and one of the character input keys is selected in order to input a character. In the method, inputting a character close to the position of the focus does not require much steps, but inputting a character farer from the position of the focus requires more steps. Here, the character far from the position of the focused character input key indicates a character input key that requires many number of steps (operations) in order to select a character indicated by the character input key.

With the arrangement of the present invention, a one-character candidate of a character corresponding to a character input key positioned far from the position of the focused character input key is preferentially determined as an input candidate. Consequently, when a character which a user wants to input next time is positioned near the position of the focus, only a small number of steps are required, and when inputting a character far from the position of the focus, usage of a candidate selection key allows the user to reduce the number of operations.

Further, it is preferable to arrange the character input device of the present invention so as to further include a word storage section for storing a word, when the right-before character string is identical with a top of the word stored in the word storage section, the second candidate determination means regarding as an input candidate a character string that follows the identical top of the word.

As described above, the second candidate determination means is means for determining an input candidate in a case where the result of the judgment of the separator judgment means shows that a character right before the input position is a character other than a separator. In this case, when a character string right before the input position is not completed as a word, it is expected that a character string for completing the character string right before the input position as a word is inputted.

Therefore, with the arrangement of the present invention, in a case where a word is stored in a word storage section and a character string right before the input position is identical with the top of the word stored in the word storage section, a character string to follow the identical portion of the word is determined as an input candidate.

Consequently, with the arrangement of the present invention, when a character right before the input position is a character other than a separator, a character for completing a character right before the input position as a word is determined as an input candidate, and when a character right before the input position is a separator, an input candidate other than the above input candidate can be determined.

As described above, an input candidate assigned to a candidate selection key is determined in different manners according to whether a character right before the input position is a separator or not. This allows assigning to the candidate selection key a suitable input candidate according to situations. Therefore, with the arrangement of the present invention, it is possible to increase the accuracy of the input candidate assigned to the candidate selection key. This allows a user to easily and swiftly input characters.

When a character string to follow an identical part of a word is displayed by a candidate selection key, it is preferable to display a character string at the end of the right-before character string, i.e., an inputted character string as well as the character string to follow the identical part of the word, since it allows a user to easily recognize the complete form of the word. Further, at that time, it is preferable to display the character strings in different colors etc. in order that the inputted character string can be recognized from the input candidate.

Further, it is preferable to arrange the character input device of the present invention so as to further include a word storage section for storing a word, when the right-before character string is identical with the word stored in the word storage section, the second candidate determination means regarding a separator as an input candidate.

As described above, the second candidate determination means is means for determining an input candidate in a case where the result of the judgment of the separator judgment means shows that a character right before the input position is a character other than a separator. In this case, when a character string right before the input position is completed as a word, it is expected that a separator is inputted at the input position.

Therefore, with the arrangement of the present invention, in a case where a word is stored in a word storage section and the right-before character string is identical with the word stored in the word storage section, a separator is determined as an input candidate.

Consequently, with the arrangement of the present invention, when the right-before character string is a separator, the separator is determined as an input candidate, and when a character right before the input position is not a separator, an input candidate other than the above input candidate can be determined.

As described above, an input candidate assigned to a candidate selection key is determined in different manners according to whether a character right before the input position is a separator or not. This allows assigning to the candidate selection key a suitable input candidate according to situations. Therefore, with the arrangement of the present invention, it is possible to increase the accuracy of the input candidate assigned to the candidate selection key. This allows a user to easily and swiftly input characters.

Further, it is preferable to arrange the character input device of the present invention so as to further include a chain separator storage section for storing a word and a separator inputted after the word in such a manner that the word and the separator are related to each other, when the right-before character string is identical with a word stored in the chain separator storage section, the second candidate determination means regarding as an input candidate the separator stored in relation to the word.

With the arrangement of the present invention, when the right-before character string is identical with a word stored in the chain separator storage section, the separator stored in relation to the word is determined as an input candidate. This allows storing in advance a separator which is highly likely to be inputted by a user, increasing the accuracy of a separator assigned to a candidate selection key. This allows a user to easily and swiftly input characters.

Further, it is preferable to arrange the character input device of the present invention so as to further include a chain word storage section for storing a word and a word inputted after the word in such a manner that the words are related to each other, when a continuous character string made of characters other than a separator right before the input position is identical with a word stored in the chain word storage section, the first candidate determination means regarding as an input candidate a word stored in relation to the word stored in the chain word storage section.

With the arrangement of the present invention, when a continuous character string made of characters other than a separator right before the input position is identical with a word stored in the chain word storage section, a word stored in relation to the word stored in the chain word storage section is determined as an input candidate. This allows storing in advance a word which is highly likely to be serially inputted by a user, increasing the accuracy of an input candidate assigned to a candidate selection key. This allows a user to easily and swiftly input characters.

Further, it is preferable to arrange the character input device of the present invention so as to further include a one-character candidate storage section for storing in advance a character string having a predetermined number of characters and a one-character candidate that is a character inputted after the character string in such a manner that the character string having a predetermined number of characters and the one-character string are related to each other, the second candidate determination means regarding as an input candidate the one-character candidate inputted after the character string having the predetermined number of characters right before the input position.

Here, storing a word in advance allows determining the word as an input candidate when the top of the word or the whole character string of the word is identical with a character string right before the input position. However, when a character string right before the input position is not identical with the word stored in advance, it is impossible to assign an input candidate to a candidate selection key. Further, when a word other than the word stored in advance is inputted, the assigned input candidate is not used.

Therefore, in the arrangement, a character string having a predetermined number of characters and a one-character candidate that is a character inputted after the character string are stored in such a manner that the one-character candidate and the character are related to each other. The one-character candidate inputted after the character string having predetermined number of characters right before the input position is determined as an input candidate.

This allows assigning an input candidate even when a character string right before the input position is not identical with a word stored in advance. Further, even when inputting a word other than a word stored in advance, it is possible to input characters with use of a candidate selection key.

Further, it is preferable to arrange the character input device of the present invention so that a character is inputted at the input position by moving a focus among adjacent character input keys displayed by the display section which correspond to characters, respectively, and selecting one of the character input keys, and when determining the one-character candidate as an input candidate, the one-character candidate determination means preferentially determines as an input candidate a one-character candidate of a character corresponding to a character input key positioned far from a position of a focused character input key on the display section.

The character input device may employ various methods for inputting characters. For example, the method may be such that a display section is caused to display character input keys and a focus is moved among adjacent character input keys and one of the character input keys is selected in order to input a character. In the method, inputting a character close to the position of the focus does not require much steps, but inputting a character farer from the position of the focus requires more steps.

With the arrangement of the present invention, a one-character candidate of a character corresponding to a character input key positioned far from the position of the focused character input key is preferentially determined as an input candidate. Consequently, when a character which a user wants to input next time is positioned near the position of the focus, only a small number of steps are required, and when inputting a character far from the position of the focus, usage of a candidate selection key allows the user to reduce the number of operations.

Further, it is preferable to arrange the character input device of the present invention so that a character string stored in the character string storage section is output to an outside of the character input device by carrying out an input determination process, there is provided a chain process storage section for storing a word and the input determination process carried out after inputting the word in such a manner that the word and the input determination process are related to each other, and when the right-before character string is identical with the word stored in the chain process storage section, the second candidate determination means regarding the input determination process as an input candidate.

With the arrangement of the present invention, the character string stored in the character string storage section is output to the outside of the character input device by carrying out the input determination process. Note that the outside of the character input device is an input field to which a character is to be inputted by the character input device. That is, with the arrangement of the present invention, the determination process is performed while a character string is completed in the character input device, and thus the completed character string is inputted in the input field.

When inputting characters, there is a case where the same character string is repeatedly inputted, such as a case of inputting one's name and address, and a case of inputting greeting message. In such a case, the input operation can be simplified by storing character strings such as name and address and greeting message in advance and assigning these character strings to candidate selection keys as input candidates. Assigning character strings stored in advance to candidate selection keys have been conventionally performed.

In contrast thereto, with the arrangement of the present invention, not only a word is stored but also a word and an input determination process carried out to follow input of the word are stored in such a manner that the word and the input determination process are related to each other. When the right-before character string is identical with a word stored in the chain process storage section, the input determination process is assigned to the candidate selection key.

That is, with the arrangement of the present invention, the determination process performed to follow input of a character string can be performed with use of a candidate selection key. This allows a user to easily and swiftly perform input of a character string and the determination process for the character string.

Further, it is preferable to arrange the character input device of the present invention so as to further include learning means for, when a character string stored in the character string storage section is output to the outside of the character input device, cutting out a separator and a word from the character string to be output and causing the word and the separator following the word to be stored in a chain separator storage section in such a manner that the word and the separator are related to each other, and causing continuous two words with a separator therebetween to be stored in a chain word storage section in such a manner that the two words are related to each other.

With the arrangement of the present invention, a word and a separator that are included in a character string having been inputted and determined in the character input device are stored separately. Further, a word and a separator following the word are stored in relation to each other, and continuous two words with a separator therebetween are stored in relation to each other.

Consequently, when a character right before the input position is identical with a word stored as described above, a separator following the word can be determined as an input candidate. Further, with the arrangement of the present invention, continuous two words with a separator therebetween are stored in relation to each other. Consequently, when a character right before the input position is a separator and when a character string right before the input position is identical with a word stored as described above, a word to be inputted next can be determined as an input candidate regardless of what separator exists right before the input position.

That is, with the arrangement of the present invention, even when a separator separating words changes, a word following the former word can be determined as an input candidate. For example, in a case where a character string “Tokyo, Japan” is learnt, when “Tokyo-” is inputted, “Japan” is determined as an input candidate regardless of the change of the separator next to “Tokyo”. Thus, with the arrangement of the present invention, it is possible to determine a suitable input candidate flexibly in response to the change of the separator.

It is preferable to arrange the character input device of the present invention so that in a case of inputting a URL (Uniform Resource Locator), when the number of characters from a separator right before the input position to a character right before the input position is more than a predetermined number, the second candidate determination means regards a period as an input candidate.

A certain rule is seen among character strings inputted when inputting a URL. That is, in an URL, a continuous character string is separated mainly by a period. Therefore, when certain number of characters are inputted without input of a separator such as a period and a slash, it is likely that a period is inputted to separate the character string.

With the arrangement of the present invention, when the number of characters from a separator right before the input position to a character right before the input position is more than a predetermined number, a period is regarded as an input candidate. This allows assigning a period to a candidate selection key in a situation where a user is likely to input a period, allowing the user to easily and swiftly input a URL. The predetermined number is not particularly limited. The predetermined number may be 2 or 3 since one character is not separated by a period in general.

It is judged that a URL is inputted when the top of a character string stored in the character string storage section is identical with “http://” or “www”. Further, it may be judged that a URL is inputted when the input field is a URL input field (address field of a browser).

It is preferable to arrange the character input device of the present invention so that in a case of inputting a URL, the first candidate determination means regards as an input candidate a predetermined character string according to whether “/” exists before the input position and after “://”.

As described above, a certain rule is seen among character strings inputted when inputting a URL. For example, a URL starts with a predetermined character string such as “http://”. When a period is inputted next to “http://”, a predetermined character string such as “com” is frequently inputted right after “http://”. Further, when a URL continues after “com”, it is often that a slash “/” is inputted right after “com” and the URL ends with a predetermined character string such as “.html/”.

With the arrangement of the present invention, a predetermined character string is determined as an input candidate according to whether “/” exists before the input position and after “://”. This allows a character string which a user is likely to input to be assigned to a candidate selection key with suitable timing according to situation, allowing the user to easily and swiftly input a URL.

It is preferable to arrange the character input device of the present invention so that, when the input position is at a starting position or when a space or a period exists right before the input position, the first candidate determination means regards as an input candidate a process for switching between inputting of a lowercase alphabet and inputting of a capital alphabet.

When inputting alphabets, there is a case where a capital alphabet is inputted at the starting position of the input position and right after a space or a period. With the arrangement of the present invention, when the input position is at the starting position or a space or a period exists right before the input position, a process for switching input of a lowercase alphabet and input of a capital alphabet is assigned to the candidate selection key. This allows a user to easily and swiftly change input of a lowercase alphabet to input of a capital alphabet with use of the candidate selection key.

Further, with the arrangement of the present invention, in a case where the input position is at the starting position or a case where a space or a period exists right before the input position, the process is assigned to a candidate selection key. Consequently, in other cases, it is possible to assign a candidate of a word etc. to a candidate selection key.

That is, with the arrangement of the present invention, in a case where the process for switching between a lowercase alphabet and a capital alphabet is likely to be carried out, the process is assigned to a candidate selection key, and in other cases, other input candidate is assigned to a candidate selection key. As a result, a candidate selection key is used effectively.

Further, it is preferable to arrange the character input device of the present invention so as to further include: character string reading means for reading a character string from the outside of the character input device to the character string storage section; and editing candidate determination means for, when the character string reading means reads a character string from the outside of the character input device, regarding as an input candidate at least one of a process for completely clearing the read character string and a process for inputting a space after the read character string.

Reading a character string from the outside of the character input device is preferable since it allows the character input device to process and edit the read character string and output the character string again. For example, in inputting a character string with which a keyword search is carried out, there is a case where a keyword has been already inputted in an input field to which a keyword is to be inputted.

In the case, when a search is carried out with use of a new keyword in addition to the inputted keyword, it is necessary for a user to input a space after the inputted keyword and input the new keyword after the space.

With the arrangement of the present invention, when a character string is read from the outside of the character input device, a space is assigned to the candidate selection key. Therefore, with the arrangement of the present invention, when a new character string is added after the read character string, it is possible to easily and swiftly input a space with use of a candidate selection key.

Further, there is a case where the read character string is not used. Therefore, when a character string is read from the outside of the character input device, a process for completely clearing the read character string may be assigned to the candidate selection key. This allows easily, swiftly, and completely clearing the read character string with use of a candidate selection key, when the read character string is not used.

Further, it is preferable to arrange the character input device of the present invention so that when the number of characters of a candidate of a word to be inputted at the input position is more than the maximum number of characters that are displayable in the candidate selection key, the first candidate determination means cuts out top character and subsequent characters of the word in such a manner that the number of the cut-out characters is not more than the maximum number of the displayable characters, and regards the cut-out characters as the input candidate, and when the number of characters of a character string for completing the right-before character string as a word is more than the maximum number of characters that are displayable in the candidate selection key, the second candidate determination means cuts out top character and subsequent characters of the character string in such a manner that the number of the cut-out characters is not more than the maximum number of the displayable characters, and regards the cut-out characters as the input candidate.

As described above, it is often that character input devices have limited spaces where input keys are arranged or where input candidates are displayed, which makes it difficult to cause a candidate selection key to display the whole character string of an input candidate. In such a case, it is general that only the top of an input candidate is displayed, and when a candidate selection key to which the input candidate is assigned is selected, the whole character string of the input candidate (including a character string that is not displayed by the candidate selection key) is inputted at the input position.

However, if the character string that is not displayed by the candidate selection key is inputted at the input position, a character string displayed by the candidate selection key is different from an inputted character string, which may confuse a user.

With the arrangement of the present invention, when the number of characters of a character string for completing the right-before character string as a word is more than the maximum number of characters that are displayable in the candidate selection key, top character and subsequent characters of the character string are cut out in such a manner that the number of the cut-out characters is not more than the maximum number of the displayable characters, and regards the cut-out characters as the input candidate.

With the arrangement of the present invention, the cut-out character string is determined as an input candidate, and consequently a character string displayed by a candidate selection key is completely identical with an inputted character string. Consequently, the user is not confused.

Further, it is preferable to arrange the character input device of the present invention so that in a case where the first candidate determination means and the second candidate determination means cut out the top character and subsequent characters in the number not more than the maximum number of the displayable characters and regard the cut-out characters as the input candidate, when a plurality of input candidates have an identical character string, the first candidate determination means and the second candidate determination means regard as the input candidate only one of the plurality of input candidates having an identical character string.

In cutting out a part of a character string constituting a word, there is a case where the same character string is cut out from different words. In this case, when the same character string is determined as input candidates, the user cannot know which input candidate is to be used and is confused. Further, when the input candidates to which the same character string is inputted are assigned to candidate selection keys, respectively, other input candidate cannot be assigned to a candidate selection key. This is not preferable.

With the arrangement of the present invention, when a plurality of input candidates include the same character string, only one of the input candidates including the same character string is determined as an input candidate. Consequently, the user is not confused as to which candidate should be selected. Further, it is possible to assign a more useful input candidate to a candidate selection key.

Further, it is preferable to arrange the character input device of the present invention to further include input candidate assigning means for causing the candidate selection key to display (i) a character string of an input candidate assigned to the candidate selection key and (ii) a character string at a rear end of the right-before character string in such a manner that the character string of the input candidate and the character string at the rear end of the right-before character string are related to each other, and when a plurality of character strings to be displayed by candidate selection keys include the character string at the rear end of the right-before character string, the input candidate assigning means causing the candidate selection keys to display the character string at the rear end in a same manner.

With the arrangement of the present invention, the character string at a rear end of the right-before character string is displayed along with the character string that is an input candidate. This allows a user to more easily recognize the complete form of a word and to more easily select a desired input candidate. Here, if the length of the character string at a rear end (the number of characters) to be displayed is different with respect to each input candidate, it is difficult for a user to recognize the boarder between the inputted character string and a character string to be inputted.

With the arrangement of the present invention, when a plurality of character strings to be displayed by candidate selection keys include the character string at the rear end of the right-before character string, the character string at the rear end of the right-before character string is displayed by each of the candidate selection keys in a same manner. Consequently, it is easy for the user to recognize the boarder between the inputted character string and a character string to be inputted, allowing the user to more easily select a desired input candidate.

It is preferable to arrange the character input device of the present invention so that in a case of inputting Japanese, when the right-before character string is not subjected to kana-kanji conversion for converting a kana character to a kanji character, a process for subjecting the right-before character string to the kana-kanji conversion is regarded as an input candidate.

Inputting Japanese requires kana-kanji conversion. When the kana-kanji conversion process is assigned as an input candidate to a candidate selection key, it is possible to easily and swiftly carry out the kana-kanji conversion process.

However, it is not preferable to fixedly assign the kana-kanji conversion process to a candidate selection key since the kana-kanji conversion process is not always used in all situations where Japanese is input. For example, in a case where a character string right before the input position has been already subjected to the kana-kanji conversion or in a case where the input position is at the starting position, there is no meaning in assigning the kana-kanji conversion process to a candidate selection key.

With the arrangement of the present invention, in a case where a character string right before the input position is not subjected to the kana-kanji conversion, a process for subjecting the character string right before the input position to the kana-kanji conversion is regarded as an input candidate. that is, with the arrangement, in a case where the kana-kanji conversion process is likely to be carried out, the process is assigned to a candidate selection key, and in other cases, other input candidate is assigned to a candidate selection key. This allows effectively using a candidate selection key.

A system of the present invention is a system, including: an information processing device including the character input device and a browser function; and a display device for displaying a browser screen outputted from the information processing device, the system allowing the character input device to input characters on a browser screen displayed by the display device. This system allows a user to easily and swiftly input characters on the browser screen.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The character input device of the present invention allows assigning to a candidate selection key a suitable input candidate according to input situations, allowing a user to easily and promptly input characters. Therefore, the character input device of the present invention is applicable not only to the image display system where a television and a computer is connected with each other but also to various electronic devices using inputting of characters, such as televisions and audio devices. In particular, the character input device of the present invention allows assigning a suitable input candidate even when limited amount of information is displayable in an input window, and therefore is preferably applicable to portable phones and portable music players.

1. A character input device for changing, in accordance with a state of inputting of characters, a process assigned to a candidate selection key displayed in such a manner as to be selectable by a user, and for carrying out, when the candidate selection key is selected, the process assigned to the selected candidate selection key,
said character input device comprising:
character string candidate determination section for assigning, to the candidate selection key, a character string input process in which a character string determined according to a character string before an input position is inputted to the input position; and
process candidate determination section for assigning, to the candidate selection key, a process that is related to inputting of characters and that is other than the character string input process,
when the candidate selection key is selected, the process assigned by the character string candidate determination section or the process candidate determination section being carried out, wherein when the input position is at a starting position or when a space or period exists right before the input position, the process candidate determination section assigns a process for switching between inputting of a lowercase alphabet and inputting of a capital alphabet to the candidate selection key.

2. The character input device as set forth in claim 1, wherein
a character string stored in a character string storage section for storing a character string is output to an outside of the character input device by carrying out an input determination process,
there is provided a chain process storage section for storing a word and the input determination process carried out after inputting the word in such a manner that the word and the input determination process are related to each other, and
when a right-before-character string that is a continuous character string whose last character is right before the input position and which does not include a separator is identical with a word stored in the chain process storage section, the candidate process determination section assigns the input determination process to the candidate selection key.

3. (canceled)

4. The character input device as set forth in claim 1, further comprising character string reading section for reading a character string from the outside of the character input device,
when the character string reading section reads a character string from the outside of the character input device, the process candidate determination section assigning to the candidate selection key a process for completely clearing the read character string.

5. The character input device as set forth in claim 1, further comprising:
input candidate determination section for determining the input candidate on a basis of a right-before-character string that is a continuous character string whose last character is right before the input position and which does not include a separator;
a one-character candidate storage section for storing a character string having a predetermined number of characters and a one-character candidate that is a character inputted after the character string, in such a manner that the character string and the one-character candidate are related to each other; and
one-character candidate determination section for referring to the one-character candidate storage section and determining as an input candidate the one-character candidate stored in relation to the character string having the predetermined number of characters right before the input position.

6. The character input device as set forth in claim 5, wherein
a character is inputted at the input position by moving a focus among adjacent character input keys displayed by the display section which correspond to characters, respectively, and selecting one of the character input keys, and
when determining the one-character candidate as an input candidate, the one-character candidate determination section preferentially determines as an input candidate a one-character candidate of a character corresponding to a character input key positioned far from a position of a focused character input key on the display section.

7. A character input device, (i) displaying a candidate selection key to which an input candidate that is a candidate of a character string to be inputted at an input position is assigned on a basis of a character string before the input position, and (ii) when the displayed candidate selection key is selected, inputting the character string of the input candidate assigned to the selected candidate selection key at the input position,
said character input device comprising:
process candidate determination section for assigning, to the candidate selection key, a process that is related to inputting of characters and that is other than the character string input process;
separator judgment section for judging whether a character right before the input position is a separator for separating words;
first candidate determination section for, when a character right before the input position is a separator, regarding as an input candidate a candidate of a word inputted after a word right before the separator; and
second candidate determination section for, when a character right before the input position is not a separator, regarding as an input candidate a candidate of a character string for completing as a word a right-before character string that is a continuous character string whose last character is right before the input position and which does not include a separator.

8. The character input device as set forth in claim 7, further comprising a word storage section for storing a word,
when the right-before character string is identical with a top of the word stored in the word storage section, the second candidate determination section regarding as an input candidate a character string that follows the identical top of the word.

9. The character input device as set forth in claim 7, further comprising a word storage section for storing a word,
when the right-before character string is identical with the word stored in the word storage section, the second candidate determination section regarding a separator as an input candidate.

10. The character input device as set forth in claim 7, further comprising a chain separator storage section for storing a word and a separator inputted after the word in such a manner that the word and the separator are related to each other,
when the right-before character string is identical with a word stored in the chain separator storage section, the second candidate determination section regarding as an input candidate the separator stored in relation to the word.

11. (canceled)

12. The character input device as set forth in claim 7, further comprising a one-character candidate storage section for storing in advance a character string having a predetermined number of characters and a one-character candidate that is a character inputted after the character string in such a manner that the character string having a predetermined number of characters and the one-character string are related to each other,
the second candidate determination section regarding as an input candidate the one-character candidate inputted after the character string having the predetermined number of characters right before the input position.

13. The character input device as set forth in claim 12, wherein
a character is inputted at the input position by moving a focus among adjacent character input keys displayed by the display section which correspond to characters, respectively, and selecting one of the character input keys, and
when determining the one-character candidate as an input candidate, the one-character candidate determination section preferentially determines as an input candidate a one-character candidate of a character corresponding to a character input key positioned far from a position of a focused character input key on the display section.

14. The character input device as set forth in claim 7, wherein
a character string created by the character input device is output to an outside of the character input device by carrying out an input determination process,
there is provided a chain process storage section for storing a word and the input determination process carried out after inputting the word in such a manner that the word and the input determination process are related to each other, and
when the right-before character string is identical with the word stored in the chain process storage section, the second candidate determination section regarding the input determination process as an input candidate.

15. The character input device as set forth in claim 7, further comprising learning section for, when a character string created by the character input device is output to the outside of the character input device, cutting out a separator and a word from the character string to be output and causing the word and the separator following the word to be stored in a chain separator storage section in such a manner that the word and the separator are related to each other, and causing continuous two words with a separator therebetween to be stored in a chain word storage section in such a manner that the two words are related to each other.

16. The character input device as set forth in claim 7, wherein in a case of inputting a URL (Uniform Resource Locator), when the number of characters from a separator right before the input position to a character right before the input position is more than a predetermined number, the second candidate determination section regards a period as an input candidate.

17. The character input device as set forth in claim 7, wherein in a case of inputting a URL, the first candidate determination section regards as an input candidate a predetermined character string according to whether “/” exists before the input position and after “://”.

18. The character input device as set forth in claim 7, when the input position is at a starting position or when a space or a period exists right before the input position, the first candidate determination section regards as an input candidate a process for switching between inputting of a lowercase alphabet and inputting of a capital alphabet.

19. The character input device as set forth in claim 7, further comprising:
character string reading section for reading a character string from the outside of the character input device to a character string storage section, which stores character string to be edited by the character input device; and
editing candidate determination section for, when the character string reading section reads a character string from the outside of the character input device, regarding as an input candidate at least one of a process for completely clearing the read character string and process for inputting a space after the read character string.

20. The character input device as set forth in claim 7, wherein
when the number of characters of a candidate of a word to be inputted at the input position is more than the maximum number of characters that are displayable in the candidate selection key, the first candidate determination section cuts out top character and subsequent characters of the word in such a manner that the number of the cut-out characters is not more than the maximum number of the displayable characters, and regards the cut-out characters as the input candidate:
when the number of characters of a character string for completing the right-before character string as a word is more than the maximum number of characters that are displayable in the candidate selection key, the second candidate determination section cuts out top character and subsequent characters of the character string in such a manner that the number of the cut-out characters is not more than the maximum number of the displayable characters, and regards the cut-out characters as the input candidate; and
in a case where the first candidate determination section and the second candidate determination section cut out the top character and subsequent characters in the number not more than the maximum number of the displayable characters and regard the cut-out characters as the input candidate, when a plurality of input candidates have an identical character string, the first candidate determination section and the second candidate determination section regard as the input candidate only one of the plurality of input candidates having an identical character string.

21. (canceled)

22. The character input device as set forth in claim 7, further comprising input candidate assigning section for causing the candidate selection key to display (i) a character string of an input candidate assigned to the candidate selection key and (ii) a character string at a rear end of the right-before character string in such a manner that the character string of the input candidate and the character string at the rear end of the right-before character string are related to each other, and when a plurality of character strings to be displayed by candidate selection keys include the character string at the rear end of the right-before character string, the input candidate assigning section causing the candidate selection keys to display the character string at the rear end in a same manner.

23-24. (canceled)

25. A character input control method of a character input device for changing, in accordance with a state of inputting of characters, a process assigned to a candidate selection key displayed in such a manner as to be selectable by a user, and for carrying out, when the candidate selection key is selected, the process assigned to the selected candidate selection key,
said method comprising the steps of:
(i) assigning, to the candidate selection key, a character string input process in which a character string determined according to a character string before an input position is inputted to the input position;
(ii) assigning, to the candidate selection key, a process that is related to inputting of characters and that is other than the character string input process; and
(iii) when the candidate selection key is selected, carrying out the process assigned to the candidate selection key in the step (i) or the step (ii),
the step (ii) assigns a process for switching between inputting of a lowercase alphabet and inputting of a capital alphabet to the candidate selection key, when the input position is at a starting position or when a space or a period exists right before the input position.

26-27. (canceled)
